(19) United States
(12) Patent Application Publication
(10) Pub. No.: US 2025/0159682 A1
(43) Pub. Date: May 15, 2025

(54) INTER-TRANSPORT BLOCK TIME INTERLEAVING

(71) Applicant: QUALCOMM Incorporated, San Diego, CA (US)

(72) Inventors: Le LIU, San Jose, CA (US); Alberto RICO ALVARINO, San Diego, CA (US); Ayan SENGUPTA, San Diego, CA (US)

(21) Appl. No.: 18/506,982

(22) Filed: Nov. 10, 2023

(51) Int. Cl. H04W 72/1273; H04L 1/1812; H04W 72/0446; H04W 72/232

(52) U.S. Cl. CPC H04W 72/1273; H04L 1/1812; H04W 72/0446; H04W 72/232

(57) ABSTRACT

Methods, systems, and devices for wireless communications are described. A network entity may transmit DCIs to a UE to schedule instances of one or more MBS TBs, the multiple instances of the one or more TBs being time-interleaved. For example, the network entity may transmit a first set of DCIs scheduling a first set of instances of a first TB, and a second set of DCIs scheduling a second set of instances of a second TB, where at least one instance of the first set of instances may be interleaved with the second set of instances. In some cases, the first and second set of DCIs may include one DCI to schedule the respective set of instances, or one DCI per instance of the respective set of instances. Additionally, or alternatively, the network entity may indicate one or more parameters to the UE associated with MBS inter-TB time interleaving.

### INTRODUCTION

The following relates to wireless communications, including inter-transport block time interleaving. Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support inter-transport block (TB) time interleaving (e.g., in a multicast broadcast service (MBS)). For example, the described techniques provide for a network entity to transmit (e.g., broadcast, multicast) downlink control information (DCI) messages (e.g., which may be referred to herein as DCIs) to a user equipment (UE), where the DCIs may schedule multiple instances of one or more TBs, and where the multiple instances of the one or more TBs may be interleaved (e.g., in time, time-interleaved). For example, the network entity may transmit a first set of DCIs scheduling a first set of instances of a first TB, and a second set of DCIs scheduling a second set of instances of a second TB, where at least one instance of the first set of instances may be interleaved with the second set of instances.

In some aspects, the first set of DCIs and the second set of DCIs may each include one respective DCI for each respective instance in the first set of instances and the second set of instances, respectively (e.g., a one-to-one ratio of DCIs to instances). For instance, a first DCI message may schedule a first transmission of a TB, a second DCI may schedule a first repetition of the TB, etc. In some examples, the DCIs may additionally include a TB indicator (e.g., an NDI, an HPID, or both), whereby a UE receiving the instances may determine that various instances of a TB are of the same TB (e.g., if the various instances of the TB are using a same HPID, a same NDI, or both). The UE may then decode the TB, for example, by performing a soft combination on the received instances of the TB. Additionally, or alternatively, the network entity may indicate a time duration to the UE, where the UE may determine that two instances of a TB are of the same TB based on whether multiple TBs are received within the time duration.

In some aspects, the network entity may schedule multiple instances of a single TB (e.g., multiple RVs or multiple repetitions of a TB) using a single DCI. The network entity may also indicate a quantity of instances for each set of instances and a time delay between the instances of each set of instances to the UE.

Additionally, or alternatively, the network entity may transmit one DCI to schedule the instances of both the first TB and the second TB. For example, the DCI may be of a format which indicates a quantity of TBs, a quantity of instances of each of the TBs, an inter-TB interleaving pattern, and a TB scaling factor, along with the resources for the UE to receive each instance of each TB.

In some aspects, the network entity may indicate one or more parameters for receiving inter-TB interleaved transmissions via broadcast or multicast. For example, for the UE to receive an MBS physical downlink shared channel (PDSCH), the UE may apply a processing time (e.g., Tproc,1) to receive the PDSCH if an HPID and an NDI are indicated in an associated physical downlink control channel (PDCCH) (e.g., DCI) scheduling the PDSCH. The network entity may indicate to the UE that the processing time (e.g., Tproc,1) may be between instances of a first TB and instances of a second TB. Additionally, or alternatively, the network entity may indicate a limited bandwidth for MBS PDSCH inter-TB interleaved transmissions for some UEs (e.g., enhanced reduced capability (eRedCap) UEs).

A method for wireless communication by a network entity for wireless communication is described. The method may include receiving a first set of one or more DCI messages that collectively schedule a first set of instances of a first TB, receiving a second set of one or more DCI messages that collectively schedule a second set of instances of a second TB, receiving, via a set of one or more PDSCHs in accordance with the first set of one or more DCI messages and the second set of one or more DCI messages, the first set of instances of the first TB and the second set of instances of the second TB for a multicast service or for a broadcast service, where at least one instance of the first set of instances of the first TB is time interleaved with the second set of instances of the second TB, and decoding the first TB based on reception of the first set of instances of the first TB.

A network entity for wireless communication for wireless communication is described. The network entity for wireless communication may include one or more memories storing processor executable code, and one or more processors coupled with the one or more memories. The one or more processors may individually or collectively operable to execute the code to cause the network entity for wireless communication to receive a first set of one or more DCI messages that collectively schedule a first set of instances of a first TB, receive a second set of one or more DCI messages that collectively schedule a second set of instances of a second TB, receive, via a set of one or more PDSCHs in accordance with the first set of one or more DCI messages and the second set of one or more DCI messages, the first set of instances of the first TB and the second set of instances of the second TB for a multicast service or for a broadcast service, where at least one instance of the first set of instances of the first TB is time interleaved with the second set of instances of the second TB, and decode the first TB based on reception of the first set of instances of the first TB.

Another network entity for wireless communication for wireless communication is described. The network entity for wireless communication may include means for receiving a first set of one or more DCI messages that collectively schedule a first set of instances of a first TB, means for receiving a second set of one or more DCI messages that collectively schedule a second set of instances of a second TB, means for receiving, via a set of one or more PDSCHs in accordance with the first set of one or more DCI messages and the second set of one or more DCI messages, the first set of instances of the first TB and the second set of instances of the second TB for a multicast service or for a broadcast service, where at least one instance of the first set of instances of the first TB is time interleaved with the second set of instances of the second TB, and means for decoding the first TB based on reception of the first set of instances of the first TB.

A non-transitory computer-readable medium storing code for wireless communication is described. The code may include instructions executable by one or more processors to receive a first set of one or more DCI messages that collectively schedule a first set of instances of a first TB, receive a second set of one or more DCI messages that collectively schedule a second set of instances of a second TB, receive, via a set of one or more PDSCHs in accordance with the first set of one or more DCI messages and the second set of one or more DCI messages, the first set of instances of the first TB and the second set of instances of the second TB for a multicast service or for a broadcast service, where at least one instance of the first set of instances of the first TB is time interleaved with the second set of instances of the second TB, and decode the first TB based on reception of the first set of instances of the first TB.

Some examples of the method, network entities, and non-transitory computer-readable medium described herein may further include operations, features, means, or instructions for perform a soft combination of one or more instances of the first set of instances of the first TB based on the first set of one or more DCI messages including an indication that each instance of the one or more instances of the first set of instances may be of the first TB.

Some examples of the method, network entities, and non-transitory computer-readable medium described herein may further include operations, features, means, or instructions for decode the first TB based on the network entity being of a first generation of network entity that may be different from a second generation of network entity, or the network entity being capable of communicating time interleaved respective instances of respective TBs that may be for the multicast service or the broadcast service, or both.

In some examples of the method, network entities, and non-transitory computer-readable medium described herein, the first set of one or more DCI messages and the second set of one or more DCI messages may be configured to be decodable by at least a second network entity that may be of a different generation than the network entity, the network entity and the second network entity may be capable of decoding the first set of one or more DCI messages and the second set of one or more DCI messages, and the network entity may be capable of communicating time interleaved respective instances of respective TBs that may be for the multicast service or the broadcast service, or both.

In some examples of the method, network entities, and non-transitory computer-readable medium described herein, each DCI message of the first set of one or more DCI messages schedules a respective instance of the first set of instances of the first TB and each DCI message of the second set of one or more DCI messages schedules a respective instance of the second set of instances of the second TB.

In some examples of the method, network entities, and non-transitory computer-readable medium described herein, each DCI message of the first set of one or more DCI messages includes a respective field indicating that the scheduled respective instance of the first set of instances corresponds to the first TB and the processing system may be configured to decode the first TB based on the respective field of each DCI message of the first set of one or more DCI messages.

In some examples of the method, network entities, and non-transitory computer-readable medium described herein, the respective field of each DCI message of the first set of one or more DCI messages indicates a respective HPID associated with the scheduled respective instance of the first set of instances, an NDI associated with the HPID, or both.

In some examples of the method, network entities, and non-transitory computer-readable medium described herein, the NDI associated with the respective HPID indicates whether the scheduled respective instance may be a first temporal transmission corresponding to the first TB.

In some examples of the method, network entities, and non-transitory computer-readable medium described herein, the HPID indicates whether the scheduled respective instance may be a retransmission corresponding to the first TB.

In some examples of the method, network entities, and non-transitory computer-readable medium described herein, at least one DCI message of the first set of one or more DCI messages may have DCI format 4_0.

In some examples of the method, network entities, and non-transitory computer-readable medium described herein, at least one DCI message of the first set of one or more DCI messages may be for the broadcast service and may have DCI format 4_1 and at least one DCI message of the first set of one or more DCI messages may be for the broadcast service and may have DCI format 4_2.

Some examples of the method, network entities, and non-transitory computer-readable medium described herein may further include operations, features, means, or instructions for receive information that indicates a time window, where decoding the first TB may be based on the first set of instances being within the time window.

Some examples of the method, network entities, and non-transitory computer-readable medium described herein may further include operations, features, means, or instructions for receive first information that indicates a quantity of the first set of instances of the first TB and second information that indicates a time delay between individual instances of the first set of instances of the first TB, where decoding the first TB may be based on the quantity and the time delay, and where the first set of one or more DCI messages may be a single DCI message that schedules the first set of instances of the first TB.

Some examples of the method, network entities, and non-transitory computer-readable medium described herein may further include operations, features, means, or instructions for receive RRC information that corresponds to a group radio network temporary identifier associated with the network entity, where the RRC information includes the first information and the second information.

In some examples of the method, network entities, and non-transitory computer-readable medium described herein, the single DCI message includes a time domain resource allocation index that may be indicative of the first information and the second information.

Some examples of the method, network entities, and non-transitory computer-readable medium described herein may further include operations, features, means, or instructions for receive RRC information that includes the first information, where the single DCI message includes a time domain resource allocation index that may be indicative of the second information.

Some examples of the method, network entities, and non-transitory computer-readable medium described herein may further include operations, features, means, or instructions for receive RRC information that includes the second information, where the single DCI message includes a time domain resource allocation index that may be indicative of the first information.

In some examples of the method, network entities, and non-transitory computer-readable medium described herein, the single DCI message includes a field with more than 2 bits that indicates a RV index associated with one instance of the first set of instances of the first TB.

Some examples of the method, network entities, and non-transitory computer-readable medium described herein may further include operations, features, means, or instructions for receive information that indicates a RV index pattern for the first set of instances of the first TB and decode only a portion of each DCI message of the first set of one or more DCI messages, where the portion excludes a respective RV field of each respective DCI message based on receipt of the information, and where decoding the first TB may be based on the RV index pattern.

In some examples of the method, network entities, and non-transitory computer-readable medium described herein, the RV index pattern indicates that a respective RV index associated with a first temporal instance of the first set of instances of the first TB may be zero.

In some examples of the method, network entities, and non-transitory computer-readable medium described herein, at least one DCI message of the first set of one or more DCI messages includes a RV field that indicates a RV index associated with a first temporal instance of the first set of instances of the first TB, the indicated RV index corresponds to a RV index pattern of a set of multiple RV index patterns, and the RV index pattern begins with the indicated RV index.

A method for wireless communication by a network entity for wireless communication is described. The method may include transmitting a first set of one or more DCI messages that collectively schedule a first set of instances of a first TB, transmitting a second set of one or more DCI messages that collectively schedule a second set of instances of a second TB, and transmitting, via a set of one or more PDSCHs in accordance with the first set of one or more DCI messages and the second set of one or more DCI messages, the first set of instances of the first TB and the second set of instances of the second TB for a multicast service or a broadcast service, where at least one instance of the first set of instances of the first TB is interleaved with the second set of instances of the second TB.

A network entity for wireless communication for wireless communication is described. The network entity for wireless communication may include one or more memories storing processor executable code, and one or more processors coupled with the one or more memories. The one or more processors may individually or collectively operable to execute the code to cause the network entity for wireless communication to transmit a first set of one or more DCI messages that collectively schedule a first set of instances of a first TB, transmit a second set of one or more DCI messages that collectively schedule a second set of instances of a second TB, and transmit, via a set of one or more PDSCHs in accordance with the first set of one or more DCI messages and the second set of one or more DCI messages, the first set of instances of the first TB and the second set of instances of the second TB for a multicast service or a broadcast service, where at least one instance of the first set of instances of the first TB is interleaved with the second set of instances of the second TB.

Another network entity for wireless communication for wireless communication is described. The network entity for wireless communication may include means for transmitting a first set of one or more DCI messages that collectively schedule a first set of instances of a first TB, means for transmitting a second set of one or more DCI messages that collectively schedule a second set of instances of a second TB, and means for transmitting, via a set of one or more PDSCHs in accordance with the first set of one or more DCI messages and the second set of one or more DCI messages, the first set of instances of the first TB and the second set of instances of the second TB for a multicast service or a broadcast service, where at least one instance of the first set of instances of the first TB is interleaved with the second set of instances of the second TB.

A non-transitory computer-readable medium storing code for wireless communication is described. The code may include instructions executable by one or more processors to transmit a first set of one or more DCI messages that collectively schedule a first set of instances of a first TB, transmit a second set of one or more DCI messages that collectively schedule a second set of instances of a second TB, and transmit, via a set of one or more PDSCHs in accordance with the first set of one or more DCI messages and the second set of one or more DCI messages, the first set of instances of the first TB and the second set of instances of the second TB for a multicast service or a broadcast service, where at least one instance of the first set of instances of the first TB is interleaved with the second set of instances of the second TB.

In some examples of the method, network entities, and non-transitory computer-readable medium described herein, each DCI message of the first set of one or more DCI messages schedules a respective instance of the first set of instances of the first TB and each DCI message of the second set of one or more DCI messages schedules a respective instance of the second set of instances of the second TB.

In some examples of the method, network entities, and non-transitory computer-readable medium described herein, each DCI message of the first set of one or more DCI messages includes a respective field indicating that the scheduled respective instance of the first set of instances corresponds to the first TB.

In some examples of the method, network entities, and non-transitory computer-readable medium described herein, the respective field of each DCI message of the first set of one or more DCI messages indicates a respective HPID associate with the scheduled respective instance of the first set of instances, an NDI associated with the HPID, or both.

In some examples of the method, network entities, and non-transitory computer-readable medium described herein, the NDI associated with the respective HPID indicates whether the scheduled respective instance may be a first temporal transmission corresponding to the first transport block.

In some examples of the method, network entities, and non-transitory computer-readable medium described herein, the HPID indicates whether the scheduled respective instance may be a retransmission corresponding to the first TB.

In some examples of the method, network entities, and non-transitory computer-readable medium described herein, at least one DCI message of the first set of one or more DCI messages may have DCI format 4_0.

In some examples of the method, network entities, and non-transitory computer-readable medium described herein, at least one DCI message of the first set of one or more DCI messages may be for the broadcast service and may have DCI format 4_1 and at least one DCI message of the first set of one or more DCI messages may be for the broadcast service and may have DCI format 4_2.

Some examples of the method, network entities, and non-transitory computer-readable medium described herein may further include operations, features, means, or instructions for transmit information that indicates a time window associated the first set of instances and decoding the first TB.

In some examples of the method, network entities, and non-transitory computer-readable medium described herein, the first set of one or more DCI messages and the second set of one or more DCI messages may be configured to be decodable by at least a second network entity that may be of a different generation than at least a third network entity, the second network entity and the third network entity may be capable of decoding the first set of one or more DCI messages and the second set of one or more DCI messages, and the third network entity may be capable of communicating time interleaved respective instances of respective TBs that may be for the multicast service or the broadcast service, or both.

Some examples of the method, network entities, and non-transitory computer-readable medium described herein may further include operations, features, means, or instructions for transmit first information that indicates a quantity of the first set of instances of the first TB and second information that indicates a time delay between individual instances of the first set of instances of the first TB, and where the first set of one or more DCI messages may be a single DCI message that schedules the first set of instances of the first TB.

Some examples of the method, network entities, and non-transitory computer-readable medium described herein may further include operations, features, means, or instructions for transmit RRC information that corresponds to a group radio network temporary identifier associated with a second network entity, where the RRC information includes the first information and the second information.

In some examples of the method, network entities, and non-transitory computer-readable medium described herein, the single DCI message includes a time domain resource allocation index that may be indicative of the first information and the second information.

Some examples of the method, network entities, and non-transitory computer-readable medium described herein may further include operations, features, means, or instructions for transmit RRC information that includes the first information, where the single DCI message includes a TDRA index that may be indicative of the second information.

Some examples of the method, network entities, and non-transitory computer-readable medium described herein may further include operations, features, means, or instructions for transmit RRC information that includes the second information, where the single DCI message includes a time domain resource allocation index that may be indicative of the first information.

In some examples of the method, network entities, and non-transitory computer-readable medium described herein, the single DCI message includes a field with more than 2 bits that indicates a RV index associated with one instance of the first set of instances of the first TB.

In some examples of the method, network entities, and non-transitory computer-readable medium described herein, each DCI message of the first set of one or more DCI messages includes a respective field with more than 2 bits that indicates a respective RV index associated with a respective instance of the first set of instances of the first TB.

Some examples of the method, network entities, and non-transitory computer-readable medium described herein may further include operations, features, means, or instructions for transmit information that indicates a RV index pattern for the first set of instances of the first TB, where the RV index pattern may be associated with decoding the first TB.

In some examples of the method, network entities, and non-transitory computer-readable medium described herein, the RV index pattern indicates that a respective RV index associated with a first temporal instance of the first set of instances of the first TB may be zero.

In some examples of the method, network entities, and non-transitory computer-readable medium described herein, at least one DCI message of the first set of one or more DCI messages includes a RV field that indicates a RV index associated with a first temporal instance of the first set of instances of the first TB, the indicated RV index corresponds to a RV index pattern of a set of multiple RV index patterns, and the RV index pattern begins with the indicated RV index.

Some examples of the method, network entities, and non-transitory computer-readable medium described herein may further include operations, features, means, or instructions for receive information that indicate a capability of a second network entity to communicate time interleaved respective instances of respective TBs that may be for the multicast service or the broadcast service, where transmitting the first set of one or more DCI messages, transmitting the second set of one or more DCI messages, transmitting the first set of instances of the first TB, or transmitting the second set of instances of the second TB, or any combination thereof, may be based on receiving the information.

A method for wireless communication by a network entity for wireless communication is described. The method may include receiving control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof, receiving, via a set of one or more PDSCHs according to the one or more parameters, a first set of instances of a first TB of the set of multiple TBs and a second set of instances of a second TB of the set of multiple TBs for a multicast service or for a broadcast service, where the first set of instances of the first TB and the second set of instances of the second TB are time interleaved, and decoding the first TB based on reception of the first set of instances of the first TB.

A network entity for wireless communication for wireless communication is described. The network entity for wireless communication may include one or more memories storing processor executable code, and one or more processors coupled with the one or more memories. The one or more processors may individually or collectively operable to execute the code to cause the network entity for wireless communication to receive control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof, receive, via a set of one or more PDSCHs according to the one or more parameters, a first set of instances of a first TB of the set of multiple TBs and a second set of instances of a second TB of the set of multiple TBs for a multicast service or for a broadcast service, where the first set of instances of the first TB and the second set of instances of the second TB are time interleaved, and decode the first TB based on reception of the first set of instances of the first TB.

Another network entity for wireless communication for wireless communication is described. The network entity for wireless communication may include means for receiving control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof, means for receiving, via a set of one or more PDSCHs according to the one or more parameters, a first set of instances of a first TB of the set of multiple TBs and a second set of instances of a second TB of the set of multiple TBs for a multicast service or for a broadcast service, where the first set of instances of the first TB and the second set of instances of the second TB are time interleaved, and means for decoding the first TB based on reception of the first set of instances of the first TB.

A non-transitory computer-readable medium storing code for wireless communication is described. The code may include instructions executable by one or more processors to receive control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof, receive, via a set of one or more PDSCHs according to the one or more parameters, a first set of instances of a first TB of the set of multiple TBs and a second set of instances of a second TB of the set of multiple TBs for a multicast service or for a broadcast service, where the first set of instances of the first TB and the second set of instances of the second TB are time interleaved, and decode the first TB based on reception of the first set of instances of the first TB.

Some examples of the method, network entities, and non-transitory computer-readable medium described herein may further include operations, features, means, or instructions for receiving the control information and decoding the first TB may be based on the network entity being of a first generation of network entity that may be different from a second generation of network entity, or the network entity being capable of communicating time interleaved respective instances of respective TBs that may be for the multicast service or the broadcast service, or both.

Some examples of the method, network entities, and non-transitory computer-readable medium described herein may further include operations, features, means, or instructions for receive one or more RRC messages.

In some examples of the method, network entities, and non-transitory computer-readable medium described herein, the one or more RRC messages semi-statically configure the one or more parameters.

Some examples of the method, network entities, and non-transitory computer-readable medium described herein may further include operations, features, means, or instructions for receive one or more DCI messages.

In some examples of the method, network entities, and non-transitory computer-readable medium described herein, at least one DCI message of the one or more DCI messages schedules resources for receiving one or more of the set of multiple TBs and activates the one or more parameters.

In some examples of the method, network entities, and non-transitory computer-readable medium described herein, the one or more DCI messages may be in a format supported by the network entity for scheduling time interleaved TBs for the multicast service or the broadcast service.

In some examples of the method, network entities, and non-transitory computer-readable medium described herein, the one or more DCI messages may be associated with one or more of a group radio network temporary identifier, a control resource set, a search space set, or any combination thereof and the association may be indicative that the one or more DCI messages pertain to communications of the multicast service or the broadcast service.

In some examples of the method, network entities, and non-transitory computer-readable medium described herein, the one or more DCI messages include a time domain resource allocation index corresponding to a time domain resource allocation table that includes entries for the one or more parameters.

In some examples of the method, network entities, and non-transitory computer-readable medium described herein, the one or more DCI messages include dedicated fields for the one or more parameters.

Some examples of the method, network entities, and non-transitory computer-readable medium described herein may further include operations, features, means, or instructions for receive second control information that indicates a pattern of HPIDs corresponding to instances of the set of multiple TBs, where each respective instance of the first set of instances of the first TB corresponds to a respective HPID of the pattern of HPIDs and each respective instance of the second set of instances of the second TB corresponds to a respective HPID of the pattern of HPIDs, and where the first set of instances of the first TB and the second set of instances of the second TB may be time interleaved based on the pattern of HPIDs.

Some examples of the method, network entities, and non-transitory computer-readable medium described herein may further include operations, features, means, or instructions for decode the first TB based on the TB scaling factor, where a size of the first TB may be based on the TB scaling factor and the respective quantity of instances of the first set of instances of the first TB.

Some examples of the method, network entities, and non-transitory computer-readable medium described herein may further include operations, features, means, or instructions for decode the first TB based on a low-density parity-check (LDPC) base graph defined by a coding rate and a payload size of the first TB, and where the payload size of the first TB may be based on the TB scaling factor applied to an unscaled TB size.

Some examples of the method, network entities, and non-transitory computer-readable medium described herein may further include operations, features, means, or instructions for decode the first TB based on a limited buffer rate matching (LBRM) size that may be defined by the TB scaling factor.

In some examples of the method, network entities, and non-transitory computer-readable medium described herein, a threshold data rate per time duration of a set of multiple time durations that correspond to the first set of instances of the first TB may be based on the TB scaling factor.

In some examples of the method, network entities, and non-transitory computer-readable medium described herein, the threshold data rate per time duration for a component carrier for the multicast service or the broadcast service may be less than or equal to a second threshold data rate for unicast signaling.

Some examples of the method, network entities, and non-transitory computer-readable medium described herein may further include operations, features, means, or instructions for receive second control information that indicates one or more RV index patterns, where a RV index of a first RV index pattern corresponds to each respective instance of the first set of instances, and where an order of the first set of instances of the first TB may be based on the first RV index pattern.

Some examples of the method, network entities, and non-transitory computer-readable medium described herein may further include operations, features, means, or instructions for select the first RV index pattern from the one or more RV index patterns based on the quantity of the first set of instances of the first TB satisfying a threshold quantity, where the first set of instances of the first TB and the second set of instances of the second TB may be time interleaved based on the first RV index pattern.

A method for wireless communication by a network entity for wireless communication is described. The method may include transmitting control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof and transmitting, via a set of one or more PDSCHs according to the one or more parameters, a first set of instances of a first TB and a second set of instances of a second TB for a multicast service or a broadcast service, where the first set of instances of the first TB and the second set of instances of the second TB are time interleaved.

A network entity for wireless communication for wireless communication is described. The network entity for wireless communication may include one or more memories storing processor executable code, and one or more processors coupled with the one or more memories. The one or more processors may individually or collectively operable to execute the code to cause the network entity for wireless communication to transmit control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof and transmit, via a set of one or more PDSCHs according to the one or more parameters, a first set of instances of a first TB and a second set of instances of a second TB for a multicast service or a broadcast service, where the first set of instances of the first TB and the second set of instances of the second TB are time interleaved.

Another network entity for wireless communication for wireless communication is described. The network entity for wireless communication may include means for transmitting control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof and means for transmitting, via a set of one or more PDSCHs according to the one or more parameters, a first set of instances of a first TB and a second set of instances of a second TB for a multicast service or a broadcast service, where the first set of instances of the first TB and the second set of instances of the second TB are time interleaved.

A non-transitory computer-readable medium storing code for wireless communication is described. The code may include instructions executable by one or more processors to transmit control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof and transmit, via a set of one or more PDSCHs according to the one or more parameters, a first set of instances of a first TB and a second set of instances of a second TB for a multicast service or a broadcast service, where the first set of instances of the first TB and the second set of instances of the second TB are time interleaved.

Some examples of the method, network entities, and non-transitory computer-readable medium described herein may further include operations, features, means, or instructions for transmit one or more RRC messages.

In some examples of the method, network entities, and non-transitory computer-readable medium described herein, the one or more RRC messages semi-statically configure the one or more parameters.

Some examples of the method, network entities, and non-transitory computer-readable medium described herein may further include operations, features, means, or instructions for transmit one or more DCI messages.

In some examples of the method, network entities, and non-transitory computer-readable medium described herein, at least one DCI message of the one or more DCI messages schedules resources for receiving one or more of the set of multiple TBs and activates the one or more parameters.

In some examples of the method, network entities, and non-transitory computer-readable medium described herein, the control information includes one or more DCI messages that may be in a format supported by a second network entity for scheduling time interleaved TBs for the multicast service or the broadcast service.

In some examples of the method, network entities, and non-transitory computer-readable medium described herein, the one or more DCI messages may be associated with one or more of a group radio network temporary identifier, a control resource set, a search space set, or any combination thereof and the association may be indicative that the one or more DCI messages include the one or more parameters and pertain to communications of the multicast service or the broadcast service.

In some examples of the method, network entities, and non-transitory computer-readable medium described herein, the one or more DCI messages include dedicated fields for the one or more parameters.

In some examples of the method, network entities, and non-transitory computer-readable medium described herein, the one or more DCI messages include a time domain resource allocation index corresponding to a time domain resource allocation table including entries for the one or more parameters.

Some examples of the method, network entities, and non-transitory computer-readable medium described herein may further include operations, features, means, or instructions for transmit second control information that indicates a pattern of HPIDs corresponding to instances of the set of multiple TBs, where each respective instance of the first set of instances of the first TB corresponds to a respective HPID of the pattern of HPIDs and each respective instance of the second set of instances of the second TB corresponds to a respective HPID of the pattern of HPIDs, and where the first set of instances of the first TB and the second set of instances of the second TB may be time interleaved based on the pattern of HPIDs.

In some examples of the method, network entities, and non-transitory computer-readable medium described herein, a size of the first TB may be based on the TB scaling factor and the respective quantity of instances of the first set of instances of the first TB.

In some examples of the method, network entities, and non-transitory computer-readable medium described herein, a threshold data rate per time duration of a set of multiple time durations that corresponds to the first set of instances of the first TB may be based on the TB scaling factor.

Some examples of the method, network entities, and non-transitory computer-readable medium described herein may further include operations, features, means, or instructions for transmit second control information that indicates one or more RV index patterns, where a RV index of a first RV index pattern corresponds to each respective instance of the first set of instances, and where an order of the first set of instances of the first TB may be based on the first RV index pattern.

A method for wireless communication by a network entity for wireless communication is described. The method may include receiving control information that schedules one or more respective instances of a set of multiple respective TBs, where the one or more respective instances of the set of multiple respective TBs are time interleaved according to a time interleaving pattern, a timing gap being between each of the one or more respective instances of the set of multiple respective TBs, receiving, via a first set of one or more PDSCHs and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process, and decode at least the first TB basing on reception of the first set of instances of the first TB.

A network entity for wireless communication for wireless communication is described. The network entity for wireless communication may include one or more memories storing processor executable code, and one or more processors coupled with the one or more memories. The one or more processors may individually or collectively operable to execute the code to cause the network entity for wireless communication to receive control information that schedules one or more respective instances of a set of multiple respective TBs, where the one or more respective instances of the set of multiple respective TBs are time interleaved according to a time interleaving pattern, a timing gap being between each of the one or more respective instances of the set of multiple respective TBs, receive, via a first set of one or more PDSCHs and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process, and decode at least the first TB based on reception of the first set of instances of the first TB.

Another network entity for wireless communication for wireless communication is described. The network entity for wireless communication may include means for receiving control information that schedules one or more respective instances of a set of multiple respective TBs, where the one or more respective instances of the set of multiple respective TBs are time interleaved according to a time interleaving pattern, a timing gap being between each of the one or more respective instances of the set of multiple respective TBs, means for receiving, via a first set of one or more PDSCHs and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process, and means for decode at least the first TB basing on reception of the first set of instances of the first TB.

A non-transitory computer-readable medium storing code for wireless communication is described. The code may include instructions executable by one or more processors to receive control information that schedules one or more respective instances of a set of multiple respective TBs, where the one or more respective instances of the set of multiple respective TBs are time interleaved according to a time interleaving pattern, a timing gap being between each of the one or more respective instances of the set of multiple respective TBs, receive, via a first set of one or more PDSCHs and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process, and decode at least the first TB based on reception of the first set of instances of the first TB.

In some examples of the method, network entities, and non-transitory computer-readable medium described herein, the control information may be configured to be decodable by at least a second network entity that may be of a different generation than the network entity, the network entity and the second network entity may be capable of decoding the control information, and the network entity may be capable of communicating time interleaved respective instances of respective TBs that may be for the multicast service or the broadcast service, or both.

Some examples of the method, network entities, and non-transitory computer-readable medium described herein may further include operations, features, means, or instructions for monitor for the first set of instances of the first TB and the second set of instances of the second TB via a bandwidth that satisfies a threshold bandwidth for multicast or broadcast via at least one PDSCH.

Some examples of the method, network entities, and non-transitory computer-readable medium described herein may further include operations, features, means, or instructions for transmit registration information that indicates a capability of the network entity to receive the one or more respective instances of the set of multiple respective TBs via the threshold bandwidth, where, to monitor for the first set of instances of the first TB, the processing system may be configured to and monitor for the first set of instances of the first TB based on transmission of the registration information.

In some examples of the method, network entities, and non-transitory computer-readable medium described herein, the threshold bandwidth may be a reduced bandwidth, the reduced bandwidth includes less frequency resources than a second bandwidth for receiving a fourth set of instances of a fourth TB, and the fourth set of instances may be a single instance, may be not time interleaved with instances of a fifth TB, or may be associated with a single PDSCH, or any combination thereof.

In some examples of the method, network entities, and non-transitory computer-readable medium described herein, the threshold bandwidth may be a 5 megahertz bandwidth.

In some examples of the method, network entities, and non-transitory computer-readable medium described herein, the control information includes one or more DCI messages that schedule the first set of instances of the first TB, the one or more DCI messages including an identifier that may be indicative that the first set of instances correspond to the first TB and reception of the first set of instances of the first TB of the set of multiple respective TBs for the multicast service or the broadcast service in accordance with the timing gap may be based on the identifier that may be indicative that the first set of instances correspond to the first TB.

Some examples of the method, network entities, and non-transitory computer-readable medium described herein may further include operations, features, means, or instructions for perform a soft combination on one or more instances of the first set of instances of the first TB based on the control information including an indication that each instance of the one or more instances of the first set of instances may be of the first TB.

A method for wireless communication by a network entity for wireless communication is described. The method may include transmitting control information that schedules one or more respective instances of a set of multiple respective TBs, where the one or more respective instances of the set of multiple respective TBs are time interleaved according to a time interleaving pattern, a timing gap being between each of the one or more respective instances of the set of multiple respective TBs and transmitting, via a first set of one or more PDSCHs and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process.

A network entity for wireless communication for wireless communication is described. The network entity for wireless communication may include one or more memories storing processor executable code, and one or more processors coupled with the one or more memories. The one or more processors may individually or collectively operable to execute the code to cause the network entity for wireless communication to transmit control information that schedules one or more respective instances of a set of multiple respective TBs, where the one or more respective instances of the set of multiple respective TBs are time interleaved according to a time interleaving pattern, a timing gap being between each of the one or more respective instances of the set of multiple respective TBs and transmit, via a first set of one or more PDSCHs and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process.

Another network entity for wireless communication for wireless communication is described. The network entity for wireless communication may include means for transmitting control information that schedules one or more respective instances of a set of multiple respective TBs, where the one or more respective instances of the set of multiple respective TBs are time interleaved according to a time interleaving pattern, a timing gap being between each of the one or more respective instances of the set of multiple respective TBs and means for transmitting, via a first set of one or more PDSCHs and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process.

A non-transitory computer-readable medium storing code for wireless communication is described. The code may include instructions executable by one or more processors to transmit control information that schedules one or more respective instances of a set of multiple respective TBs, where the one or more respective instances of the set of multiple respective TBs are time interleaved according to a time interleaving pattern, a timing gap being between each of the one or more respective instances of the set of multiple respective TBs and transmit, via a first set of one or more PDSCHs and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process.

In some examples of the method, network entities, and non-transitory computer-readable medium described herein, the control information may be configured to be decodable by at least a second network entity that may be of a different generation than a third network entity, the second network entity and the third network entity may be capable of decoding the control information, and the third network entity may be capable of communicating time interleaved respective instances of respective TBs that may be for the multicast service or the broadcast service, or both.

In some examples of the method, network entities, and non-transitory computer-readable medium described herein, the first set of instances of the first TB and the second set of instances of the second TB may be transmitted via a bandwidth that satisfies a threshold bandwidth for the multicast service or the broadcast service via at least one PDSCH.

Some examples of the method, network entities, and non-transitory computer-readable medium described herein may further include operations, features, means, or instructions for receive registration information that indicates a capability of a second network entity to receive the one or more respective instances of the set of multiple respective TBs via the threshold bandwidth, where the first set of instances of the first TB may be transmitted based on the registration information.

In some examples of the method, network entities, and non-transitory computer-readable medium described herein, the threshold bandwidth may be a reduced bandwidth, the reduced bandwidth includes less frequency resources than a second bandwidth for receiving a fourth set of instances of a fourth TB, and the fourth set of instances may be a single instance, may be not time interleaved with instances of a fifth TB, or may be associated with a single PDSCH, or any combination thereof.

In some examples of the method, network entities, and non-transitory computer-readable medium described herein, the threshold bandwidth may be a 5 megahertz bandwidth.

In some examples of the method, network entities, and non-transitory computer-readable medium described herein, the control information includes one or more DCI messages that schedule the first set of instances of the first TB, the one or more DCI messages including an identifier that may be indicative that the first set of instances correspond to the first TB and transmission of the first set of instances of the first TB of the set of multiple respective TBs for the multicast service or the broadcast service in accordance with the timing gap may be based on the identifier.

A method for wireless communication by a network entity is described. The method may include receiving a first set of one or more DCI messages that collectively schedule a first set of instances of a first TB, receiving a second set of one or more DCI messages that collectively schedule a second set of instances of a second TB, receiving, via a set of one or more PDSCHs in accordance with the first set of one or more DCI messages and the second set of one or more DCI messages, the first set of instances of the first TB and the second set of instances of the second TB for a multicast service or for a broadcast service, where at least one instance of the first set of instances of the first TB is time interleaved with the second set of instances of the second TB, and decoding the first TB based on reception of the first set of instances of the first TB.

A network entity for wireless communication is described. The network entity may include one or more memories storing processor executable code, and one or more processors coupled with the one or more memories. The one or more processors may individually or collectively operable to execute the code to cause the network entity to receive a first set of one or more DCI messages that collectively schedule a first set of instances of a first TB, receive a second set of one or more DCI messages that collectively schedule a second set of instances of a second TB, receive, via a set of one or more PDSCHs in accordance with the first set of one or more DCI messages and the second set of one or more DCI messages, the first set of instances of the first TB and the second set of instances of the second TB for a multicast service or for a broadcast service, where at least one instance of the first set of instances of the first TB is time interleaved with the second set of instances of the second TB, and decode the first TB based on reception of the first set of instances of the first TB.

Another network entity for wireless communication is described. The network entity may include means for receiving a first set of one or more DCI messages that collectively schedule a first set of instances of a first TB, means for receiving a second set of one or more DCI messages that collectively schedule a second set of instances of a second TB, means for receiving, via a set of one or more PDSCHs in accordance with the first set of one or more DCI messages and the second set of one or more DCI messages, the first set of instances of the first TB and the second set of instances of the second TB for a multicast service or for a broadcast service, where at least one instance of the first set of instances of the first TB is time interleaved with the second set of instances of the second TB, and means for decoding the first TB based on reception of the first set of instances of the first TB.

A non-transitory computer-readable medium storing code for wireless communication is described. The code may include instructions executable by one or more processors to receive a first set of one or more DCI messages that collectively schedule a first set of instances of a first TB, receive a second set of one or more DCI messages that collectively schedule a second set of instances of a second TB, receive, via a set of one or more PDSCHs in accordance with the first set of one or more DCI messages and the second set of one or more DCI messages, the first set of instances of the first TB and the second set of instances of the second TB for a multicast service or for a broadcast service, where at least one instance of the first set of instances of the first TB is time interleaved with the second set of instances of the second TB, and decode the first TB based on reception of the first set of instances of the first TB.

In some examples of the method, network entities, and non-transitory computer-readable medium described herein, decoding the first TB may include operations, features, means, or instructions for performing a soft combination of one or more instances of the first set of instances of the first TB based on the first set of one or more DCI messages including an indication that each instance of the one or more instances of the first set of instances may be of the first TB.

In some examples of the method, network entities, and non-transitory computer-readable medium described herein, decoding the first TB may include operations, features, means, or instructions for decoding the first TB based on the network entity being of a first generation of network entity that may be different from a second generation of network entity, or the network entity being capable of communicating time interleaved respective instances of respective TBs that may be for the multicast service or the broadcast service, or both.

In some examples of the method, network entities, and non-transitory computer-readable medium described herein, the first set of one or more DCI messages and the second set of one or more DCI messages may be configured to be decodable by at least a second network entity that may be of a different generation than the network entity, the network entity and the second network entity may be capable of decoding the first set of one or more DCI messages and the second set of one or more DCI messages, and the network entity may be capable of communicating time interleaved respective instances of respective TBs that may be for the multicast service or the broadcast service, or both.

In some examples of the method, network entities, and non-transitory computer-readable medium described herein, each DCI message of the first set of one or more DCI messages schedules a respective instance of the first set of instances of the first TB and each DCI message of the second set of one or more DCI messages schedules a respective instance of the second set of instances of the second TB.

In some examples of the method, network entities, and non-transitory computer-readable medium described herein, each DCI message of the first set of one or more DCI messages includes a respective field indicating that the scheduled respective instance of the first set of instances corresponds to the first TB and decoding the first TB may be based on the respective field of each DCI message of the first set of one or more DCI messages.

In some examples of the method, network entities, and non-transitory computer-readable medium described herein, the respective field of each DCI message of the first set of one or more DCI messages indicates a respective HPID associated with the scheduled respective instance of the first set of instances, an NDI associated with the HPID, or both.

In some examples of the method, network entities, and non-transitory computer-readable medium described herein, the NDI associated with the respective HPID indicates whether the scheduled respective instance may be a first temporal transmission corresponding to the first TB.

In some examples of the method, network entities, and non-transitory computer-readable medium described herein, the HPID indicates whether the scheduled respective instance may be a retransmission corresponding to the first TB.

In some examples of the method, network entities, and non-transitory computer-readable medium described herein, at least one DCI message of the first set of one or more DCI messages may have DCI format 4_0.

In some examples of the method, network entities, and non-transitory computer-readable medium described herein, at least one DCI message of the first set of one or more DCI messages may be for the broadcast service and may have DCI format 4_1 and at least one DCI message of the first set of one or more DCI messages may be for the broadcast service and may have DCI format 4_2.

Some examples of the method, network entities, and non-transitory computer-readable medium described herein may further include operations, features, means, or instructions for receiving information that indicates a time window, where decoding the first TB may be based on the first set of instances being within the time window.

Some examples of the method, network entities, and non-transitory computer-readable medium described herein may further include operations, features, means, or instructions for receiving first information that indicates a quantity of the first set of instances of the first TB and second information that indicates a time delay between individual instances of the first set of instances of the first TB, where decoding the first TB may be based on the quantity and the time delay, and where the first set of one or more DCI messages may be a single DCI message that schedules the first set of instances of the first TB.

Some examples of the method, network entities, and non-transitory computer-readable medium described herein may further include operations, features, means, or instructions for receiving RRC information that corresponds to a group radio network temporary identifier associated with the network entity, where the RRC information includes the first information and the second information.

In some examples of the method, network entities, and non-transitory computer-readable medium described herein, the single DCI message includes a time domain resource allocation index that may be indicative of the first information and the second information.

Some examples of the method, network entities, and non-transitory computer-readable medium described herein may further include operations, features, means, or instructions for receiving RRC information that includes the first information, where the single DCI message includes a time domain resource allocation index that may be indicative of the second information.

Some examples of the method, network entities, and non-transitory computer-readable medium described herein may further include operations, features, means, or instructions for receiving RRC information that includes the second information, where the single DCI message includes a time domain resource allocation index that may be indicative of the first information.

In some examples of the method, network entities, and non-transitory computer-readable medium described herein, the single DCI message includes a field with more than 2 bits that indicates a RV index associated with one instance of the first set of instances of the first TB.

Some examples of the method, network entities, and non-transitory computer-readable medium described herein may further include operations, features, means, or instructions for receiving information that indicates a RV index pattern for the first set of instances of the first TB and decoding only a portion of each DCI message of the first set of one or more DCI messages, where the portion excludes a respective RV field of each respective DCI message based on receipt of the information, and where decoding the first TB may be based on the RV index pattern.

In some examples of the method, network entities, and non-transitory computer-readable medium described herein, the RV index pattern indicates that a respective RV index associated with a first temporal instance of the first set of instances of the first TB may be zero.

In some examples of the method, network entities, and non-transitory computer-readable medium described herein, at least one DCI message of the first set of one or more DCI messages includes a RV field that indicates a RV index associated with a first temporal instance of the first set of instances of the first TB, the indicated RV index corresponds to a RV index pattern of a set of multiple RV index patterns, and the RV index pattern begins with the indicated RV index.

A method for wireless communication by a network entity is described. The method may include transmitting a first set of one or more DCI messages that collectively schedule a first set of instances of a first TB, transmitting a second set of one or more DCI messages that collectively schedule a second set of instances of a second TB, and transmitting, via a set of one or more PDSCHs in accordance with the first set of one or more DCI messages and the second set of one or more DCI messages, the first set of instances of the first TB and the second set of instances of the second TB for a multicast service or a broadcast service, where at least one instance of the first set of instances of the first TB is interleaved with the second set of instances of the second TB.

A network entity for wireless communication is described. The network entity may include one or more memories storing processor executable code, and one or more processors coupled with the one or more memories. The one or more processors may individually or collectively operable to execute the code to cause the network entity to transmit a first set of one or more DCI messages that collectively schedule a first set of instances of a first TB, transmit a second set of one or more DCI messages that collectively schedule a second set of instances of a second TB, and transmit, via a set of one or more PDSCHs in accordance with the first set of one or more DCI messages and the second set of one or more DCI messages, the first set of instances of the first TB and the second set of instances of the second TB for a multicast service or a broadcast service, where at least one instance of the first set of instances of the first TB is interleaved with the second set of instances of the second TB.

Another network entity for wireless communication is described. The network entity may include means for transmitting a first set of one or more DCI messages that collectively schedule a first set of instances of a first TB, means for transmitting a second set of one or more DCI messages that collectively schedule a second set of instances of a second TB, and means for transmitting, via a set of one or more PDSCHs in accordance with the first set of one or more DCI messages and the second set of one or more DCI messages, the first set of instances of the first TB and the second set of instances of the second TB for a multicast service or a broadcast service, where at least one instance of the first set of instances of the first TB is interleaved with the second set of instances of the second TB.

A non-transitory computer-readable medium storing code for wireless communication is described. The code may include instructions executable by one or more processors to transmit a first set of one or more DCI messages that collectively schedule a first set of instances of a first TB, transmit a second set of one or more DCI messages that collectively schedule a second set of instances of a second TB, and transmit, via a set of one or more PDSCHs in accordance with the first set of one or more DCI messages and the second set of one or more DCI messages, the first set of instances of the first TB and the second set of instances of the second TB for a multicast service or a broadcast service, where at least one instance of the first set of instances of the first TB is interleaved with the second set of instances of the second TB.

In some examples of the method, network entities, and non-transitory computer-readable medium described herein, each DCI message of the first set of one or more DCI messages schedules a respective instance of the first set of instances of the first TB and each DCI message of the second set of one or more DCI messages schedules a respective instance of the second set of instances of the second TB.

In some examples of the method, network entities, and non-transitory computer-readable medium described herein, each DCI message of the first set of one or more DCI messages includes a respective field indicating that the scheduled respective instance of the first set of instances corresponds to the first TB.

In some examples of the method, network entities, and non-transitory computer-readable medium described herein, the respective field of each DCI message of the first set of one or more DCI messages indicates a respective HPID associate with the scheduled respective instance of the first set of instances, an NDI associated with the HPID, or both.

In some examples of the method, network entities, and non-transitory computer-readable medium described herein, the NDI associated with the respective HPID indicates whether the scheduled respective instance may be a first temporal transmission corresponding to the first transport block.

In some examples of the method, network entities, and non-transitory computer-readable medium described herein, the HPID indicates whether the scheduled respective instance may be a retransmission corresponding to the first TB.

In some examples of the method, network entities, and non-transitory computer-readable medium described herein, at least one DCI message of the first set of one or more DCI messages may have DCI format 4_0.

In some examples of the method, network entities, and non-transitory computer-readable medium described herein, at least one DCI message of the first set of one or more DCI messages may be for the broadcast service and may have DCI format 4_1 and at least one DCI message of the first set of one or more DCI messages may be for the broadcast service and may have DCI format 4_2.

Some examples of the method, network entities, and non-transitory computer-readable medium described herein may further include operations, features, means, or instructions for transmit information that indicates a time window associated the first set of instances and decoding the first TB.

In some examples of the method, network entities, and non-transitory computer-readable medium described herein, the first set of one or more DCI messages and the second set of one or more DCI messages may be configured to be decodable by at least a second network entity that may be of a different generation than at least a third network entity, the second network entity and the third network entity may be capable of decoding the first set of one or more DCI messages and the second set of one or more DCI messages, and the third network entity may be capable of communicating time interleaved respective instances of respective TBs that may be for the multicast service or the broadcast service, or both.

Some examples of the method, network entities, and non-transitory computer-readable medium described herein may further include operations, features, means, or instructions for transmitting first information that indicates a quantity of the first set of instances of the first TB and second information that indicates a time delay between individual instances of the first set of instances of the first TB, and where the first set of one or more DCI messages may be a single DCI message that schedules the first set of instances of the first TB.

Some examples of the method, network entities, and non-transitory computer-readable medium described herein may further include operations, features, means, or instructions for transmitting RRC information that corresponds to a group radio network temporary identifier associated with a second network entity, where the RRC information includes the first information and the second information.

In some examples of the method, network entities, and non-transitory computer-readable medium described herein, the single DCI message includes a time domain resource allocation index that may be indicative of the first information and the second information.

Some examples of the method, network entities, and non-transitory computer-readable medium described herein may further include operations, features, means, or instructions for transmitting RRC information that includes the first information, where the single DCI message includes a TDRA index that may be indicative of the second information.

Some examples of the method, network entities, and non-transitory computer-readable medium described herein may further include operations, features, means, or instructions for transmitting RRC information that includes the second information, where the single DCI message includes a time domain resource allocation index that may be indicative of the first information.

In some examples of the method, network entities, and non-transitory computer-readable medium described herein, the single DCI message includes a field with more than 2 bits that indicates a RV index associated with one instance of the first set of instances of the first TB.

In some examples of the method, network entities, and non-transitory computer-readable medium described herein, each DCI message of the first set of one or more DCI messages includes a respective field with more than 2 bits that indicates a respective RV index associated with a respective instance of the first set of instances of the first TB.

Some examples of the method, network entities, and non-transitory computer-readable medium described herein may further include operations, features, means, or instructions for transmitting information that indicates a RV index pattern for the first set of instances of the first TB, where the RV index pattern may be associated with decoding the first TB.

In some examples of the method, network entities, and non-transitory computer-readable medium described herein, the RV index pattern indicates that a respective RV index associated with a first temporal instance of the first set of instances of the first TB may be zero.

In some examples of the method, network entities, and non-transitory computer-readable medium described herein, at least one DCI message of the first set of one or more DCI messages includes a RV field that indicates a RV index associated with a first temporal instance of the first set of instances of the first TB, the indicated RV index corresponds to a RV index pattern of a set of multiple RV index patterns, and the RV index pattern begins with the indicated RV index.

Some examples of the method, network entities, and non-transitory computer-readable medium described herein may further include operations, features, means, or instructions for receiving information that indicate a capability of a second network entity to communicate time interleaved respective instances of respective TBs that may be for the multicast service or the broadcast service, where transmitting the first set of one or more DCI messages, transmitting the second set of one or more DCI messages, transmitting the first set of instances of the first TB, or transmitting the second set of instances of the second TB, or any combination thereof, may be based on receiving the information.

A method for wireless communication by a network entity is described. The method may include receiving control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof, receiving, via a set of one or more PDSCHs according to the one or more parameters, a first set of instances of a first TB of the set of multiple TBs and a second set of instances of a second TB of the set of multiple TBs for a multicast service or for a broadcast service, where the first set of instances of the first TB and the second set of instances of the second TB are time interleaved, and decoding the first TB based on reception of the first set of instances of the first TB.

A network entity for wireless communication is described. The network entity may include one or more memories storing processor executable code, and one or more processors coupled with the one or more memories. The one or more processors may individually or collectively operable to execute the code to cause the network entity to receive control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof, receive, via a set of one or more PDSCHs according to the one or more parameters, a first set of instances of a first TB of the set of multiple TBs and a second set of instances of a second TB of the set of multiple TBs for a multicast service or for a broadcast service, where the first set of instances of the first TB and the second set of instances of the second TB are time interleaved, and decode the first TB based on reception of the first set of instances of the first TB.

Another network entity for wireless communication is described. The network entity may include means for receiving control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof, means for receiving, via a set of one or more PDSCHs according to the one or more parameters, a first set of instances of a first TB of the set of multiple TBs and a second set of instances of a second TB of the set of multiple TBs for a multicast service or for a broadcast service, where the first set of instances of the first TB and the second set of instances of the second TB are time interleaved, and means for decoding the first TB based on reception of the first set of instances of the first TB.

A non-transitory computer-readable medium storing code for wireless communication is described. The code may include instructions executable by one or more processors to receive control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof, receive, via a set of one or more PDSCHs according to the one or more parameters, a first set of instances of a first TB of the set of multiple TBs and a second set of instances of a second TB of the set of multiple TBs for a multicast service or for a broadcast service, where the first set of instances of the first TB and the second set of instances of the second TB are time interleaved, and decode the first TB based on reception of the first set of instances of the first TB.

Some examples of the method, network entities, and non-transitory computer-readable medium described herein may further include operations, features, means, or instructions for receiving the control information and decoding the first TB may be based on the network entity being of a first generation of network entity that may be different from a second generation of network entity, or the network entity being capable of communicating time interleaved respective instances of respective TBs that may be for the multicast service or the broadcast service, or both.

In some examples of the method, network entities, and non-transitory computer-readable medium described herein, receiving the control information may include operations, features, means, or instructions for receiving one or more RRC messages.

In some examples of the method, network entities, and non-transitory computer-readable medium described herein, the one or more RRC messages semi-statically configure the one or more parameters.

In some examples of the method, network entities, and non-transitory computer-readable medium described herein, receiving the control information may include operations, features, means, or instructions for receiving one or more DCI messages.

In some examples of the method, network entities, and non-transitory computer-readable medium described herein, at least one DCI message of the one or more DCI messages schedules resources for receiving one or more of the set of multiple TBs and activates the one or more parameters.

In some examples of the method, network entities, and non-transitory computer-readable medium described herein, the one or more DCI messages may be in a format supported by the network entity for scheduling time interleaved TBs for the multicast service or the broadcast service.

In some examples of the method, network entities, and non-transitory computer-readable medium described herein, the one or more DCI messages may be associated with one or more of a group radio network temporary identifier, a control resource set, a search space set, or any combination thereof and the association may be indicative that the one or more DCI messages pertain to communications of the multicast service or the broadcast service.

In some examples of the method, network entities, and non-transitory computer-readable medium described herein, the one or more DCI messages include a time domain resource allocation index corresponding to a time domain resource allocation table that includes entries for the one or more parameters.

In some examples of the method, network entities, and non-transitory computer-readable medium described herein, the one or more DCI messages include dedicated fields for the one or more parameters.

Some examples of the method, network entities, and non-transitory computer-readable medium described herein may further include operations, features, means, or instructions for receiving second control information that indicates a pattern of HPIDs corresponding to instances of the set of multiple TBs, where each respective instance of the first set of instances of the first TB corresponds to a respective HPID of the pattern of HPIDs and each respective instance of the second set of instances of the second TB corresponds to a respective HPID of the pattern of HPIDs, and where the first set of instances of the first TB and the second set of instances of the second TB may be time interleaved based on the pattern of HPIDs.

In some examples of the method, network entities, and non-transitory computer-readable medium described herein, decoding the first TB may include operations, features, means, or instructions for decoding the first TB based on the TB scaling factor, where a size of the first TB may be based on the TB scaling factor and the respective quantity of instances of the first set of instances of the first TB.

In some examples of the method, network entities, and non-transitory computer-readable medium described herein, decoding the first TB may include operations, features, means, or instructions for decode the first TB based on a low-density parity-check (LDPC) base graph defined by a coding rate and a payload size of the first TB, and where the payload size of the first TB may be based on the TB scaling factor applied to an unscaled TB size.

In some examples of the method, network entities, and non-transitory computer-readable medium described herein, decoding the first TB may include operations, features, means, or instructions for decode the first TB based on a limited buffer rate matching (LBRM) size that may be defined by the TB scaling factor.

In some examples of the method, network entities, and non-transitory computer-readable medium described herein, a threshold data rate per time duration of a set of multiple time durations that correspond to the first set of instances of the first TB may be based on the TB scaling factor.

In some examples of the method, network entities, and non-transitory computer-readable medium described herein, the threshold data rate per time duration for a component carrier for the multicast service or the broadcast service may be less than or equal to a second threshold data rate for unicast signaling.

Some examples of the method, network entities, and non-transitory computer-readable medium described herein may further include operations, features, means, or instructions for receiving second control information that indicates one or more RV index patterns, where a RV index of a first RV index pattern corresponds to each respective instance of the first set of instances, and where an order of the first set of instances of the first TB may be based on the first RV index pattern.

Some examples of the method, network entities, and non-transitory computer-readable medium described herein may further include operations, features, means, or instructions for selecting the first RV index pattern from the one or more RV index patterns based on the quantity of the first set of instances of the first TB satisfying a threshold quantity, where the first set of instances of the first TB and the second set of instances of the second TB may be time interleaved based on the first RV index pattern.

A method for wireless communication by a network entity is described. The method may include transmitting control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof and transmitting, via a set of one or more PDSCHs according to the one or more parameters, a first set of instances of a first TB and a second set of instances of a second TB for a multicast service or a broadcast service, where the first set of instances of the first TB and the second set of instances of the second TB are time interleaved.

A network entity for wireless communication is described. The network entity may include one or more memories storing processor executable code, and one or more processors coupled with the one or more memories. The one or more processors may individually or collectively operable to execute the code to cause the network entity to transmit control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof and transmit, via a set of one or more PDSCHs according to the one or more parameters, a first set of instances of a first TB and a second set of instances of a second TB for a multicast service or a broadcast service, where the first set of instances of the first TB and the second set of instances of the second TB are time interleaved.

Another network entity for wireless communication is described. The network entity may include means for transmitting control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof and means for transmitting, via a set of one or more PDSCHs according to the one or more parameters, a first set of instances of a first TB and a second set of instances of a second TB for a multicast service or a broadcast service, where the first set of instances of the first TB and the second set of instances of the second TB are time interleaved.

A non-transitory computer-readable medium storing code for wireless communication is described. The code may include instructions executable by one or more processors to transmit control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof and transmit, via a set of one or more PDSCHs according to the one or more parameters, a first set of instances of a first TB and a second set of instances of a second TB for a multicast service or a broadcast service, where the first set of instances of the first TB and the second set of instances of the second TB are time interleaved.

In some examples of the method, network entities, and non-transitory computer-readable medium described herein, transmitting the control information may include operations, features, means, or instructions for transmitting one or more RRC messages.

In some examples of the method, network entities, and non-transitory computer-readable medium described herein, the one or more RRC messages semi-statically configure the one or more parameters.

In some examples of the method, network entities, and non-transitory computer-readable medium described herein, transmitting the control information may include operations, features, means, or instructions for transmitting one or more DCI messages.

In some examples of the method, network entities, and non-transitory computer-readable medium described herein, at least one DCI message of the one or more DCI messages schedules resources for receiving one or more of the set of multiple TBs and activates the one or more parameters.

In some examples of the method, network entities, and non-transitory computer-readable medium described herein, the control information includes one or more DCI messages that may be in a format supported by a second network entity for scheduling time interleaved TBs for the multicast service or the broadcast service.

In some examples of the method, network entities, and non-transitory computer-readable medium described herein, the one or more DCI messages may be associated with one or more of a group radio network temporary identifier, a control resource set, a search space set, or any combination thereof and the association may be indicative that the one or more DCI messages include the one or more parameters and pertain to communications of the multicast service or the broadcast service.

In some examples of the method, network entities, and non-transitory computer-readable medium described herein, the one or more DCI messages include dedicated fields for the one or more parameters.

In some examples of the method, network entities, and non-transitory computer-readable medium described herein, the one or more DCI messages include a time domain resource allocation index corresponding to a time domain resource allocation table including entries for the one or more parameters.

Some examples of the method, network entities, and non-transitory computer-readable medium described herein may further include operations, features, means, or instructions for transmitting second control information that indicates a pattern of HPIDs corresponding to instances of the set of multiple TBs, where each respective instance of the first set of instances of the first TB corresponds to a respective HPID of the pattern of HPIDs and each respective instance of the second set of instances of the second TB corresponds to a respective HPID of the pattern of HPIDs, and where the first set of instances of the first TB and the second set of instances of the second TB may be time interleaved based on the pattern of HPIDs.

In some examples of the method, network entities, and non-transitory computer-readable medium described herein, a size of the first TB may be based on the TB scaling factor and the respective quantity of instances of the first set of instances of the first TB.

In some examples of the method, network entities, and non-transitory computer-readable medium described herein, a threshold data rate per time duration of a set of multiple time durations that corresponds to the first set of instances of the first TB may be based on the TB scaling factor.

Some examples of the method, network entities, and non-transitory computer-readable medium described herein may further include operations, features, means, or instructions for transmitting second control information that indicates one or more RV index patterns, where a RV index of a first RV index pattern corresponds to each respective instance of the first set of instances, and where an order of the first set of instances of the first TB may be based on the first RV index pattern.

A method for wireless communication by a network entity is described. The method may include receiving control information that schedules one or more respective instances of a set of multiple respective TBs, where the one or more respective instances of the set of multiple respective TBs are time interleaved according to a time interleaving pattern, a timing gap being between each of the one or more respective instances of the set of multiple respective TBs, receiving, via a first set of one or more PDSCHs and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process, and decode at least the first TB basing on reception of the first set of instances of the first TB.

A network entity for wireless communication is described. The network entity may include one or more memories storing processor executable code, and one or more processors coupled with the one or more memories. The one or more processors may individually or collectively operable to execute the code to cause the network entity to receive control information that schedules one or more respective instances of a set of multiple respective TBs, where the one or more respective instances of the set of multiple respective TBs are time interleaved according to a time interleaving pattern, a timing gap being between each of the one or more respective instances of the set of multiple respective TBs, receive, via a first set of one or more PDSCHs and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process, and decode at least the first TB base on reception of the first set of instances of the first TB.

Another network entity for wireless communication is described. The network entity may include means for receiving control information that schedules one or more respective instances of a set of multiple respective TBs, where the one or more respective instances of the set of multiple respective TBs are time interleaved according to a time interleaving pattern, a timing gap being between each of the one or more respective instances of the set of multiple respective TBs, means for receiving, via a first set of one or more PDSCHs and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process, and means for decode at least the first TB basing on reception of the first set of instances of the first TB.

A non-transitory computer-readable medium storing code for wireless communication is described. The code may include instructions executable by one or more processors to receive control information that schedules one or more respective instances of a set of multiple respective TBs, where the one or more respective instances of the set of multiple respective TBs are time interleaved according to a time interleaving pattern, a timing gap being between each of the one or more respective instances of the set of multiple respective TBs, receive, via a first set of one or more PDSCHs and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process, and decode at least the first TB base on reception of the first set of instances of the first TB.

In some examples of the method, network entities, and non-transitory computer-readable medium described herein, the control information may be configured to be decodable by at least a second network entity that may be of a different generation than the network entity, the network entity and the second network entity may be capable of decoding the control information, and the network entity may be capable of communicating time interleaved respective instances of respective TBs that may be for the multicast service or the broadcast service, or both.

Some examples of the method, network entities, and non-transitory computer-readable medium described herein may further include operations, features, means, or instructions for monitoring for the first set of instances of the first TB and the second set of instances of the second TB via a bandwidth that satisfies a threshold bandwidth for multicast or broadcast via at least one PDSCH.

Some examples of the method, network entities, and non-transitory computer-readable medium described herein may further include operations, features, means, or instructions for transmitting registration information that indicates a capability of the network entity to receive the one or more respective instances of the set of multiple respective TBs via the threshold bandwidth, where, to monitor for the first set of instances of the first TB, the processing system may be configured to and monitoring for the first set of instances of the first TB based on transmission of the registration information.

In some examples of the method, network entities, and non-transitory computer-readable medium described herein, the threshold bandwidth may be a reduced bandwidth, the reduced bandwidth includes less frequency resources than a second bandwidth for receiving a fourth set of instances of a fourth TB, and the fourth set of instances may be a single instance, may be not time interleaved with instances of a fifth TB, or may be associated with a single PDSCH, or any combination thereof.

In some examples of the method, network entities, and non-transitory computer-readable medium described herein, the threshold bandwidth may be a 5 megahertz bandwidth.

In some examples of the method, network entities, and non-transitory computer-readable medium described herein, the control information includes one or more DCI messages that schedule the first set of instances of the first TB, the one or more DCI messages including an identifier that may be indicative that the first set of instances correspond to the first TB and reception of the first set of instances of the first TB of the set of multiple respective TBs for the multicast service or the broadcast service in accordance with the timing gap may be based on the identifier that may be indicative that the first set of instances correspond to the first TB.

In some examples of the method, network entities, and non-transitory computer-readable medium described herein, decoding the first TB may include operations, features, means, or instructions for performing a soft combination on one or more instances of the first set of instances of the first TB based on the control information including an indication that each instance of the one or more instances of the first set of instances may be of the first TB.

A method for wireless communication by a network entity is described. The method may include transmitting control information that schedules one or more respective instances of a set of multiple respective TBs, where the one or more respective instances of the set of multiple respective TBs are time interleaved according to a time interleaving pattern, a timing gap being between each of the one or more respective instances of the set of multiple respective TBs and transmitting, via a first set of one or more PDSCHs and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process.

A network entity for wireless communication is described. The network entity may include one or more memories storing processor executable code, and one or more processors coupled with the one or more memories. The one or more processors may individually or collectively operable to execute the code to cause the network entity to transmit control information that schedules one or more respective instances of a set of multiple respective TBs, where the one or more respective instances of the set of multiple respective TBs are time interleaved according to a time interleaving pattern, a timing gap being between each of the one or more respective instances of the set of multiple respective TBs and transmit, via a first set of one or more PDSCHs and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process.

Another network entity for wireless communication is described. The network entity may include means for transmitting control information that schedules one or more respective instances of a set of multiple respective TBs, where the one or more respective instances of the set of multiple respective TBs are time interleaved according to a time interleaving pattern, a timing gap being between each of the one or more respective instances of the set of multiple respective TBs and means for transmitting, via a first set of one or more PDSCHs and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process.

A non-transitory computer-readable medium storing code for wireless communication is described. The code may include instructions executable by one or more processors to transmit control information that schedules one or more respective instances of a set of multiple respective TBs, where the one or more respective instances of the set of multiple respective TBs are time interleaved according to a time interleaving pattern, a timing gap being between each of the one or more respective instances of the set of multiple respective TBs and transmit, via a first set of one or more PDSCHs and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process.

In some examples of the method, network entities, and non-transitory computer-readable medium described herein, the control information may be configured to be decodable by at least a second network entity that may be of a different generation than a third network entity, the second network entity and the third network entity may be capable of decoding the control information, and the third network entity may be capable of communicating time interleaved respective instances of respective TBs that may be for the multicast service or the broadcast service, or both.

In some examples of the method, network entities, and non-transitory computer-readable medium described herein, the first set of instances of the first TB and the second set of instances of the second TB may be transmitted via a bandwidth that satisfies a threshold bandwidth for the multicast service or the broadcast service via at least one PDSCH.

Some examples of the method, network entities, and non-transitory computer-readable medium described herein may further include operations, features, means, or instructions for receiving registration information that indicates a capability of a second network entity to receive the one or more respective instances of the set of multiple respective TBs via the threshold bandwidth, where the first set of instances of the first TB may be transmitted based on the registration information.

In some examples of the method, network entities, and non-transitory computer-readable medium described herein, the threshold bandwidth may be a reduced bandwidth, the reduced bandwidth includes less frequency resources than a second bandwidth for receiving a fourth set of instances of a fourth TB, and the fourth set of instances may be a single instance, may be not time interleaved with instances of a fifth TB, or may be associated with a single PDSCH, or any combination thereof.

In some examples of the method, network entities, and non-transitory computer-readable medium described herein, the threshold bandwidth may be a 5 megahertz bandwidth.

In some examples of the method, network entities, and non-transitory computer-readable medium described herein, the control information includes one or more DCI messages that schedule the first set of instances of the first TB, the one or more DCI messages including an identifier that may be indicative that the first set of instances correspond to the first TB and transmission of the first set of instances of the first TB of the set of multiple respective TBs for the multicast service or the broadcast service in accordance with the timing gap may be based on the identifier.

### BRIEF DESCRIPTION OF THE DRAWINGS

FIG. 1 shows an example of a wireless communications system that supports inter-transport block (TB) time interleaving in accordance with one or more aspects of the present disclosure.

FIG. 2 shows an example of an inter-TB time interleaving diagram that supports inter-TB time interleaving in accordance with one or more aspects of the present disclosure.

FIGS. 3 and 4 show examples of resource allocation diagrams that support inter-TB time interleaving in accordance with one or more aspects of the present disclosure.

FIGS. 5 and 6 show examples of a process flows that support inter-TB time interleaving in accordance with one or more aspects of the present disclosure.

FIGS. 7 and 8 show block diagrams of devices that support inter-TB time interleaving in accordance with one or more aspects of the present disclosure.

FIG. 9 shows a block diagram of a communications manager that supports inter-TB time interleaving in accordance with one or more aspects of the present disclosure.

FIG. 10 shows a diagram of a system including a device that supports inter-TB time interleaving in accordance with one or more aspects of the present disclosure.

FIGS. 11 and 12 show block diagrams of devices that support inter-TB time interleaving in accordance with one or more aspects of the present disclosure.

FIG. 13 shows a block diagram of a communications manager that supports inter-TB time interleaving in accordance with one or more aspects of the present disclosure.

FIG. 14 shows a diagram of a system including a device that supports inter-TB time interleaving in accordance with one or more aspects of the present disclosure.

FIGS. 15 through 20 show flowcharts illustrating methods that support inter-TB time interleaving in accordance with one or more aspects of the present disclosure.

### DETAILED DESCRIPTION

In some wireless communications systems, a network entity may transmit signaling via a multicast and broadcast service (MBS), where the signaling may include multiple transport blocks (TBs). In some cases, the network entity may schedule sequential transmission (e.g., broadcast, multicast) of multiple instances (e.g., redundancy versions (RVs), repetitions) of a TB using a single downlink control information (DCI) message (e.g., which may be referred to herein as DCIs), where each instance may be associated with a different RV of the TB, and thus a different set of encoded bits of data of the TB. Alternatively, the network entity may schedule the transmission (e.g., broadcast, multicast) of multiple instances of the TB, where each instance of the TB corresponds to (e.g., is scheduled by) one scheduling DCI. In either case, instances of each TB may not be time interleaved, and a user equipment (UE) receiving the TBs may not be able to determine whether a received TB is a new TB or another instance (e.g., repetition or RV) of a previously received TB. Soft combining (e.g., combining received instances of a single TB to increase the likelihood of successful receipt of the full TB) may result in increased reliability of wireless signaling and decreased system latency. However, a receiving UE may not be able to perform soft combining on the different instances of received TBs based on a lack of an indication to the UE that the various instances are of the same TB.

Some scheduling DCIs for multicast or broadcast services may not include any indication of whether a TB is a new TB or an instance of a previously transmitted TB. For example, the DCIs transmitted by the network entity to schedule a set of TBs may not include a hybrid automatic repeat request (HARQ) process identifier (ID) (HPID), or a new data indicator (NDI) associated with the instances of the TB. Additionally, one or more UEs of certain generations or capabilities (e.g., legacy UEs, UEs of a first generation) may not be capable of receiving an HPID or NDI via a broadcast or multicast DCI. Thus, a method of allowing network entity UEs (e.g., advanced UEs, UEs capable of performing techniques described herein, UEs of a second generation) to perform soft combining on different instances of a TB without affecting the one or more UEs that cannot perform the soft combining is desired.

According to techniques described herein, a network entity may transmit DCIs to a UE, where the DCIs may schedule multiple instances of one or more TBs (e.g., multicast TBs, broadcast TBs), and where the multiple instances of the one or more TBs may be interleaved (e.g., in time, time-interleaved). For example, the network entity may transmit a first set of DCIs scheduling a first set of instances of a first TB, and a second set of DCIs scheduling a second set of instances of a second TB, where at least one instance of the first set of instances may be interleaved with the second set of instances.

In some cases, the first set of DCIs and the second set of DCIs may each include one DCI for each instance in the first set of instances and the second set of instances, respectively (e.g., a one-to-one ratio of DCIs to instances). For instance, a first DCI message may schedule a first transmission of a TB, a second DCI may schedule a first repetition of the TB, etc. In some examples, the DCIs may be of a first DCI format (e.g., DCI format 4_0), and the network entity may additionally include, in a field in each of the DCIs, a TB indicator (e.g., an NDI, an HPID, or both), whereby a receiving UE may determine that various instances of a TB are of the same TB (e.g., if the various instances of the TB are using a same HPID, a same NDI, or both). The UE may then decode the TB via soft combining the received instances of the TB. Additionally, or alternatively, the DCIs may be a second format of DCI (e.g., format 4_1, format 4_2, a new DCI format) which may include the field for the TB indicator (e.g., such as a HPID, an NDI, or both). Additionally, or alternatively, the network entity may indicate a time duration to the UE, where the UE may determine that two instances of a TB are of the same TB based on whether multiple TBs are received within the time duration.

Additionally, or alternatively, the network entity may schedule multiple instances of a single TB (e.g., multiple RVs or multiple repetitions of a TB) using a single DCI (e.g., a one-to-many ratio of DCIs to instances of a TB). Multiple DCIs may thus schedule multiple interleaved instances of various TBs. The network entity may also indicate a quantity of instances for each set of instances and a time delay between the instances of each set of instances to the UE. For example, the network entity may use radio resource control (RRC) signaling, DCI signaling (e.g., a TDRA index corresponding to a time domain resource allocation (TDRA) table), or both to indicate the quantity of instances of a scheduled TB and the time delay. In some cases, the network entity may transmit the RRC signaling to the UE for (e.g., via) different configurations for each group radio network temporary identifier (G-RNTI) associated with different MBS broadcast or multicast data. Additionally, or alternatively, when an index to the TDRA table indicates the time delay and the quantity of instances, the time delay may be based on the quantity of instances.

Additionally, or alternatively, the network entity may transmit one DCI to schedule the instances of both the first TB and the second TB. For example, the DCI may be of a format which indicates a quantity of TBs, a quantity of instances of each of the TBs, an inter-TB interleaving pattern, and a TB scaling factor, along with the resources for the UE to receive each instance of each TB.

In some cases, the network entity may indicate one or more parameters for receiving inter-TB interleaved transmission via broadcast or multicast. For example, for the UE to receive an MBS physical downlink shared channel (PDSCH), the UE may apply a processing time (e.g., Tproc,1) to receive the PDSCH if an HPID and an NDI are indicated in an associated physical downlink control channel (PDCCH) (e.g., DCI) scheduling the PDSCH. The network entity may indicate to the UE that the processing time (e.g., Tproc,1) may be between instances of a first TB and instances of a second TB. Additionally, or alternatively, the network entity may indicate a limited bandwidth for MBS PDSCH inter-TB interleaved transmissions for some UEs (e.g., enhanced reduced capability (eRedCap) UEs).

As described herein, the network entity, the UE, or both, may use at least one of multiple exemplary techniques for implementing MBS inter-TB time interleaving. These exemplary techniques are in no way limiting, but merely examples of possible implementations of the techniques described herein.

Aspects of the disclosure are initially described in the context of wireless communications systems. Aspects of the disclosure are also described in the context of inter-TB time interleaving diagrams, resource allocation diagrams, and process flows. Aspects of the disclosure are further illustrated by and described with reference to apparatus diagrams, system diagrams, and flowcharts that relate to inter-TB time interleaving.

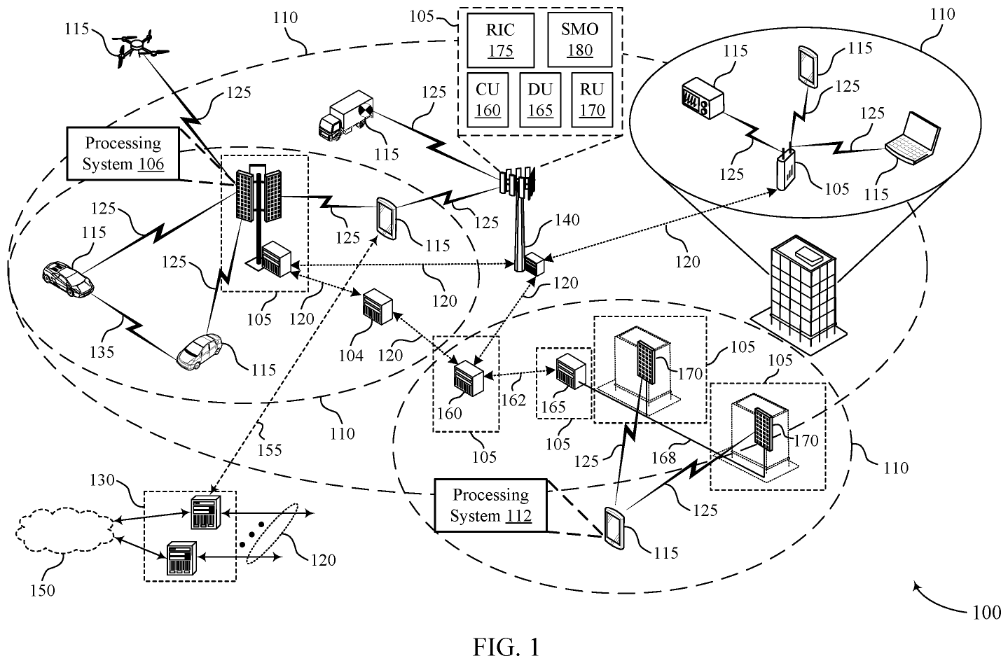

FIG. 1 shows an example of a wireless communications system 100 that supports inter-TB time interleaving in accordance with one or more aspects of the present disclosure. The wireless communications system 100 may include one or more network entities 105, one or more UEs 115, and a core network 130. In some cases, the one or more network entities 105 may include UEs, and the one or more UEs 115 may be referred to as network entities. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among 2 or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support inter-TB time interleaving as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space (SS) sets, and each SS set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. SS sets may include common SS sets configured for sending control information to multiple UEs 115 and UE-specific SS sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 105. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity (e.g., network entity 105) may include a processing system 106. Similarly, the network entity (e.g., UE 115) may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

According to techniques described herein, a network entity 105 may transmit (e.g., broadcast, multicast, unicast) DCIs to a UE 115, where the DCIs may schedule multiple instances of one or more TBs, and where the multiple instances of the one or more TBs may be interleaved (e.g., in time, time interleaved). For example, the network entity 105 may transmit a first set of DCIs scheduling a first set of instances of a first TB, and a second set of DCIs scheduling a second set of instances of a second TB, where at least one instance of the first set of instances may be interleaved with the second set of instances.

In some cases, the first set of DCIs and the second set of DCIs may each include one DCI for each instance in the first set of instances and the second set of instances, respectively (e.g., a one-to-one ratio of DCIs to instances). For instance, a first DCI message may schedule a first transmission of a TB, a second DCI may schedule a first repetition of the TB, etc. In some examples, the DCIs may be of a first DCI format (e.g., DCI format 4_0), and the network entity 105 may additionally include, in a field of the DCIs, a TB indicator (e.g., an NDI, an HPID, or both), whereby a receiving UE 115 may determine that various instances of a TB are of the same TB (e.g., if the various instances of the TB are using a same HPID, a same NDI, or both). The UE 115 may then decode the TB via soft combining the received instances of the TB. Additionally, or alternatively, the DCIs may be a second format of DCI (e.g., format 4_1, format 4_2, a new DCI format) which may include the field for indicating the TB indicator (e.g., such as an HPID, an NDI, or both). Additionally, or alternatively, the network entity 105 may indicate a time duration to the UE 115, where the UE 115 may determine that two instances of a TB are of the same TB based on whether multiple TBs (e.g., the two instances) are received within the time duration.

Additionally, or alternatively, the network entity 105 may schedule multiple instances of a single TB (e.g., multiple RVs or multiple repetitions of a TB) using a single DCI (e.g., a one-to-many ratio of DCIs to instances of a TB). Multiple DCIs may thus schedule multiple interleaved instances of various TBs. The network entity 105 may also indicate a quantity of instances for each set of instances and a time delay between the instances of each set of instances to the UE 115. For example, the network entity 105 may use radio resource control (RRC) signaling, DCI signaling (e.g., a TDRA index corresponding to a time domain resource allocation (TDRA) table), or both to indicate the quantity of instances of a scheduled TB and the time delay. In some cases, the network entity 105 may transmit the RRC signaling to the UE 115 with a different configuration (e.g., of a quantity of instances, of a time delay, or both) for each group radio network temporary identifier (G-RNTI) associated with different MBS broadcast or multicast data. Additionally, or alternatively, when an index to the TDRA table indicates the time delay and the quantity of instances, the time delay may be based on the quantity of instances.

Additionally, or alternatively, the network entity 105 may transmit one DCI to schedule the instances of both the first TB and the second TB. For example, the DCI may be of a format which indicates a quantity of TBs, a quantity of instances of each of the TBs, an inter-TB interleaving pattern, and a TB scaling factor, along with the resources for the UE 115 to receive each instance of each TB.

In some cases, the network entity 105 may indicate one or more parameters for receiving inter-TB interleaved transmission via broadcast or multicast. For example, for the UE 115 to receive an MBS PDSCH, the UE 115 may apply a processing time (e.g., Tproc,1) to receive the PDSCH if an HPID and an NDI are indicated in an associated PDCCH (e.g., DCI) scheduling the PDSCH. The network entity may indicate to the UE 115 that the processing time (e.g., Tproc,1) may be between instances of a first TB and instances of a second TB. Additionally, or alternatively, the network entity 105 may indicate a limited bandwidth for MBS PDSCH inter-TB interleaved transmissions for some UEs 115 (e.g., reduced capability (eRedCap) UEs). As described herein, the network entity 105, the UE 115, or both, may use at least one of multiple techniques for implementing MBS inter-TB time interleaving. These techniques are not intended to be limiting, but merely examples of possible implementations of the techniques described herein.

Aspects of the disclosure are initially described in the context of wireless communications systems. Aspects of the disclosure are also described in the context of inter-TB time interleaving diagrams, resource allocation diagrams, and process flows. Aspects of the disclosure are further illustrated by and described with reference to apparatus diagrams, system diagrams, and flowcharts that relate to inter-TB time interleaving.

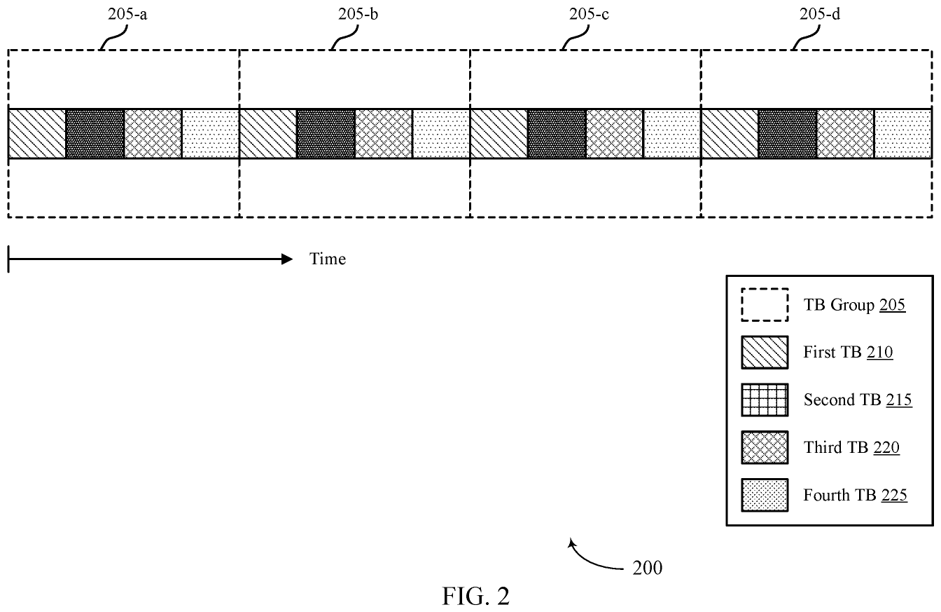

FIG. 2 shows an example of an inter-TB time interleaving diagram 200 that supports inter-TB time interleaving in accordance with one or more aspects of the present disclosure. In some cases, aspects of the inter-TB time interleaving diagram 200 may implement or be implemented by aspects of FIG. 1. For example, the inter-TB time interleaving diagram 200 may include multiple TBs (e.g., a first TB 210, a second TB 215, a third TB 220, and a fourth TB 225), which may be examples of TBs as described herein. In some aspects, a network entity (e.g., a network entity 105) and a UE (e.g., a UE 115) may communicate according to the inter-TB time interleaving diagram 200.

Some wireless communications systems may implement TB interleaving in an MBS. For example, a wireless communications system may implement time interleaving because opportunities for feedback-based retransmissions may be limited (e.g., non-existent) in MBS scenarios (e.g., while transmitting television programming). However, the wireless communications systems may not implement time interleaving of various instances (e.g., repetitions, RVs) of TBs (e.g., different TBs).

For example, wireless communications systems may implement MBS time interleaving of TBs without repetitions of each TB. A UE may receive first control signaling (e.g., DCI signaling) which may schedule a first instance of a TB, and may receive second control signaling which may schedule a second instance of the TB. However (e.g., for MBS broadcast), the first control signaling and the second control signaling may be of a format (e.g., DCI format 4_0) which may not include an HPID or an NDI. Thus, the UE may not be able to determine if the first instance of the TB and the second instance of the TB are each new data transmissions or retransmissions of the TB, which may impede the UE from performing soft combining on the first instance and the second instance to decode the TB.

Additionally, or alternatively, wireless communications systems may implement MBS time interleaving without interleaving instances of different TBs. For example, a UE may receive first control signaling (e.g., DCI signaling) scheduling multiple contiguous (e.g., slot level contiguous) instances of a first TB, where each contiguous instance of the first TB may be associated with a different redundancy version of the first TB. In some cases, the instances of the first TB may be scheduled according to an RV index order following a predefined (e.g., preconfigured) RV index order. The UE may also receive second control signaling that schedules one or more contiguous instances of a second TB. However, the instance of the first TB and the instances of the second TB may not be time interleaved, such that channel conditions for receiving the instances of the first TB and the second TB, respectively, may be similar across the instances of each respective TB (e.g., due to a short amount of time between them for the channel conditions to change). Thus, the decoding of the instances of the first TB or the second TB may suffer due to poor channel conditions during reception of each of the respective instances.

In some cases, a network entity may receive an indication of a quantity of instances for the first TB (e.g., via RRC signaling, pdsch-AggregationFactor configured per G-RNTI or group configured scheduling radio network temporary identifier (G-CS-RNTI)). Additionally, or alternatively, the network entity may include the quantity of instances dynamically in an entry of a TDRA table. Additionally, or alternatively, the network entity may preconfigure the UE with an RV index order for the instances of the first TB. However, due to a lack of MBS inter-TB time interleaving in some wireless communications systems, the UEs in the system may experience reduced quality in TB reception and decoding.

According to aspect of the present disclosure, a wireless communications system may support MBS inter-TB time interleaving (e.g., an MBS multicast traffic channel (MTCH) with inter-TB time interleaving) as illustrated by the inter-TB time interleaving diagram 200. In some cases, the wireless communications system may implement the MBS inter-TB time interleaving via control signaling scheduling single instances of a TB or multiple instances of a TB. Additionally, or alternatively, the control signaling may indicate TB information (e.g., TB group repetition information) associated with each instance of the TB.

In some cases, a first set of UEs (e.g., UEs of a second generation, MBS inter-TB time interleaving capable UEs) may be capable of implementing the MBS inter-TB time interleaving, and a second set of UEs (e.g., legacy UEs, UEs of a first generation) may have limited capabilities (e.g., no capabilities) to implement MBS inter-TB time interleaving. For example, the first set of UEs may be capable of implementing MBs inter-TB time interleaving, and the second set of UEs may not be capable of implementing one or more aspects of MBs inter-TB time interleaving as described herein, or may not be capable of performing soft combining procedures according to MBS inter-TB time interleaving as described herein.

However, some aspects of MBS inter-TB time interleaving (e.g., as described herein) may be compatible with the second set of UEs. For example, the techniques described herein may include utilizing one or more formats (e.g., DCI formats) or implementations of control information to support MBS inter-TB time interleaving, such that the wireless communications system may implement the MBS inter-TB time interleaving for the first set of UEs without affecting the second set of UEs (e.g., the MBS inter-TB time interleaving may be backwards compatible). Additionally, the techniques described herein may include one or more ways for a UE of the first set of UEs to differentiate control signaling for MBS inter-TB time interleaving from other (e.g., legacy) control signaling.

In some cases, the inter-TB time interleaving diagram 200 may include one or more TB groups 205 (e.g., a TB group 205-a, a TB group 205-b, a TB group 205-c, and a TB group 205-d), where each TB group 205 may include one or more interleaved instances of one or more TBs. For example, the TB group 205-a may include a first instance (e.g., associated with a first RV and RV index (e.g., RVO)) of a first TB 210, a first instance of a second TB 215, a first instance of a third TB 220, and a first instance of a fourth TB 225. The TB group 205-b may include a second instance of the first TB 210, a second instance of the second TB 215, a second instance of the third TB 220, and a second instance of the fourth TB 225. The TB groups 205-c and 205-d may follow similar patterns with a third instance and a fourth instance, respectively. With each TB group 205 scheduled in this manner, the instances of respective (e.g., different) TBs may be time-interleaved across the TB groups 205. In some cases, the TBs (e.g., the first TB 210, the second TB 215, the third TB 220, the fourth TB 225) may be multicast TBs, broadcast TBs, or both. As used herein, the term “TB” may refer to unicast TBs, multicast TBs, or broadcast TBs, or any combination thereof. Techniques described herein may support such TB interleaving in MBSs, as illustrated in diagram 200. Further, similar techniques may be applied to frequency interleaving.

According to aspects of the present disclosure, a wireless communications system may implement one or more of various techniques for MBS inter-TB time interleaving. For example, a network entity (e.g., a network entity 105) may configure a UE (e.g., a UE 115) with one or more techniques for implementing the MBS inter-TB time interleaving. For example, the network entity may configure the UE with one or more techniques for MBS inter-TB time interleaving based on a use case (e.g., multicast vs. broadcast), a data rate, or both. The present disclosure may provide detailed descriptions for multiple techniques for implementing the MBS inter-TB time interleaving. In some cases, the network entity 105, the UE 115, or both, may select one or more of the described techniques (e.g., scenarios) according to various conditions or parameters (e.g., data rate, use case, etc.).

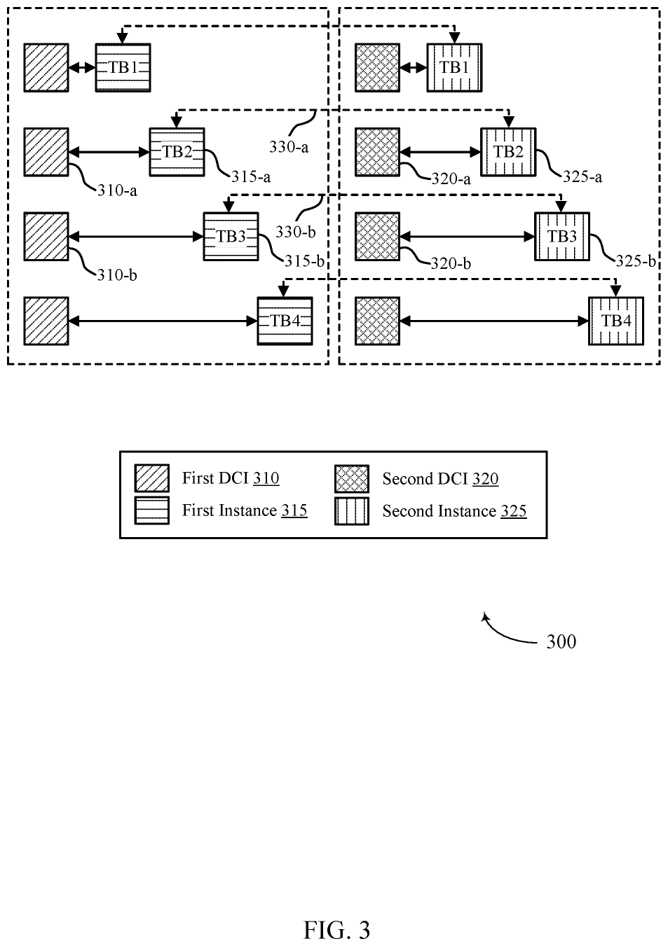

FIG. 3 shows an example of a resource allocation diagram 300 that supports signaling inter-TB time interleaving in accordance with one or more aspects of the present disclosure. In some cases, aspects of the resource allocation diagram 300 may implement or be implemented by aspects of FIGS. 1-2. For example, the resource allocation diagram 300 may include various TBs (e.g., TB1, TB2, TB3, and TB4) and instances (e.g., first instances 315, second instances 325) of the various TBs, which may be examples of TBs and instances as described herein. In some cases, a wireless communications system may implement MBS inter-TB time interleaving according to the resource allocation diagram 300.

In some cases, implementing MBS inter-TB time interleaving may include scheduling a single instance (e.g., repetition, redundancy version) of a TB via a single DCI, where instances of different TBs may be interleaved. For example, a UE (e.g., a UE 115, a network entity) may receive, from a network entity (e.g., a network entity 105), one or more first DCIs 310 (e.g., including a first DCI 310-a and a first DCI 310-b) that each schedule a first instance 315 (e.g., including a first instance 315-a and a first instance 315-b) of respective (e.g., different) TBs (e.g., a TB1, a TB2, a TB3, a TB4, multicast TBs, broadcast TBs). The UE may also receive one or more second DCIs 320 (e.g., including a second DCI 320-a and a second DCI 320-b) that each schedule a second instance 325 (e.g., including a second instance 325-a and a second instance 325-b) of the respective TB. In some cases, the phrase “the DCIs,” as used herein, may refer to the first DCIs 310, the second DCIs 320, or both.

In some cases, the UE may receive, in a first MBS PDCCH, the first DCI 310-a and the first DCI 310-b scheduling the first instance 315-a of the TB2 and the first instance 315-b of the TB3 via a first MBS PDSCH. The UE may also receive, in a second MBS PDCCH, the second DCI 320-a and the second DCI 320-b scheduling the second instance 325-a of the TB2 and the second instance 325-b of the TB3, respectively. The first instance 315-a and the second instance 325-a may be time interleaved, such that the instance of the TB2 is interleaved between instances of other TBs, including the TB3. Based on one or more indications in the first DCI 310-a and the second DCI 320-a, the UE may perform a soft combination 330-a on the first instance 315-a and the second instance 325-a. Additionally, or alternatively, based on one or more indications in the first DCI 310-b and the second DCI 320-b, the UE may perform a soft combination 330-b on the first instance 315-b and the second instance 325-b.

In some aspects, the MBS inter-TB time interleaving (e.g., as described with reference to FIG. 3) may be backwards compatible with the second set of UEs (e.g., old UEs, legacy UEs). For example (e.g., for broadcast MTCH), the second set of UEs may detect the various transmissions of the first MTCH PDCCH and the second MTCH PDCCH, and may receive the first instances 315 and the second instances 325 of the TBs. However, the second set of UEs may not perform the soft combinations 330 based on, for example, not receiving (e.g., not detecting, not decoding, not understanding) an NDI or HPID in each of the first DCIs 310 and the second DCIs 320, which may indicate to some UEs (e.g., new UEs, MBS inter-TB time interleaving capable UEs) that each of the first instances 315 may be an initial transmission of a respective TB and that each of the second instances 325 may be a retransmission of the respective TB.

However, the first set of UEs (e.g., new UEs, MBS inter-TB time interleaving capable UEs) may receive an indication that a first instance 315 and a second instance 325 of a same TB correspond to the same TB, which may allow the first set of UEs to perform the soft combinations 330. In some cases, the first DCIs 310, the second DCIs 320, or both, may indicate to a UE that a first instance 315 and a second instance 325 correspond to a same TB. For example, each of the first DCIs 310, each of the second DCIs 320, or both, may include a field for indicating that a respectively scheduled first instance 315, second instance 325, or both, corresponds to a respective TB. In some cases, the field may include an NDI, an HPID, or both. In some cases, one or more of the first DCIs 310, one or more of the second DCIs 320, or both, may be of a first DCI format (e.g., DCI format 4_0), and may additionally include the field. Additionally, or alternatively, some UEs of the second set (e.g., legacy UEs, UEs of a second generation) may ignore the field in the first DCIs 310 and the second DCIs 320, and may not combine the TBs with different RVs.

In some cases, the first DCI format may be used for the scheduling of PDSCH for broadcast in a downlink cell, and may include a cyclic redundancy check (CRC) scrambled by multicast control channel-radio network temporary identifier (MCCH-RNTI) or G-RNTI for broadcast configured by MBS-SessionInfo to indicate information to the UE. For example, the indicated information may include a frequency domain resource assignment (e.g., the size of a CORESET if the CORESET is configured for the cell, the size of initial downlink bandwidth part if the CORESET is not configured for the cell), one or more time domain resource assignments (e.g., 4 bits as defined in one or more standards documents), virtual resource block (VRB) to physical resource block (PRB) mapping (e.g., 1 bit), MCS (e.g., 5 bits), an RV (2 bits), an MCCH change notification (e.g., 2 bits if a CRC of the DCI is scrambled by MCCH-RNTI, otherwise bit field may be reserved), reserved bits (e.g., 14 bits), or any combination thereof.

Additionally, or alternatively, a second DCI format may be used to schedule interleaved TBs for MBS broadcast MTCHs. For example, the first DCIs 310, the second DCIs 320, or both, may be of a format including an indication that a respectively scheduled first instance 315, second instance 325, or both, corresponds to a respective TB. For example, one or more of the first DCIs 310, one or more of the second DCIs 320, or both, may be of a second DCI format (e.g., DCI format 4_1, DCI format 4_2), where the second DCI format may indicate an NDI, an HPID, or both, for a respectively scheduled instance of a respective TB. However, some UEs of the second set may not be capable of using DCIs of the second DCI format to detect MBS TBs (e.g., MBS broadcast MTCH).

In some cases, the second DCI format may be used for the scheduling of PDSCH for multicast in a downlink cell, and may include a CRC scrambled by G-RNTI for multicast or G-CS-RNTI configured by MBS-RNTI-SpecificConfig to indicate information to the UE. In some cases, the indicated information may include a frequency domain resource assignment (e.g., the size of a CORESET if the CORESET is configured for the cell, the size of initial downlink bandwidth part if the CORESET is not configured for the cell), one or more time domain resource assignments (e.g., 4 bits as defined in one or more standards documents), VRB to PRB mapping (e.g., 1 bit), MCS (e.g., 5 bits), an NDI (e.g., 1 bit), an RV (2 bits), a HARQ process number (e.g., 4 bits), a downlink assignment index (e.g., 2 bits), a PUCCH resource indicator (e.g., 3 bits), a PDSCH to HARQ feedback timing indicator (e.g., 3 bits), reserved bits (e.g., 3 bits), or any combination thereof.

Additionally, or alternatively, a UE implementing the MBS inter-TB time interleaving may receive control information indicating a time window, wherein the UE may determine that two or more instances correspond to a same TB based on the time window. For example, one or more of the first DCIs 310, one or more of the second DCIs 320, one or more other DCIs, or one or more RRC messages, or any combination thereof, may indicate the time window to the UE. In some cases, the UE may determine that two or more instances of a TB scheduled in a same channel or subcarrier during the time window correspond to the same TB. In some cases, the UE may receive a first instance of a TB, and after the time window expires after receiving the first instance, may receive a second instance of a TB. Based on the second instance being a first temporal instance of a TB received after the time window from receiving the first TB, the UE may determine that the first instance and the second instance are of the same TB. In some cases, the UE may decode the TB based on determining that the first instance and the second instance correspond to the same TB, which may include soft combining the first instance and the second instance. In some examples, the UE may determine that any TBs received within the time window correspond to the same TB.

In some cases, the MBS inter-TB time-interleaving (e.g., as described with reference to FIG. 3) may be associated with one or more advantages. For example, a wireless communications system implementing MBS inter-TB time interleaving may allow UEs of different generations to receive the same control signaling and shared signaling (e.g., the same PDCCH/PDSCH transmissions, the same first DCIs 310 and second DCIs 320). This may decrease signaling overhead, and may support backwards compatibility across various types of UEs supporting different capabilities.

In some cases, the first DCIs 310, the second DCIs 320, or both, may indicate an RV corresponding to a respective scheduled instance of a respective TB. The DCIs may include an RV index field including a quantity of bits for indicating the RV. For example, the quantity of bits may be two, such that UEs of the second set (e.g., legacy UEs) and the first set of UEs (e.g., new UEs, MBS inter-TB time interleaving capable UEs) may be capable of reading the RV index field. In some cases (e.g., for up to 4 instances (e.g., repetitions) of a TB), the RV index field may include 2 bits to indicate an RV index for each instance from the set of {0, 1, 2, 3}.

In some cases, a TB may correspond to more than 4 instances (e.g., more than 4 RVs). For example, the TB may correspond to 8 instances, and the DCIs may include an RV index field with more than 2 bits (e.g., 3 bits), such that the RV index field may indicate an RV index from the set of {0, 1, 2, 3, 4, 5, 6, 7}. In some cases, TBs associated with 8 instances, for example, may be associated with (e.g., achieve) a larger diversity gain than TBs associated with 4 instances.

In some cases, the DCIs may be of a format including an RV index field of more than 2 bits (e.g., 3 bits), which may indicate the RV index of a corresponding instance of a corresponding TB from the set of {0, 1, 2, 3, 4, 5, 6, 7}. For example, the DCIs may be of the second DCI format (e.g., DCI format 4_1, DCI format 4_2), as described herein, to schedule the instances of the TBs with an RV index field of more that 2 bits.

Additionally, or alternatively, a UE (e.g., a new UE) receiving a TB corresponding to more than 4 instances may receive the instances according to a predefined RV index order. For example, the UE may ignore an RV index field of 2 bits in the DCIs, and may assume that RVs of instances of a TB follow a predefined (e.g., preconfigured) order (e.g., for each instance associated with a same HPID, NDI, or both). For example, the UE may decode a portion (e.g., only a portion) of each of the first DCIs 310 and the second DCIs 320, where the portion may not include (e.g., may exclude) the RV index field of the DCIs. The UE may refrain from later decoding the excluded portion of the DCIs. In some cases, the RV index order may be {0, 4, 6, 2, 7, 3, 5, 1} for TBs associated with 8 or more instances, or the RV index order may be {0, 2, 3, 1} for TBs associated with 4 instances (e.g., or less than 8 instances).

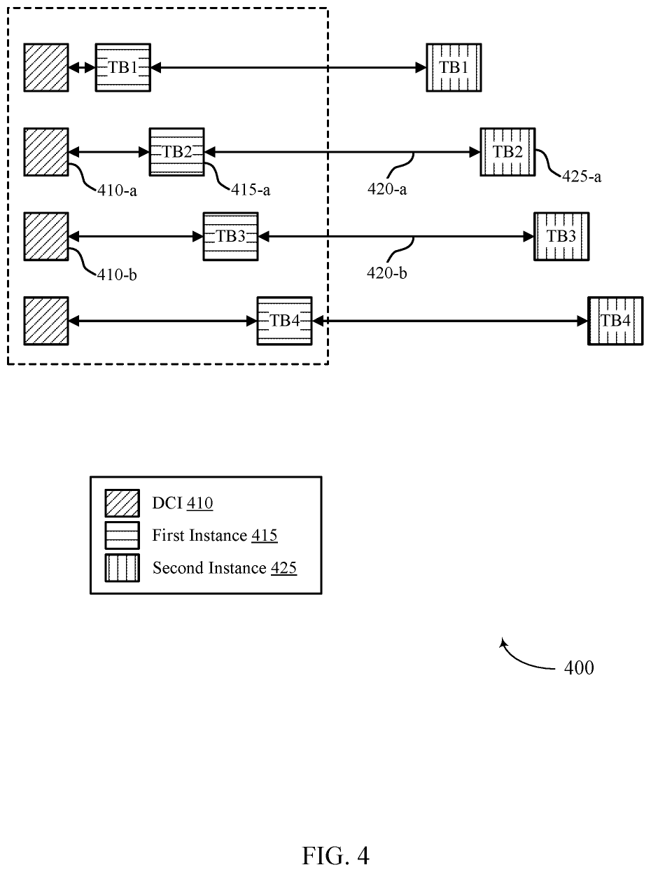

FIG. 4 shows an example of a resource allocation diagram 400 that supports inter-TB time interleaving in accordance with one or more aspects of the present disclosure. In some cases, aspects of the resource allocation diagram 400 may implement or be implemented by aspects of FIGS. 1-3. For example, the resource allocation diagram 400 may include one or more DCIs 410, one or more TBs, and one or more instances of TBs, which may be examples of DCIs, TBs, and instance of TBs, respectively, as described herein with respect to FIGS. 1-3. In some cases, a wireless communications system may implement MBS inter-TB time according to the resource allocation diagram 300.

In some cases, implementing MBS inter-TB time interleaving may include scheduling one or more instances (e.g., at least a first instance 415 and a second instance 425) of a TB via a single (e.g., one) DCI (e.g., a DCI 410, which may be referred to as a DCI message). For example, a UE (e.g., a UE 115, a network entity) may receive, from a network entity (e.g., a network entity 105), one or more DCIs 410 (e.g., including a DCI 410-a and a DCI 410-b, DCI messages), which may each schedule multiple instances (e.g., including at least a first instance 415 and a second instance 425) of a TB (e.g., including at least TB2 and TB3).

In some cases, the network entity and the UE may perform MBS single-TB scheduling with repetition and gap information. The UE may receive signaling (e.g., receive control signaling) indicating information associated with the interleaving of MBS TBs. For example, the information may include a quantity of instances for each TB, and a time delay 420 (e.g., in time, slots, symbols) between each instance of each TB. For instance, the UE may receive the DCI 410-a, which may schedule the first instance 415-a of TB 2 and the second instance 425-a of TB 2. The scheduling information may indicate a first time offset or gap between the DCI 410-a and the first instance 415-a of TB 2 (e.g., time resources, frequency resources, or both for the first instance 415-a), and the time delay 420-a between the first instance 415-a of TB 2 and the second instance 425-a of TB 2. Although the quantity of instance for each TB shown in the resource allocation diagram 400 may be two, the techniques described herein may apply to any quantity of instances. In some cases, the time delay 420-a may be the same or different from the time delay 420-b.

In some cases, the UE may receive an indication of the quantity of instances and the time delays 420 via a TDRA table or via control signaling (e.g., RRC signaling). For example, the UE may receive control signaling indicating both the quantity of instance and the time delays 420, where the control signaling may be associated with a G-RNTI associated with the UE (e.g., both repetition information and a time gap may be configured via RRC per G-RNTI). Additionally, or alternatively, a TDRA table (e . . . g, in the RRC signaling, and an index in the DCI message indicating an entry in the TDRA table) may indicate both the quantity of instances and the time delays 420, where the time delays 420 (e.g., a length of the time delays 420 in time, or in a quantity of intervals such has slots, mini-slots, symbols, or the like) may be dynamic based on a quantity of TBs (e.g., TB1, TB2, TB3, TB4) with interleaved instances. For example, if the quantity of TBs with interleaved instances increases, the time delays 420 may increase (e.g., to provide more space for instances of more TBs). In some cases, the DCIs 410 may include a TDRA index that is indicative of the quantity of instances and the time delays 420.

In some cases, some UEs (e.g., with limited capabilities or of a different type or generation) may ignore (e.g., not decode) an indication of the quantity of instances, the time delays 420, or both, in received control signaling. For example, the some UEs may assume the quantity of instances for each TB is one. Additionally, or alternatively, some UEs may ignore parameters in the TDRA table associated with the quantity of instances and the time delays 420, and may assume the quantity of instances is one.

Additionally, or alternatively, the quantity of instances and the time delays 420 may each be configured via a combination of the TDRA table or the control signaling (e.g., the RRC signaling). For example, the UE may receive control signaling (e.g., RRC signaling) indicating the quantity of instances of one or more TBs, and may determine the time delays 420 based on an entry in a TDRA table. For example, the DCIs 410 may include a TDRA index that is indicative of the time delays 420. Additionally, or alternatively, the UE may receive control signaling indicating the time delays 420, and may determine the quantity of instances based on an entry in the TDRA table. For example, the DCIs 410 may include a TDRA index that is indicative of the quantity of instances for a scheduled TB.

In some cases, some UEs may not be capable of receiving the quantity of instances of a TB and the time delays 420 each via one of the control signaling or the TDRA table. For example, some UEs may not be configured or have the capability to decode such information from the control signaling (e.g., RRC signaling, DCI signaling), or some UEs may not be configured or have the capability to determine the information from the TDRA table. Additionally, or alternatively, some UEs may be capable of receiving the DCIs 410 and the first instances 415 of the TBs in a MBS PDCCH (e.g., the first temporal instances of the TBs scheduled by the DCIs 410), but some UEs may not be capable of receiving later instances of the TBs, including the second instances 425 outside of the MBS PDCCH.

In some cases, MBS inter-TB time interleaving (e.g., as described with respect to FIG. 4) may be associated with one or more advantages. For example, due to the DCIs 410 scheduling multiple instances of the TBs, the techniques described with reference to FIG. 4 may be associated with less signaling overhead (e.g., PDCCH overhead) than the techniques described with reference to FIG. 3.

In some cases, the network entity and the UE may support MBS single-TB scheduling and indications of repetition and gaps, where repetitions and gaps may be configured. The DCIs 410 may indicate an RV index associated with one or more instances of the TBs (e.g., similar to as described herein with respect to the first DCIs 310 and the second DCIs 320 of FIG. 3). For example, a DCIs 410 may include an RV index field indicating an RV index for one or more of the instances of the respective TB scheduled by the DCI 410. In some cases, the RV index may be the same for all UEs (e.g., across multiple types of UEs, capabilities of UEs, or generations of UEs), or may be different from different UEs (e.g., different RV indices may be applied to different types of UEs, capabilities of UEs, or generations of UEs). As some UEs may not be capable of receiving or decoding the RV index field in the DCIs 410, such UEs may assume that the RV indices of the instances of the TBs scheduled by the DCIs 410 follow a predefined (e.g., preconfigured) RV index order (e.g., pattern). For example, such UEs may assume an RV index order of {0, 2, 3, 1}. Additionally, or alternatively, the RV index field of the DCIs 410 may indicate to such UEs an RV index of the first instances 415 of the TBs, which may be indicative of a predefined RV index order. For example, the RV index field may indicate an RV index of 1, and the old UEs may determine and RV index order of {1, 0, 2, 3}.

In some cases, the DCIs 410 may be of a first DCI format (e.g., DCI format 4_0, as described herein), which may include 2 bits for the RV index field. In some cases, the DCIs 410 may be of the first DCI format when the TBs (e.g., TB1, TB2, TB3, and TB4, for example) may be associated with 4 instances (e.g., the first instances 415, the second instances 425, and 2 more instances).

However, in some cases, the TBs may be associated with more than 4 instances. For example, the TBs may be associated with 8 instances (e.g., repetitions), such that the RV index of each instance may be of the set of {0, 1, 2, 3, 4, 5, 6, 7}. In some cases, an increase in a quantity of instances of a TB may increase a gain associated with the TB. In such cases, and according techniques described herein, a UE of the first set may receive the instances associated with the TB according to a predefined RV index order (e.g., for instances associated with a same HPID, NDI, or both). For example, the predefined RV index order may be {0, 4, 6, 2, 7, 3, 5, 1} for 8 or more instances.

In some cases, the network entity and the UE may support MBS single-TB scheduling and indications of repetition and gaps, where repetitions and gaps may be configured. The RV index field in a DCIs 410 may indicate an RV index order for a respective TB. For example, the RV index field may indicate at least an initial RV in the RV index order. For example, the DCIs 410 may be of the second DCI format (e.g., DCI format 4_1, DCI format 4_2, a new DCI format) which includes more that 2 bits (e.g., 3 bits) for the RV index field. Thus, the RV index field may indicate at an initial RV index (e.g., an RV index for the first instances 415) of at least the set of {0, 1, 2, 3, 4, 5, 6, 7}, where the initial RV index may be indicative of an RV index order for the instances of the TB of a set of predefined RV index orders. As another example, the DCIs 410 may be of the first DCI format, and may include 2 bits for the RV index field, such that the RV index field may indicate an initial RV index of the set of {0, 1, 2, 3}, where the initial RV index may be indicative of an RV index order for the instances of the TB of a set of predefined RV index orders.

In some examples, some UEs (e.g., of a particularly type or generation, or of limited capability) may ignore an RV index field of the DCIs 410 (e.g., of 2 or more bits). In some cases, other UEs may assume that the initial RV index (e.g., the RV index of the first instances 415) is 0. For example, the UEs may receive the DCIs 410, and may decode a portion of the DCIs 410 which does not include (e.g., excludes) the RV index field.

In some examples, a wireless communications system may implement MBS inter-TB time interleaving, where MBS single or multi-TB scheduling is supported by an indication of a quantity of TBs, a quantity of repetitions or instances per TB, an inter-TB interleaving pattern, TB scaling, or any combination thereof. In some cases, a UE (e.g., a UE with advanced capability or of a later generation, an MBS inter-TB time interleaving capable UE) may receive control information (e.g., one or more DCIs, RRC signaling) that indicates one or more parameters corresponding to one or more MBS inter-TB time interleaved TBs (e.g., and one or more respective instances corresponding to each TB). In some cases, the one or more parameters may include a quantity of TBs for MBS inter-TB time interleaving, a quantity of instances (e.g., repetitions) of each TB of the quantity of TBs, a time interleaving pattern for the instances of the TBs of the quantity of TBs, a TB scaling factor, a, or any combination thereof. Additionally, or alternatively, the HPIDs associated with each TB may be predefined to be consecutive and increasing in order. In some examples, each DCI 410 may include a set of parameters for a set of repetitions of a TB. In some examples, a single DCI 410 (e.g., the DCI 410-a) may include the parameters for multiple TBs (e.g., the DCI 410-a may include parameters for scheduling interleaved instances of the TB 2 and the TB 3, and the network entity may not transmit additional DCIs, such as the DCI 410-b).

As described herein, the one or more parameters may include a TB scaling factor, a. In some cases, the TB scaling factor may increase a data rate per slot to avoid the data rate being decreased due to interleaving the instances of the TBs across multiple slots. For example, the TB scaling factor may be used or defined via the following equation:

$$S * \frac{α}{N} \approx L , \qquad 1$$

where S may represent a size (e.g., in resources, symbols, slots, time) of each instance of a TB after applying the TB scaling factor, N may represent the quantity of TBs, and L may represent a size of a TB not associated with multiple instances or MBS inter-TB time interleaving (e.g., and thus without the TB scaling factor applied). In some cases, the TB scaling factor may increase the size of the TBs to provide higher throughput in the MBS inter-TB time interleaving scenario. Additionally, the UE may determine a low-density parity-check (LDPC) base graph (e.g., either LDPC base graph 1 or LDPC base graph 2) for each TB based on a coding rate R and payload size A of the TB. In some cases, the coding rate R may be based on an MCS index of the TB, and the payload size A may be the TB size after TB scaling. For example, A=(S*α).

Implementing the TB scaling factor may affect other aspects of communications via the MBS inter-TB time interleaved TBs. For example, a limited buffer rate matching (LBRM) may increase due to the TB scaling for MBS point-to-multipoint (PTM) transmissions. In some cases, at least for multicast transmissions, a UE may not use point-to-point (PTP) associated with a C-RNTI for the retransmission of the multicast PTM transmission if the LBRM is different between PTP and PTM transmissions associated with TB scaling.

Implementing the TB scaling factor may also affect a threshold (e.g., maximum) data rate per symbol. For example, the threshold data rate per symbol may be increased due to TB scaling for MBS PTM transmissions. In some cases, the UE, a network entity, or both, may be configured to restrict the threshold data rate in a component carrier (CC) associated with MBS with TB scaling to be no larger than that of unicast of one CC or multiple CCs. For example, the threshold data rate across a quantity of CCs (e.g., broadband, all CCs) may remain constant (e.g., may not change).

In some cases, the time interleaving pattern, an RV index order associated with the instances of the TBs, or both, may be based on the quantity of instances of each TB (e.g., indicated by the one or more parameters). For example, the RV index order for instances of a TB may be {0, 2, 3, 1} when a quantity of instances of the TB is 4. Additionally, or alternatively, the RV index order for instances of a TB may be {0, 4, 6, 2, 7, 3, 5, 1} when a quantity of instances of the TB is 8 or more.

In some cases, MBS inter-TB time interleaving (e.g., as described herein with respect to FIG. 4) may be associated with one or more advantages. For example, the techniques described herein for MBS inter-TB time interleaving may be associated with less signaling overhead (e.g., PDCCH overhead) for some UEs than the techniques described herein with reference to FIG. 3 based on, for example, being associated with less control signaling (e.g., control signaling of a smaller size after initial configuration, fewer control signaling messages).

In some examples, techniques described herein may be compatible with (e.g., may support) semipersistent scheduling (SPS). For example, a network entity may semi-statically configure any combination of the parameters described herein on a per SPS-Config basis or on a per group-configured scheduling-radio network temporary identifier (G-CS-RNTI) basis via RRC signaling. Additionally, or alternatively, the network entity may dynamically configure any combination of the parameters (e.g., on the per SPS-Config basis or on the per G-CS-RNTI basis) by an SPS activation DCI. In some cases, the UEs of the first set may receive DCIs of a first DCI format (e.g., legacy DCIs, DCI format 4_0) to trigger the SPS-Config associated with a corresponding G-CS-RNTI, which may include one or more of the parameter (e.g., RRC-configured parameters) for MBS inter-TB time interleaved TB scheduling.

As described herein, a UE may receive DCIs (e.g., or other control signaling) for dynamic scheduling of MBS inter-TB time interleaved signaling, for activation of MBS inter-TB time interleaved SPS, or both. In some cases, the DCIs may be of a format including a different size than a single-TB scheduling DCI format. The DCI format may also include a fully flexible indication of a quantity of TBs to be scheduled, a quantity of instances of each TB, the TB scaling factor, and a time interleaving pattern for the instances of the TBs.

Additionally, or alternatively, the DCIs may include one or more DCI messages of a new format including a same size for the DCI messages as a single-TB DCI. In some cases, the DCIs of the new format may be differentiated from other DCIs (e.g., single-TB PDCCH may be differentiated from new multi-TB PDCCH) via separate configured G-RNTIs, non-overlapping SS sets, non-overlapping CORESETs or any combination thereof. In some cases, elements in such a DCI format may be per entry of a TDRA table. For instance, entries of a TDRA table may include elements which may indicate (e.g., include) the parameter described herein (e.g., if the multi-TB scheduling is dynamically indicated by DCI). Additionally, or alternatively, such DCI formats may include one or more fields to indicate the parameters described herein (e.g., if the multi-TB scheduling is dynamically indicated by DCI).

As described herein, a UE (e.g., a UE 115) may implement one or more of the techniques for MBS inter-TB time interleaving described herein. For example, a network entity may select one or more of the described techniques to use for MBS broadcast services and MBS multicast services, respectively, and may configure the UE to use the selected techniques for each MBS service, respectively. For example, the network entity may select the techniques described herein with reference to FIG. 1 for MBS broadcast services, and may select the techniques described herein with reference to FIG. 4 for MBS multicast services (e.g., based on a capability of the UE).

In some cases, the network entity may select and configure the UE with one or more techniques for MBS inter-TB time interleaving based one a data rate associated with MBS signaling. For example, the network entity may select techniques described herein with reference to FIGS. 3 and 4 for MBS broadcast services associated with a low data rate (e.g., associated with a first G-RNTI or G-CS-RNTI), and may select techniques described herein with reference to FIG. 4 for MBS broadcast services associated with a high data rate (e.g., associated with a second G-RNTI or G-CS-RNTI), based on capabilities of the UE.

In some cases, a device (e.g., a UE, a UE 115, a network entity, a network entity 105) implementing MBS inter-TB time interleaving may communicate according to a configuration (e.g., schedule, timeline) based on the MBS inter-TB time interleaving. In some cases, some the first set of UEs may communicate according to a similar or a different configuration as the second set of UEs (e.g., legacy UEs).

For example, in some multicast scenarios, the second set of UEs may include a processing time (e.g., a time gap, Tproc,1) between a first PDSCH transmission and a second PDSCH transmission, whether HARQ feedback may be enabled or disabled. For example, when HARQ feedback for the HARQ process ID is disabled, the UE may not expect to receive another PDCCH carrying a DCI scheduling a PDSCH or set of slot-aggregated PDSCH scheduled for the given HARQ process or to receive another PDSCH without corresponding PDCCH for the given HARQ process that starts until the processing time after the end of the reception of the first PDSCH transmission or slot-aggregated PDSCH for that HARQ process. A same configuration may apply with enabled HARQ feedback.

In some cases, (e.g., for an eRedCap) UE supporting multicast), the processing time may apply to multicast MTCH PDSCH and a bandwidth for MTCH PDSCH may satisfy a threshold bandwidth. For example, the threshold bandwidth for PDSCH may be 5 MHz, which may be similar to a threshold bandwidth applied to unicast PDSCH.

Additionally, or alternatively, the first set of UEs may communicate according to a similar configuration as the second set of UEs (e.g., legacy UEs). For example, the processing time described herein may apply to multicast MTCH PDSCH, in addition to the gap (e.g., the time delays 420 as described herein with respect to FIG. 3) between the interleaved instances of the TBs. For the eRedCap UEs of the first set of UEs, a bandwidth of multicast MTCH PDSCH may satisfy the first bandwidth threshold.

As another example, in some broadcast scenarios, the second set of UEs may not implement the processing time. For example, the processing time may not apply to broadcast MCCH/MTCH PDSCH because an HPID, an NDI, or both, may not be explicitly indicated in a DCI of a format for broadcast (e.g., DCI format 4_0), and a UE of the second set may not be capable of determining whether an instances scheduled by the DCI (e.g., a PDSCH transmission) is an initial or retransmitted packet using the same HPID. Additionally, eRedCap UEs of the second set of UEs (e.g., that support broadcast) may not implement the processing time for broadcast MCCH/MTCH PDSCH, and a bandwidth for broadcast MCCH/MTCH PDSCH may satisfy a second bandwidth threshold. For example, the second bandwidth threshold may be 20 MHz (e.g., which may similar to a bandwidth for the PDSCH to transmit system information blocks (SIBs), paging, or both).

Additionally, or alternatively, the first set of UEs may apply the processing time to broadcast MTCH PDSCH in addition to the gap between the interleaved instances of the TBs (e.g., the time delays 420 described herein with respect to FIG. 3) if an HPID, an NDI, or both, for broadcast MTCH PDSCH is indicated by a corresponding scheduling DCI. Additionally, or alternatively, eRedCap UEs of the first set of UEs may receive an indication of the HPID, the NDI, or both, for broadcast MTCH PDSCH (e.g., vis the scheduling DCI, via other control signaling). In some cases, the bandwidth for broadcast MTCH PDSCH for the eRedCap UEs of the first set of UEs may also satisfy the first bandwidth threshold.

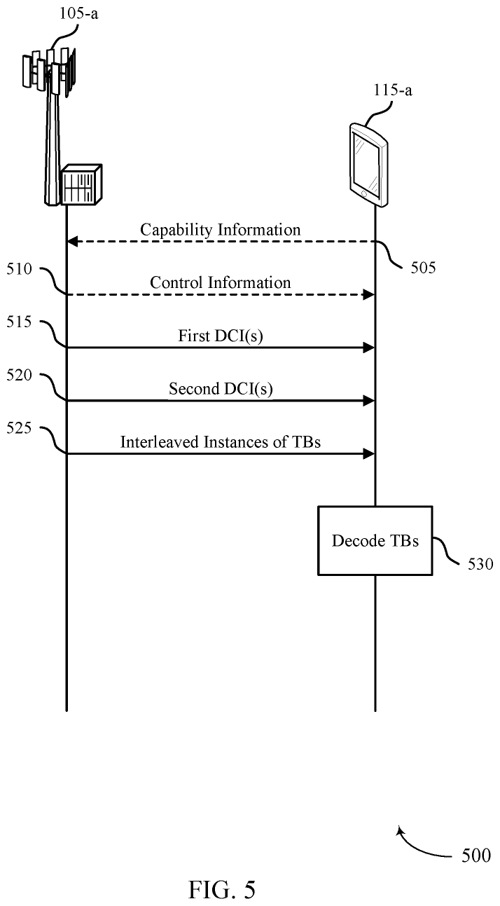

FIG. 5 shows an example of a process flow 500 that supports inter-TB time interleaving in accordance with one or more aspects of the present disclosure. In some cases, aspects of the process flow 500 may implement or be implemented by aspects of FIGS. 1-4. For example, the process flow 500 may include a network entity 105-a and a UE 115-b, which may be examples of network entities 105 and UEs 115, respectively, as described herein with respect to FIGS. 1-4. Additionally, or alternatively, the UE 115-b may be referred to as a network entity. In some cases, the UE 115-b and the network entity 105-b may MBS inter-TB time interleaved communications according to techniques described herein with respect to FIG. 3, as described herein.

In the following description of process flow 500, the operations may be performed in a different order than the order shown, or other operations may be added or removed from the process flow 500. For example, some operations may also be left out of process flow 500, may be performed in different orders or at different times, or other operations may be added to process flow 500. Although the UE 115-a and the network entity 105-a are shown performing the operations of process flow 500, some aspects of some operations may also be performed by one or more other wireless devices or network devices. In some aspects, the second network entity may refer to the UE 115-a (e.g., the UE 115-a may be an example of a network entity). As used herein, the term “DCIs” may refer to one or more DCI messages.

At 505, the network entity 105-a may receive information that indicates a capability of a second network entity (e.g., the UE 115-b) to communicate time interleaved respective instances of respective TBs that are for the multicast service or the broadcast service.

At 510, the UE 115-a may receive information (e.g., control information, RRC signaling, DCI signaling) from the network entity 105-a via one or more messages. For example, the information may indicate a time window associated with decoding a first TB associated with a first set of instances. Additionally, or alternatively, the UE 115-a may receive information that indicates a redundancy version index pattern for at least a first set of instances of a first TB.

At 515, the UE 115-a may receive, from the network entity 105-a, a first set of one or more DCIs (e.g., DCI messages) that collectively schedule the first set of instances of the first TB. In some cases, the network entity 105-a may configure the first set of one or more DCIs to be decodable by at least a different UE (e.g., a second network entity, an old UE) that is of a different generation than the UE 115-a (e.g., a new UE), wherein the UE 115-a and the different UE may be capable of decoding the first set of one or more DCIs. In some cases, the UE 115-a may be capable of communicating time interleaved respective instances of respective TBs that are for the multicast service or the broadcast service, or both, and the different UE may not be capable of such.

In some cases, each DCI of the first set of one or more DCIs may schedule a respective instance of the first set of instances of the first TB. For example, each DCI of the first set of one or more DCIs may include a respective field indicating that a scheduled respective instance of the first set of instances corresponds to the first TB.

In some cases, the first set of one or more downlink control information messages may be a single DCI that schedules the first set of instances of the first TB. In some aspects, the single DCI may include a field with 2 or more bits that indicates an RV index associated with one instance of the first set of instances of the first TB. Additionally, or alternatively, the single DCI may include a TDRA index that is indicative of first information indicating a quantity of instances of the first set of instances, second information indicating a time delay (e.g., time delays 420 of FIG. 3) between the respective instances of the first set of instances, or both. Additionally, or alternatively, the UE 115-a may receive RRC information that corresponds to a G-RNTI associated with the UE 115-a, where the RRC information includes an indication the first information, an indication of the second information, or both. For example, the UE 115-a may receive the RRC information with the information at 510.

In some cases, each DCI of the first set of DCIs may include a respective field which may indicate a respective HPID associated with the scheduled respective instance of the first set of instances, an NDI associated with the HPID, or both. For example, the NDI associated with the respective HPID may indicate whether the scheduled respective instance is a first temporal transmission corresponding to the first TB. Additionally, or alternatively, the HPID may indicate whether the scheduled respective instance is a retransmission corresponding to the first TB.

The first set of DCIs may be of one or more formats. For example, at least one DCI of the first set of one or more DCIs may have a DCI format 4_0 (e.g., the first DCI format, as described herein with respect to FIG. 3). Additionally, or alternatively, at least one DCI of the first set of one or more DCIs may be for the broadcast service and may have DCI format 4_1 or DCI format 4_2 (e.g., the second DCI format as described herein with respect to FIG. 3).

In some cases, the UE 115-a may decode some or all of each DCI of the first set of DCIs. For example, the UE 115-a may decode a portion of each DCI (e.g., only a portion) of the first set of one or more DCIs, where the portion may exclude the respective RV field of each respective DCI based on, for example, receipt of the information indicating the RV index pattern.

In some cases, the RV index pattern may indicate that a respective RV index associated with a first temporal instance of the first set of instances of the first TB is zero. In some cases, at least one DCI of the first set of one or more DCIs may include an RV field that indicates an RV index associated with a first temporal instance of the first set of instances of the first TB, wherein the indicated RV index corresponds to an RV index pattern of multiple RV index patterns. In some cases, the RV index pattern may begin with the indicated RV index.

At 520, the UE 115-a may receive (e.g., from the network entity 105-a) a second set of one or more DCIs that collectively schedule a second set of instances of a second TB. In some aspects, the second set of one or more DCIs may be similar to (e.g., follow a same configuration, pattern, or format as) the first set of DCIs. For example, each DCI of the second set of one or more DCIs may schedule a respective instance of the second set of instances of the second TB, or the second set of DCIs may be a single DCI that may schedules the second set of instances of the second TB. Additionally, the network entity 105-a may configure the second set of one or more DCIs to be decodable by at least the different UE that is of the different generation than the UE 115-a, where the UE 115-a and the other UE may be capable of decoding the first set of one or more DCIs and the second set of one or more DCIs. Additionally, or alternatively, the UE 115-a may be capable of communicating time interleaved respective instances of respective TBs that are for the multicast service or the broadcast service, or both.

At 525, the UE 115-a may receive (from the network entity 105-a) the first set of instances of the first TB and the second set of instances of the second TB for the multicast service, for the broadcast service, or for both. For example, the UE 115-a may receive the first set of instances and the second set of instances via a set of one or more PDSCHs in accordance with the first set of one or more DCIs and the second set of one or more DCIs, as described herein with respect to FIGS. 2 and 3. For example, at least one instance of the first set of instances of the first TB may be time-interleaved with the second set of instances of the second TB.

At 530, the UE 115-a may decode at least the first TB based on reception of the first set of instances of the first TB. In some cases, the UE 115-a (e.g., to decode the first TB) may perform a soft combination of one or more instances of the first set of instances of the first TB based on the first set of one or more DCIs including the indication that each instance of the one or more instances of the first set of instances is of the first TB. Additionally, or alternatively, the UE 115-a may decode the first TB based on the UE 115-a being of the first generation of UE that is different from the second generation of UE. Additionally, or alternatively, the UE 115-a may decode the first TB based on the UE 115-a being capable of communicating time interleaved respective instances of respective TBs that are for the multicast service, the broadcast service, or both.

In some cases, one or more other factors may affect the decoding of the first TB. For example, decoding the first TB may be based on the quantity of instances of the first TB and the time delay (e.g., the quantity of instances and the time delays 420 as described herein with respect to FIG. 3). Additionally, or alternatively, decoding the first TB may be based on the first set of instances being within the time window received in the information at 510 (e.g., as described herein with respect to FIG. 3). Additionally, or alternatively, the UE 115-a may decode the first TB based on the respective field of each DCI of the first set of one or more DCIs indicating that each instance of the first set of instances is of the first TB. In some cases, decoding the first TB may also be based on the RV index pattern indicated by one or more DCIs of the first set of DCIs (e.g., as described herein).

Thus, the network entity 105-a and the UE 115-a may communicate one or more instances of MBS TBs, where the one or more instances of different TBs may be time-interleaved. In some cases, this may improve communication reliability between the network entity 105-a and the UE 115-a.

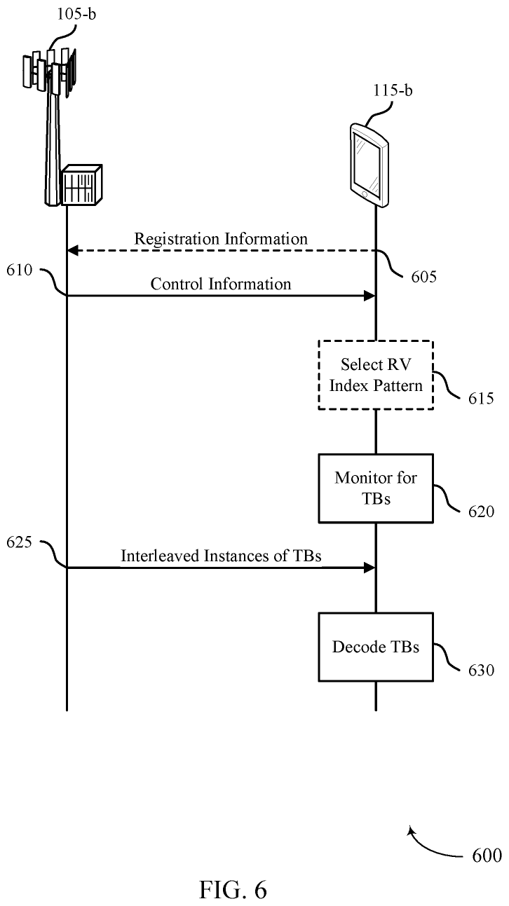

FIG. 6 shows an example of a process flow 600 that supports inter-TB time interleaving in accordance with one or more aspects of the present disclosure. In some cases, aspects of the process flow 600 may implement or be implemented by aspects of FIGS. 1-5. For example, the process flow 600 may include a network entity 105-b and a UE 115-b, which may be examples of network entities 105 and UEs 115 as described herein with respect to FIGS. 1-5. In some aspects, the network entity 105-b and the UE 115-b may perform MBS inter-TB time interleaved communications according to one or more aspects of the techniques described herein with respect to FIG. 4.

In the following description of process flow 600, the operations may be performed in a different order than the order shown, or other operations may be added or removed from the process flow 600. For example, some operations may also be left out of process flow 600, may be performed in different orders or at different times, or other operations may be added to process flow 600. Although the UE 115-b and the network entity 105-b are shown performing the operations of process flow 600, some aspects of some operations may also be performed by one or more other wireless devices or network devices. In some aspects, the second network entity may refer to the UE 115-b (e.g., the UE 115-b may be an example of a network entity). As used herein, the term “DCIs” may refer to one or more DCI messages.

At 605, the UE 115-b may transmit registration information to the network entity 105-b For example, the registration information may indicate a capability of the UE 115-b to receive one or more respective instances of multiple respective TBs via a threshold bandwidth (e.g., as described herein with respect to FIG. 4).

At 610, the UE 115-b may receive, from the network entity 105-b, control information indicative of one or more parameters that correspond to multiple TBs, wherein the one or more parameters include a quantity of TBs of the multiple TBs, a respective quantity of instances of each respective TB of the multiple TBs, a time interleaving pattern corresponding to the multiple TBs, a TB scaling factor, or any combination thereof (e.g., as described herein with reference to FIG. 4).

In some cases, to receive the control information, the UE 115-b may receive one or more RRC messages indicating the parameters (e.g., the control information may be RRC messages). For example, the one or more RRC messages may semi-statically configure the one or more parameters to the UE 115-b. In some cases, to receive the control information, the UE 115-b may receive one or more DCIs. For example, at least one DCI of the one or more DCIs may activate the one or more parameters.

In some cases, the UE 115-b may also receive control information (e.g., same control information, different control information) that schedules one or more respective instances of the multiple respective TBs, wherein the one or more respective instances of the multiple respective TBs may be time-interleaved according to the time interleaving pattern. In some cases, the one or more respective instances of the multiple respective TBs may be scheduled with a timing gap between each of the one or more respective instances.

In some cases, the control information may include one or more DCIs that schedule the first set of instances of the first TB. In some cases, the one or more DCIs may include an identifier that is indicative that the first set of instances correspond to the first TB. In some cases, at least one DCI of the one or more DCIs may schedule resources (e.g., wireless communication resources, one or more frequency resources, one or more time resources) for receiving one or more of the multiple TBs. In some cases, the one or more DCIs may be of a format supported by the UE 115-b (e.g., DCI format 4_0, DCI format 4_1, DCI format 4_2, a new DCI format) for scheduling MBS inter-TB time-interleaved TBs for the multicast service or the broadcast service.

In some cases, the one or more DCIs may be associated with one or more of indicators, where the one or more indicators may include a G-RNTI, a CORESET, an SS set, or any combination thereof. In some cases, the association of the one or more DCIs with the indicators may be indicative that the one or more DCIs pertain to communications of the multicast service or the broadcast service. Additionally, or alternatively, the one or more DCIs may include (e.g., indicate) a TDRA index corresponding to a TDRA table that includes entries for the one or more parameters, as described herein. Additionally, or alternatively, the one or more DCIs may include dedicated fields for the one or more parameters.

In some cases, the UE 115-b may receive the control information based on the UE 115-b being of a first generation of UE (e.g., a new UE, as described herein) that is different from a second generation of UE (e.g., an old UE, as described herein). Additionally, or alternatively, the UE 115-b may receive the control signaling based on the UE 115-b being capable of communicating time interleaved respective instances of respective TBs that are for a multicast service or a broadcast service. Additionally, or alternatively, the control information may include one or more DCIs that are in a format (e.g., DCI format 4_0, DCI format 4_1, DCI format 4_2) supported by a different UE for scheduling time-interleaved TBs for the multicast service or the broadcast service.

In some cases, the network entity 105-b may configure the control information to be decodable by at least the different UE, which may be of a different generation than the UE 115-b. Additionally, or alternatively, the UE 115-b and the other UE may be capable of decoding the control information, and the UE 115-b may be capable of communicating time interleaved respective instances of respective TBs that are for the multicast service or the broadcast service.

In some cases, the UE 115-b may receive control information that indicates a pattern of HPIDs corresponding to one or more instances of the multiple TBs. For example, each respective instance of the first set of instances of the first TB may correspond to a respective HPID of the pattern of HPIDs, and each respective instance of the second set of instances of the second TB may correspond to a respective HPID of the pattern of HPIDs. As described here, the first set of instances of the first TB and the second set of instances of the second TB may be time-interleaved based on the pattern of HPIDs.

In some cases, the UE 115-b may receive control information that indicates one or more RV index patterns. For example, each RV index of a first RV index pattern of the one or more RV index patterns may correspond to each respective instance of the first set of instances of the first TB. Accordingly, an order of the first set of instances of the first TB may be based on the first RV index pattern.

At 615, the UE 115-b may select the first RV index pattern from the one or more RV index patterns based on the quantity of the first set of instances of the first TB satisfying a threshold quantity. In some cases, the first set of instances of the first TB and the second set of instances of the second TB may be time-interleaved based on the first RV index pattern, due to, for example, the UE selecting the first RV index pattern.

At 620, the UE 115-b may monitor for the first set of instances of the first TB and the second set of instances of the second TB via a bandwidth that satisfies a threshold bandwidth for multicast or broadcast via at least one PDSCH. For example, the threshold bandwidth may be a 5 megahertz bandwidth. In some cases, the UE 115-b may also monitor for the first set of instances of the first TB based on transmission of the registration information.

In some cases, the threshold bandwidth may be a reduced bandwidth. For example, the reduced bandwidth may include less frequency resources than a second bandwidth for receiving a fourth set of instances of a fourth TB, where the fourth set of instances may be a single instance, may not be time-interleaved with instances of a fifth TB, or may be associated with a single PDSCH, or any combination thereof.

At 625, the UE 115-b may receive a first set of instances of a first TB of the multiple TBs and a second set of instances of a second TB of the multiple TBs for the multicast service or for the broadcast service. For example, the UE 115-b may receive the first set of instances and the second set of instances via a set of one or more PDSCHs, according to the one or more parameters, based on the time interleaving pattern, or any combination thereof. In some cases, the first set of instances of the first TB and the second set of instances of the second TB may be time-interleaved. In some cases, the first set of instances of a first TB of the multiple respective TBs may use a first HARQ process (e.g., may be associated with a first HPID), and the second set of instances of a second TB of the multiple respective TBs may use a second HARQ process (e.g., be associated with a second HPID) for a multicast service or a broadcast service.

As described herein, the UE 115-b may receive the first set of instances and the second set of instances in accordance with the timing gap (e.g., time delays 420, as describe herein with respect to FIG. 4) between each of the first set of instances and between each of the second set of instances. Additionally, or alternatively, the UE 115-b may receive the first set of instances and the second set of instances based on (e.g., according to, including) a processing timing gap (e.g., processing time, as described herein) between a termination of a first set of one or more PDSCHs associated with the first set of instances and another event. For example, the event may include receiving other control information scheduling a second set of one or more PDSCHs associated with a third TB, receiving the second set of one or more PDSCHs, or both. In some cases, the processing timing gap may satisfy a threshold processing time, and the third TB may use the first HARQ process or the second HARQ process. The UE 115-b may receive the first set of instances and the second set of instances based on the processing timing gap satisfying the threshold processing time.

In some cases, reception of the first set of instances of the first TB of the multiple respective TBs for the multicast service or the broadcast service in accordance with the timing gap may be based on the identifier included in the control information. For example, the identifier may be indicative that the first set of instances corresponds to the first TB.

At 630, the UE 115-b may decode the first TB (e.g., at least the first TB) based on receiving the first set of instances of the first TB. For example, decoding the first TB may be based on the UE 115-b being of a first generation of UE (e.g., a new UE, as described herein) that is different from a second generation of UE (e.g., old UEs, as described herein). Additionally, or alternatively, the UE 115-b may decode the first set of instances based on the UE 115-b being capable of communicating time interleaved respective instances of respective TBs that are for the multicast service or the broadcast service.

In some cases, decoding the first TB may include performing a soft combination on one or more instances of the first set of instances of the first TB. For example, the UE 115-b may perform the soft combination on one or more instances of the first set of instances of the first TB based on the control information comprising an indication that each instance of the one or more instances of the first set of instances is of the first TB.

In some cases, the UE 115-b may decode the first TB based on the TB scaling factor (e.g., as described herein with respect to FIG. 4). For example, a size of the first TB may be based on the TB scaling factor, a respective quantity of instances of the first set of instances of the first TB, or both.

Additionally, or alternatively, the UE 115-b may decode the first TB based on a LDPC base graph defined by a coding rate and a payload size of the first TB. In some cases, the payload size of the first TB may be based on the TB scaling factor applied to an unscaled TB size. Additionally, or alternatively, the UE 115-b may decode the first TB based on a LBRM size that is defined by the TB scaling factor.

Additionally, or alternatively, a threshold data rate per time duration of multiple time durations that correspond to the first set of instances of the first TB may be based on the TB scaling factor. In some cases, the threshold data rate per time duration for a component carrier for the multicast service or the broadcast service may be less than or equal to a second threshold data rate for unicast signaling.

In this way, the network entity 105-b and the UE 115-b may communicate one or more instances of one or more respective TBs via an MBS that are inter-TB time interleaved. In some cases, implementing the techniques described herein may provide for increase reliability in the MBS communications between the UE 115-b and the network entity 105-b.

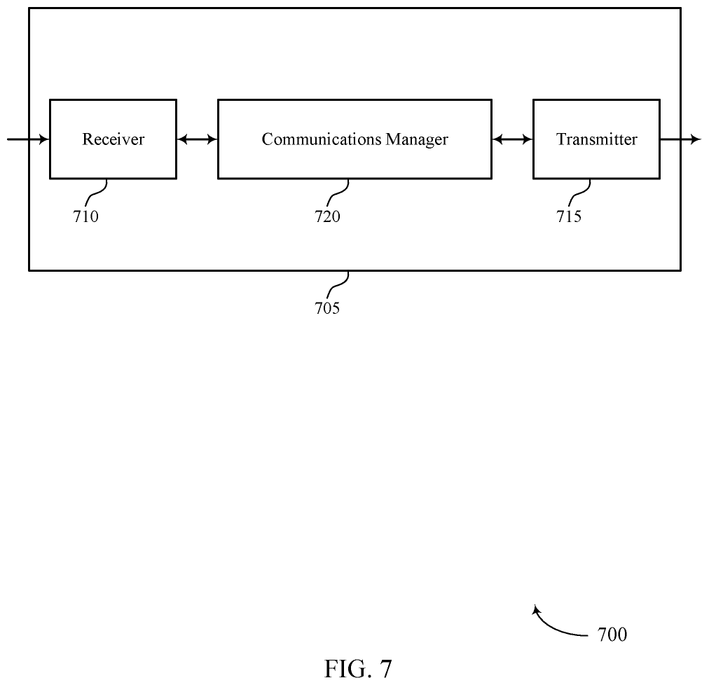

FIG. 7 shows a block diagram 700 of a device 705 that supports inter-TB time interleaving in accordance with one or more aspects of the present disclosure. The device 705 may be an example of aspects of a UE 115 as described herein, which may also be referred to as a network entity. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to inter-TB time interleaving). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to inter-TB time interleaving). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of inter-TB time interleaving as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor. If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. For example, the communications manager 720 is capable of, configured to, or operable to support a means for receiving a first set of one or more downlink control information messages that collectively schedule a first set of instances of a first TB. The communications manager 720 is capable of, configured to, or operable to support a means for receiving a second set of one or more downlink control information messages that collectively schedule a second set of instances of a second TB. The communications manager 720 is capable of, configured to, or operable to support a means for receiving, via a set of one or more physical downlink shared channels (PDSCHs) in accordance with the first set of one or more downlink control information messages and the second set of one or more downlink control information messages, the first set of instances of the first TB and the second set of instances of the second TB for a multicast service or for a broadcast service, where at least one instance of the first set of instances of the first TB is time-interleaved with the second set of instances of the second TB. The communications manager 720 is capable of, configured to, or operable to support a means for decoding the first TB based on reception of the first set of instances of the first TB.

Additionally, or alternatively, the communications manager 720 may support wireless communication in accordance with examples as disclosed herein. For example, the communications manager 720 is capable of, configured to, or operable to support a means for receiving control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof. The communications manager 720 is capable of, configured to, or operable to support a means for receiving, via a set of one or more physical downlink shared channels (PDSCHs) according to the one or more parameters, a first set of instances of a first TB of the set of multiple TBs and a second set of instances of a second TB of the set of multiple TBs for a multicast service or for a broadcast service, where the first set of instances of the first TB and the second set of instances of the second TB are time-interleaved. The communications manager 720 is capable of, configured to, or operable to support a means for decoding the first TB based on reception of the first set of instances of the first TB.

Additionally, or alternatively, the communications manager 720 may support wireless communication in accordance with examples as disclosed herein. For example, the communications manager 720 is capable of, configured to, or operable to support a means for receiving control information that schedules one or more respective instances of a set of multiple respective TBs, where the one or more respective instances of the set of multiple respective TBs are time-interleaved according to a time interleaving pattern, a timing gap being between each of the one or more respective instances of the set of multiple respective TBs. The communications manager 720 is capable of, configured to, or operable to support a means for receiving, via a first set of one or more physical downlink shared channels (PDSCHs) and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process. The communications manager 720 is capable of, configured to, or operable to support a means for decode at least the first TB basing on reception of the first set of instances of the first TB.

Additionally, or alternatively, the communications manager 720 may support wireless communication in accordance with examples as disclosed herein. For example, the communications manager 720 is capable of, configured to, or operable to support a means for receiving a first set of one or more downlink control information messages that collectively schedule a first set of instances of a first TB. The communications manager 720 is capable of, configured to, or operable to support a means for receiving a second set of one or more downlink control information messages that collectively schedule a second set of instances of a second TB. The communications manager 720 is capable of, configured to, or operable to support a means for receiving, via a set of one or more physical downlink shared channels (PDSCHs) in accordance with the first set of one or more downlink control information messages and the second set of one or more downlink control information messages, the first set of instances of the first TB and the second set of instances of the second TB for a multicast service or for a broadcast service, where at least one instance of the first set of instances of the first TB is time-interleaved with the second set of instances of the second TB. The communications manager 720 is capable of, configured to, or operable to support a means for decoding the first TB based on reception of the first set of instances of the first TB.

Additionally, or alternatively, the communications manager 720 may support wireless communication in accordance with examples as disclosed herein. For example, the communications manager 720 is capable of, configured to, or operable to support a means for receiving control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof. The communications manager 720 is capable of, configured to, or operable to support a means for receiving, via a set of one or more physical downlink shared channels (PDSCHs) according to the one or more parameters, a first set of instances of a first TB of the set of multiple TBs and a second set of instances of a second TB of the set of multiple TBs for a multicast service or for a broadcast service, where the first set of instances of the first TB and the second set of instances of the second TB are time-interleaved. The communications manager 720 is capable of, configured to, or operable to support a means for decoding the first TB based on reception of the first set of instances of the first TB.

Additionally, or alternatively, the communications manager 720 may support wireless communication in accordance with examples as disclosed herein. For example, the communications manager 720 is capable of, configured to, or operable to support a means for receiving control information that schedules one or more respective instances of a set of multiple respective TBs, where the one or more respective instances of the set of multiple respective TBs are time-interleaved according to a time interleaving pattern, a timing gap being between each of the one or more respective instances of the set of multiple respective TBs. The communications manager 720 is capable of, configured to, or operable to support a means for receiving, via a first set of one or more physical downlink shared channels (PDSCHs) and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process. The communications manager 720 is capable of, configured to, or operable to support a means for decode at least the first TB basing on reception of the first set of instances of the first TB.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for more efficient utilization of communication resources. For example, a network entity (e.g., including a UE) implementing the techniques described herein may experience a higher reliability of wireless communications, which may cause fewer retransmissions of data, making for more efficient utilization of communication resources.

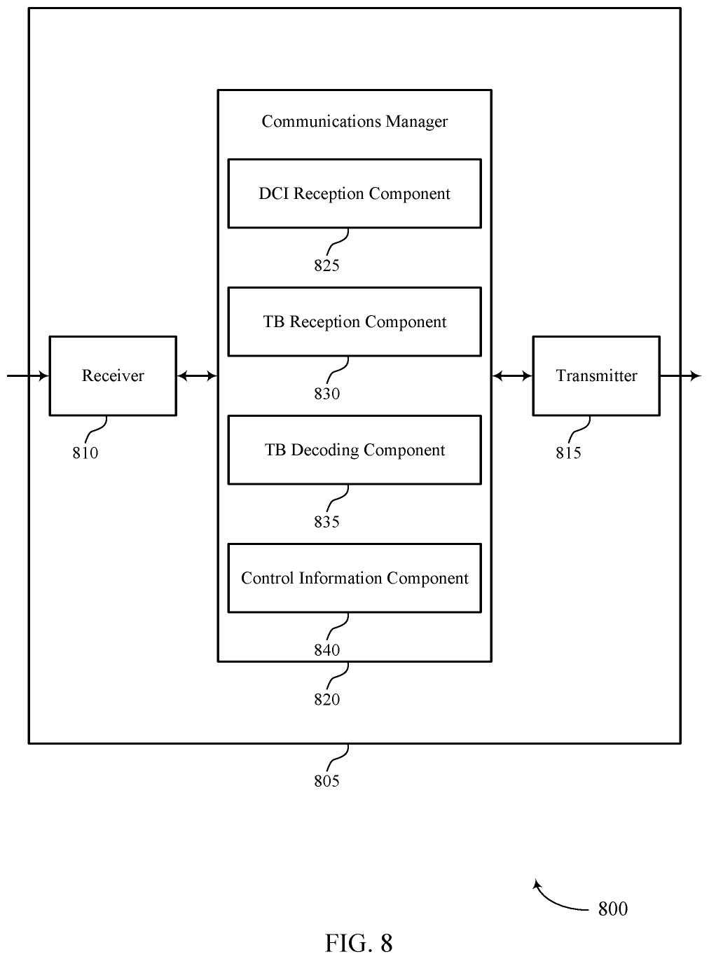

FIG. 8 shows a block diagram 800 of a device 805 that supports inter-TB time interleaving in accordance with one or more aspects of the present disclosure. The device 805 may be an example of aspects of a device 705 or a UE 115 as described herein, which may also be referred to as a network entity. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to inter-TB time interleaving). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to inter-TB time interleaving). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of inter-TB time interleaving as described herein. For example, the communications manager 820 may include a DCI reception component p, a TB reception component 830, a TB decoding component 835, a control information component 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication in accordance with examples as disclosed herein. The DCI reception component 825 is capable of, configured to, or operable to support a means for receiving a first set of one or more downlink control information messages that collectively schedule a first set of instances of a first TB. The DCI reception component 825 is capable of, configured to, or operable to support a means for receiving a second set of one or more downlink control information messages that collectively schedule a second set of instances of a second TB. The TB reception component 830 is capable of, configured to, or operable to support a means for receiving, via a set of one or more physical downlink shared channels (PDSCHs) in accordance with the first set of one or more downlink control information messages and the second set of one or more downlink control information messages, the first set of instances of the first TB and the second set of instances of the second TB for a multicast service or for a broadcast service, where at least one instance of the first set of instances of the first TB is time-interleaved with the second set of instances of the second TB. The TB decoding component 835 is capable of, configured to, or operable to support a means for decoding the first TB based on reception of the first set of instances of the first TB.

Additionally, or alternatively, the communications manager 820 may support wireless communication in accordance with examples as disclosed herein. The control information component 840 is capable of, configured to, or operable to support a means for receiving control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof. The TB reception component 830 is capable of, configured to, or operable to support a means for receiving, via a set of one or more physical downlink shared channels (PDSCHs) according to the one or more parameters, a first set of instances of a first TB of the set of multiple TBs and a second set of instances of a second TB of the set of multiple TBs for a multicast service or for a broadcast service, where the first set of instances of the first TB and the second set of instances of the second TB are time-interleaved. The TB decoding component 835 is capable of, configured to, or operable to support a means for decoding the first TB based on reception of the first set of instances of the first TB.

Additionally, or alternatively, the communications manager 820 may support wireless communication in accordance with examples as disclosed herein. The control information component 840 is capable of, configured to, or operable to support a means for receiving control information that schedules one or more respective instances of a set of multiple respective TBs, where the one or more respective instances of the set of multiple respective TBs are time-interleaved according to a time interleaving pattern, a timing gap being between each of the one or more respective instances of the set of multiple respective TBs. The TB reception component 830 is capable of, configured to, or operable to support a means for receiving, via a first set of one or more physical downlink shared channels (PDSCHs) and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process. The TB decoding component 835 is capable of, configured to, or operable to support a means for decode at least the first TB basing on reception of the first set of instances of the first TB.

Additionally, or alternatively, the communications manager 820 may support wireless communication in accordance with examples as disclosed herein. The DCI reception component 825 is capable of, configured to, or operable to support a means for receiving a first set of one or more downlink control information messages that collectively schedule a first set of instances of a first TB. The DCI reception component 825 is capable of, configured to, or operable to support a means for receiving a second set of one or more downlink control information messages that collectively schedule a second set of instances of a second TB. The TB reception component 830 is capable of, configured to, or operable to support a means for receiving, via a set of one or more physical downlink shared channels (PDSCHs) in accordance with the first set of one or more downlink control information messages and the second set of one or more downlink control information messages, the first set of instances of the first TB and the second set of instances of the second TB for a multicast service or for a broadcast service, where at least one instance of the first set of instances of the first TB is time-interleaved with the second set of instances of the second TB. The TB decoding component 835 is capable of, configured to, or operable to support a means for decoding the first TB based on reception of the first set of instances of the first TB.

Additionally, or alternatively, the communications manager 820 may support wireless communication in accordance with examples as disclosed herein. The control information component 840 is capable of, configured to, or operable to support a means for receiving control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof. The TB reception component 830 is capable of, configured to, or operable to support a means for receiving, via a set of one or more physical downlink shared channels (PDSCHs) according to the one or more parameters, a first set of instances of a first TB of the set of multiple TBs and a second set of instances of a second TB of the set of multiple TBs for a multicast service or for a broadcast service, where the first set of instances of the first TB and the second set of instances of the second TB are time-interleaved. The TB decoding component 835 is capable of, configured to, or operable to support a means for decoding the first TB based on reception of the first set of instances of the first TB.

Additionally, or alternatively, the communications manager 820 may support wireless communication in accordance with examples as disclosed herein. The control information component 840 is capable of, configured to, or operable to support a means for receiving control information that schedules one or more respective instances of a set of multiple respective TBs, where the one or more respective instances of the set of multiple respective TBs are time-interleaved according to a time interleaving pattern, a timing gap being between each of the one or more respective instances of the set of multiple respective TBs. The TB reception component 830 is capable of, configured to, or operable to support a means for receiving, via a first set of one or more physical downlink shared channels (PDSCHs) and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process. The TB decoding component 835 is capable of, configured to, or operable to support a means for decode at least the first TB basing on reception of the first set of instances of the first TB.

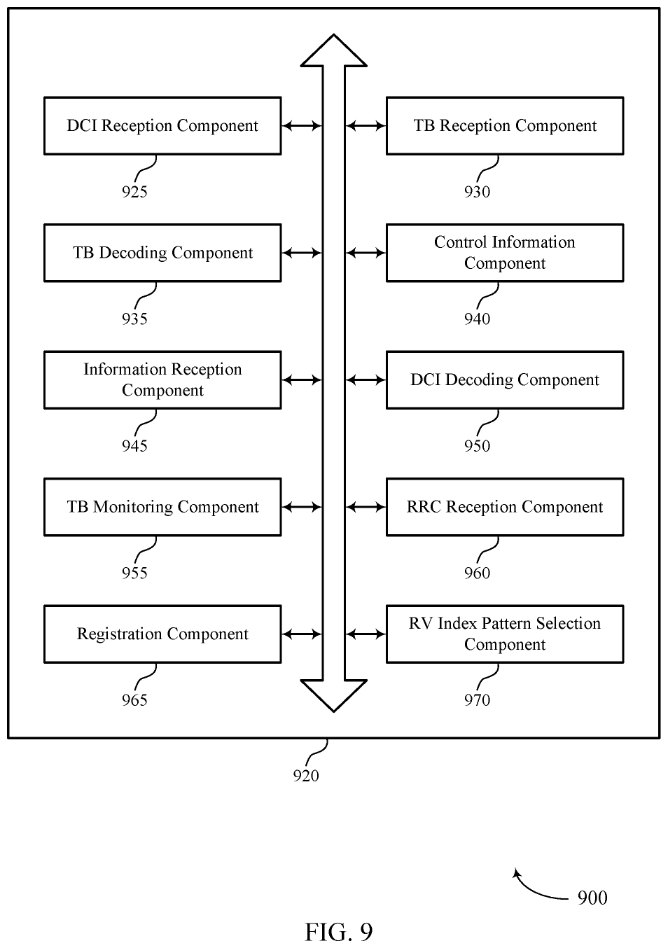

FIG. 9 shows a block diagram 900 of a communications manager 920 that supports inter-TB time interleaving in accordance with one or more aspects of the present disclosure. The communications manager 920 may be an example of aspects of a communications manager 720, a communications manager 820, or both, as described herein. The communications manager 920, or various components thereof, may be an example of means for performing various aspects of inter-TB time interleaving as described herein. For example, the communications manager 920 may include a DCI reception component 925, a TB reception component 930, a TB decoding component 935, a control information component 940, an information reception component 945, a DCI decoding component 950, a TB monitoring component 955, an RRC reception component 960, a registration component 965, an RV index pattern selection component 970, or any combination thereof. Each of these components, or components or subcomponents thereof (e.g., one or more processors, one or more memories), may communicate, directly or indirectly, with one another (e.g., via one or more buses).

The communications manager 920 may support wireless communication in accordance with examples as disclosed herein. The DCI reception component 925 is capable of, configured to, or operable to support a means for receiving a first set of one or more downlink control information messages that collectively schedule a first set of instances of a first TB. In some examples, the DCI reception component 925 is capable of, configured to, or operable to support a means for receiving a second set of one or more downlink control information messages that collectively schedule a second set of instances of a second TB. The TB reception component 930 is capable of, configured to, or operable to support a means for receiving, via a set of one or more physical downlink shared channels (PDSCHs) in accordance with the first set of one or more downlink control information messages and the second set of one or more downlink control information messages, the first set of instances of the first TB and the second set of instances of the second TB for a multicast service or for a broadcast service, where at least one instance of the first set of instances of the first TB is time-interleaved with the second set of instances of the second TB. The TB decoding component 935 is capable of, configured to, or operable to support a means for decoding the first TB based on reception of the first set of instances of the first TB.

In some examples, perform a soft combination of one or more instances of the first set of instances of the first TB based on the first set of one or more downlink control information messages including an indication that each instance of the one or more instances of the first set of instances is of the first TB.

In some examples, decode the first TB based on the network entity being of a first generation of network entity that is different from a second generation of network entity, or the network entity being capable of communicating time interleaved respective instances of respective TBs that are for the multicast service or the broadcast service, or both.

In some examples, the first set of one or more downlink control information messages and the second set of one or more downlink control information messages are configured to be decodable by at least a second network entity that is of a different generation than the network entity. In some examples, the network entity and the second network entity are capable of decoding the first set of one or more downlink control information messages and the second set of one or more downlink control information messages. In some examples, the network entity is capable of communicating time interleaved respective instances of respective TBs that are for the multicast service or the broadcast service, or both.

In some examples, each downlink control information message of the first set of one or more downlink control information messages schedules a respective instance of the first set of instances of the first TB. In some examples, each downlink control information message of the second set of one or more downlink control information messages schedules a respective instance of the second set of instances of the second TB.

In some examples, each downlink control information message of the first set of one or more downlink control information messages includes a respective field indicating that the scheduled respective instance of the first set of instances corresponds to the first TB. In some examples, the processing system is configured to decode the first TB based on the respective field of each downlink control information message of the first set of one or more downlink control information messages.

In some examples, the respective field of each downlink control information message of the first set of one or more downlink control information messages indicates a respective HARQ process identifier (ID) associated with the scheduled respective instance of the first set of instances, a new data indicator (NDI) associated with the HARQ process ID, or both.

In some examples, the NDI associated with the respective HARQ process ID indicates whether the scheduled respective instance is a first temporal transmission corresponding to the first TB.

In some examples, the HARQ process ID indicates whether the scheduled respective instance is a retransmission corresponding to the first TB.

In some examples, at least one downlink control information message of the first set of one or more downlink control information messages has downlink control information format 4.

In some examples, at least one downlink control information message of the first set of one or more downlink control information messages is for the broadcast service and has downlink control information format 4_1. In some examples, at least one downlink control information message of the first set of one or more downlink control information messages is for the broadcast service and has downlink control information format 4_2.

In some examples, receive information that indicates a time window, where decoding the first TB is based on the first set of instances being within the time window.

In some examples, receive first information that indicates a quantity of the first set of instances of the first TB and second information that indicates a time delay between individual instances of the first set of instances of the first TB, where decoding the first TB is based on the quantity and the time delay, and where the first set of one or more downlink control information messages is a single downlink control information message that schedules the first set of instances of the first TB.

In some examples, receive radio resource control information that corresponds to a group radio network temporary identifier associated with the network entity, where the radio resource control information includes the first information and the second information.

In some examples, the single downlink control information message includes a time domain resource allocation index that is indicative of the first information and the second information.

In some examples, receive radio resource control information that includes the first information, where the single downlink control information message includes a time domain resource allocation index that is indicative of the second information.

In some examples, receive radio resource control information that includes the second information, where the single downlink control information message includes a time domain resource allocation index that is indicative of the first information.

In some examples, the single downlink control information message includes a field with more than 2 bits that indicates a redundancy version index associated with one instance of the first set of instances of the first TB.

In some examples, receive information that indicates a redundancy version index pattern for the first set of instances of the first TB. In some examples, decode only a portion of each downlink control information message of the first set of one or more downlink control information messages, where the portion excludes a respective redundancy version field of each respective downlink control information message based on receipt of the information, and where decoding the first TB is based on the redundancy version index pattern.

In some examples, the redundancy version index pattern indicates that a respective redundancy version index associated with a first temporal instance of the first set of instances of the first TB is zero.

In some examples, at least one downlink control information message of the first set of one or more downlink control information messages includes a redundancy version field that indicates a redundancy version index associated with a first temporal instance of the first set of instances of the first TB. In some examples, the indicated redundancy version index corresponds to a redundancy version index pattern of a set of multiple redundancy version index patterns. In some examples, the redundancy version index pattern begins with the indicated redundancy version index.

Additionally, or alternatively, the communications manager 920 may support wireless communication in accordance with examples as disclosed herein. The control information component 940 is capable of, configured to, or operable to support a means for receiving control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof. In some examples, the TB reception component 930 is capable of, configured to, or operable to support a means for receiving, via a set of one or more physical downlink shared channels (PDSCHs) according to the one or more parameters, a first set of instances of a first TB of the set of multiple TBs and a second set of instances of a second TB of the set of multiple TBs for a multicast service or for a broadcast service, where the first set of instances of the first TB and the second set of instances of the second TB are time-interleaved. In some examples, the TB decoding component 935 is capable of, configured to, or operable to support a means for decoding the first TB based on reception of the first set of instances of the first TB.

In some examples, receiving the control information and decoding the first TB are based on the network entity being of a first generation of network entity that is different from a second generation of network entity, or the network entity being capable of communicating time interleaved respective instances of respective TBs that are for the multicast service or the broadcast service, or both.

In some examples, receiving the control information may include receiving one or more radio resource control messages.

In some examples, the one or more radio resource control messages semi-statically configure the one or more parameters.

In some examples, receiving the control information may include receiving one or more downlink control information messages.

In some examples, at least one downlink control information message of the one or more downlink control information messages schedules resources for receiving one or more of the set of multiple TBs and activates the one or more parameters.

In some examples, the one or more downlink control information messages are in a format supported by the network entity for scheduling time-interleaved TBs for the multicast service or the broadcast service.

In some examples, the one or more downlink control information messages are associated with one or more of a group radio network temporary identifier, a control resource set, a SS set, or any combination thereof. In some examples, the association is indicative that the one or more downlink control information messages pertain to communications of the multicast service or the broadcast service.

In some examples, the one or more downlink control information messages include a time domain resource allocation index corresponding to a time domain resource allocation table that includes entries for the one or more parameters.

In some examples, the one or more downlink control information messages include dedicated fields for the one or more parameters.

In some examples, receive second control information that indicates a pattern of HARQ process identifiers (IDs) corresponding to instances of the set of multiple TBs, where each respective instance of the first set of instances of the first TB corresponds to a respective HARQ process ID of the pattern of HARQ process IDs and each respective instance of the second set of instances of the second TB corresponds to a respective HARQ process ID of the pattern of HARQ process IDs, and where the first set of instances of the first TB and the second set of instances of the second TB are time-interleaved based on the pattern of HARQ process IDs.

In some examples, decode the first TB based on the TB scaling factor, where a size of the first TB is based on the TB scaling factor and the respective quantity of instances of the first set of instances of the first TB.

In some examples, decode the first TB based on a low-density parity-check (LDPC) base graph defined by a coding rate and a payload size of the first TB, and where the payload size of the first TB is based on the TB scaling factor applied to an unscaled TB size.

In some examples, decode the first TB based on a limited buffer rate matching (LBRM) size that is defined by the TB scaling factor.

In some examples, a threshold data rate per time duration of a set of multiple time durations that correspond to the first set of instances of the first TB is based on the TB scaling factor.

In some examples, the threshold data rate per time duration for a component carrier for the multicast service or the broadcast service is less than or equal to a second threshold data rate for unicast signaling.

In some examples, receive second control information that indicates one or more redundancy version index patterns, where a redundancy version index of a first redundancy version index pattern corresponds to each respective instance of the first set of instances, and where an order of the first set of instances of the first TB is based on the first redundancy version index pattern.

In some examples, select the first redundancy version index pattern from the one or more redundancy version index patterns based on the quantity of the first set of instances of the first TB satisfying a threshold quantity, where the first set of instances of the first TB and the second set of instances of the second TB are time-interleaved based on the first redundancy version index pattern.

Additionally, or alternatively, the communications manager 920 may support wireless communication in accordance with examples as disclosed herein. In some examples, the control information component 940 is capable of, configured to, or operable to support a means for receiving control information that schedules one or more respective instances of a set of multiple respective TBs, where the one or more respective instances of the set of multiple respective TBs are time-interleaved according to a time interleaving pattern, a timing gap being between each of the one or more respective instances of the set of multiple respective TBs. In some examples, the TB reception component 930 is capable of, configured to, or operable to support a means for receiving, via a first set of one or more physical downlink shared channels (PDSCHs) and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process. In some examples, the TB decoding component 935 is capable of, configured to, or operable to support a means for decode at least the first TB basing on reception of the first set of instances of the first TB.

In some examples, the control information is configured to be decodable by at least a second network entity that is of a different generation than the network entity. In some examples, the network entity and the second network entity are capable of decoding the control information. In some examples, the network entity is capable of communicating time interleaved respective instances of respective TBs that are for the multicast service or the broadcast service, or both.

In some examples, monitor for the first set of instances of the first TB and the second set of instances of the second TB via a bandwidth that satisfies a threshold bandwidth for multicast or broadcast via at least one PDSCH.

In some examples, transmit registration information that indicates a capability of the network entity to receive the one or more respective instances of the set of multiple respective TBs via the threshold bandwidth, where, to monitor for the first set of instances of the first TB, the processing system is configured to monitor for the first set of instances of the first TB based on transmission of the registration information.

In some examples, the threshold bandwidth is a reduced bandwidth. In some examples, the reduced bandwidth includes less frequency resources than a second bandwidth for receiving a fourth set of instances of a fourth TB. In some examples, the fourth set of instances is a single instance, is not time-interleaved with instances of a fifth TB, or is associated with a single PDSCH, or any combination thereof.

In some examples, the threshold bandwidth is a 5 megahertz bandwidth.

In some examples, the control information includes one or more downlink control information messages that schedule the first set of instances of the first TB, the one or more downlink control information messages including an identifier that is indicative that the first set of instances correspond to the first TB. In some examples, reception of the first set of instances of the first TB of the set of multiple respective TBs for the multicast service or the broadcast service in accordance with the timing gap is based on the identifier that is indicative that the first set of instances correspond to the first TB.

In some examples, perform a soft combination on one or more instances of the first set of instances of the first TB based on the control information including an indication that each instance of the one or more instances of the first set of instances is of the first TB.

Additionally, or alternatively, the communications manager 920 may support wireless communication in accordance with examples as disclosed herein. In some examples, the DCI reception component 925 is capable of, configured to, or operable to support a means for receiving a first set of one or more downlink control information messages that collectively schedule a first set of instances of a first TB. In some examples, the DCI reception component 925 is capable of, configured to, or operable to support a means for receiving a second set of one or more downlink control information messages that collectively schedule a second set of instances of a second TB. In some examples, the TB reception component 930 is capable of, configured to, or operable to support a means for receiving, via a set of one or more physical downlink shared channels (PDSCHs) in accordance with the first set of one or more downlink control information messages and the second set of one or more downlink control information messages, the first set of instances of the first TB and the second set of instances of the second TB for a multicast service or for a broadcast service, where at least one instance of the first set of instances of the first TB is time-interleaved with the second set of instances of the second TB. In some examples, the TB decoding component 935 is capable of, configured to, or operable to support a means for decoding the first TB based on reception of the first set of instances of the first TB.

In some examples, to support decoding the first TB, the TB decoding component 935 is capable of, configured to, or operable to support a means for performing a soft combination of one or more instances of the first set of instances of the first TB based on the first set of one or more downlink control information messages including an indication that each instance of the one or more instances of the first set of instances is of the first TB.

In some examples, to support decoding the first TB, the TB decoding component 935 is capable of, configured to, or operable to support a means for decoding the first TB based on the network entity being of a first generation of network entity that is different from a second generation of network entity, or the network entity being capable of communicating time interleaved respective instances of respective TBs that are for the multicast service or the broadcast service, or both.

In some examples, the first set of one or more downlink control information messages and the second set of one or more downlink control information messages are configured to be decodable by at least a second network entity that is of a different generation than the network entity. In some examples, the network entity and the second network entity are capable of decoding the first set of one or more downlink control information messages and the second set of one or more downlink control information messages. In some examples, the network entity is capable of communicating time interleaved respective instances of respective TBs that are for the multicast service or the broadcast service, or both.

In some examples, each downlink control information message of the first set of one or more downlink control information messages schedules a respective instance of the first set of instances of the first TB. In some examples, each downlink control information message of the second set of one or more downlink control information messages schedules a respective instance of the second set of instances of the second TB.

In some examples, each downlink control information message of the first set of one or more downlink control information messages includes a respective field indicating that the scheduled respective instance of the first set of instances corresponds to the first TB. In some examples, decoding the first TB is based on the respective field of each downlink control information message of the first set of one or more downlink control information messages.

In some examples, the respective field of each downlink control information message of the first set of one or more downlink control information messages indicates a respective HARQ process identifier (ID) associated with the scheduled respective instance of the first set of instances, a new data indicator (NDI) associated with the HARQ process ID, or both.

In some examples, the NDI associated with the respective HARQ process ID indicates whether the scheduled respective instance is a first temporal transmission corresponding to the first TB.

In some examples, the HARQ process ID indicates whether the scheduled respective instance is a retransmission corresponding to the first TB.

In some examples, at least one downlink control information message of the first set of one or more downlink control information messages has downlink control information format 4_.

In some examples, at least one downlink control information message of the first set of one or more downlink control information messages is for the broadcast service and has downlink control information format 4_1. In some examples, at least one downlink control information message of the first set of one or more downlink control information messages is for the broadcast service and has downlink control information format 4_2.

In some examples, the information reception component 945 is capable of, configured to, or operable to support a means for receiving information that indicates a time window, where decoding the first TB is based on the first set of instances being within the time window.

In some examples, the information reception component 945 is capable of, configured to, or operable to support a means for receiving first information that indicates a quantity of the first set of instances of the first TB and second information that indicates a time delay between individual instances of the first set of instances of the first TB, where decoding the first TB is based on the quantity and the time delay, and where the first set of one or more downlink control information messages is a single downlink control information message that schedules the first set of instances of the first TB.

In some examples, the RRC reception component 960 is capable of, configured to, or operable to support a means for receiving radio resource control information that corresponds to a group radio network temporary identifier associated with the network entity, where the radio resource control information includes the first information and the second information.

In some examples, the single downlink control information message includes a time domain resource allocation index that is indicative of the first information and the second information.

In some examples, the RRC reception component 960 is capable of, configured to, or operable to support a means for receiving radio resource control information that includes the first information, where the single downlink control information message includes a time domain resource allocation index that is indicative of the second information.

In some examples, the RRC reception component 960 is capable of, configured to, or operable to support a means for receiving radio resource control information that includes the second information, where the single downlink control information message includes a time domain resource allocation index that is indicative of the first information.

In some examples, the single downlink control information message includes a field with more than 2 bits that indicates a redundancy version index associated with one instance of the first set of instances of the first TB.

In some examples, the information reception component 945 is capable of, configured to, or operable to support a means for receiving information that indicates a redundancy version index pattern for the first set of instances of the first TB. In some examples, the DCI decoding component 950 is capable of, configured to, or operable to support a means for decoding only a portion of each downlink control information message of the first set of one or more downlink control information messages, where the portion excludes a respective redundancy version field of each respective downlink control information message based on receipt of the information, and where decoding the first TB is based on the redundancy version index pattern.

In some examples, the redundancy version index pattern indicates that a respective redundancy version index associated with a first temporal instance of the first set of instances of the first TB is zero.

In some examples, at least one downlink control information message of the first set of one or more downlink control information messages includes a redundancy version field that indicates a redundancy version index associated with a first temporal instance of the first set of instances of the first TB. In some examples, the indicated redundancy version index corresponds to a redundancy version index pattern of a set of multiple redundancy version index patterns. In some examples, the redundancy version index pattern begins with the indicated redundancy version index.

Additionally, or alternatively, the communications manager 920 may support wireless communication in accordance with examples as disclosed herein. In some examples, the control information component 940 is capable of, configured to, or operable to support a means for receiving control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof. In some examples, the TB reception component 930 is capable of, configured to, or operable to support a means for receiving, via a set of one or more physical downlink shared channels (PDSCHs) according to the one or more parameters, a first set of instances of a first TB of the set of multiple TBs and a second set of instances of a second TB of the set of multiple TBs for a multicast service or for a broadcast service, where the first set of instances of the first TB and the second set of instances of the second TB are time-interleaved. In some examples, the TB decoding component 935 is capable of, configured to, or operable to support a means for decoding the first TB based on reception of the first set of instances of the first TB.

In some examples, receiving the control information and decoding the first TB are based on the network entity being of a first generation of network entity that is different from a second generation of network entity, or the network entity being capable of communicating time interleaved respective instances of respective TBs that are for the multicast service or the broadcast service, or both.

In some examples, to support receiving the control information, the control information component 940 is capable of, configured to, or operable to support a means for receiving one or more radio resource control messages.

In some examples, the one or more radio resource control messages semi-statically configure the one or more parameters.

In some examples, to support receiving the control information, the control information component 940 is capable of, configured to, or operable to support a means for receiving one or more downlink control information messages.

In some examples, at least one downlink control information message of the one or more downlink control information messages schedules resources for receiving one or more of the set of multiple TBs and activates the one or more parameters.

In some examples, the one or more downlink control information messages are in a format supported by the network entity for scheduling time-interleaved TBs for the multicast service or the broadcast service.

In some examples, the one or more downlink control information messages are associated with one or more of a group radio network temporary identifier, a control resource set, a SS set, or any combination thereof. In some examples, the association is indicative that the one or more downlink control information messages pertain to communications of the multicast service or the broadcast service.

In some examples, the one or more downlink control information messages include a time domain resource allocation index corresponding to a time domain resource allocation table that includes entries for the one or more parameters.

In some examples, the one or more downlink control information messages include dedicated fields for the one or more parameters.

In some examples, the control information component 940 is capable of, configured to, or operable to support a means for receiving second control information that indicates a pattern of HARQ process identifiers (IDs) corresponding to instances of the set of multiple TBs, where each respective instance of the first set of instances of the first TB corresponds to a respective HARQ process ID of the pattern of HARQ process IDs and each respective instance of the second set of instances of the second TB corresponds to a respective HARQ process ID of the pattern of HARQ process IDs, and where the first set of instances of the first TB and the second set of instances of the second TB are time-interleaved based on the pattern of HARQ process IDs.

In some examples, to support decoding the first TB, the TB decoding component 935 is capable of, configured to, or operable to support a means for decoding the first TB based on the TB scaling factor, where a size of the first TB is based on the TB scaling factor and the respective quantity of instances of the first set of instances of the first TB.

In some examples, to support decoding the first TB, the TB decoding component 935 is capable of, configured to, or operable to support a means for decode the first TB based on a low-density parity-check (LDPC) base graph defined by a coding rate and a payload size of the first TB, and where the payload size of the first TB is based on the TB scaling factor applied to an unscaled TB size.

In some examples, to support decoding the first TB, the TB decoding component 935 is capable of, configured to, or operable to support a means for decode the first TB based on a limited buffer rate matching (LBRM) size that is defined by the TB scaling factor.

In some examples, a threshold data rate per time duration of a set of multiple time durations that correspond to the first set of instances of the first TB is based on the TB scaling factor.

In some examples, the threshold data rate per time duration for a component carrier for the multicast service or the broadcast service is less than or equal to a second threshold data rate for unicast signaling.

In some examples, the control information component 940 is capable of, configured to, or operable to support a means for receiving second control information that indicates one or more redundancy version index patterns, where a redundancy version index of a first redundancy version index pattern corresponds to each respective instance of the first set of instances, and where an order of the first set of instances of the first TB is based on the first redundancy version index pattern.

In some examples, the RV index pattern selection component 970 is capable of, configured to, or operable to support a means for selecting the first redundancy version index pattern from the one or more redundancy version index patterns based on the quantity of the first set of instances of the first TB satisfying a threshold quantity, where the first set of instances of the first TB and the second set of instances of the second TB are time-interleaved based on the first redundancy version index pattern.

Additionally, or alternatively, the communications manager 920 may support wireless communication in accordance with examples as disclosed herein. In some examples, the control information component 940 is capable of, configured to, or operable to support a means for receiving control information that schedules one or more respective instances of a set of multiple respective TBs, where the one or more respective instances of the set of multiple respective TBs are time-interleaved according to a time interleaving pattern, a timing gap being between each of the one or more respective instances of the set of multiple respective TBs. In some examples, the TB reception component 930 is capable of, configured to, or operable to support a means for receiving, via a first set of one or more physical downlink shared channels (PDSCHs) and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process. In some examples, the TB decoding component 935 is capable of, configured to, or operable to support a means for decode at least the first TB basing on reception of the first set of instances of the first TB.

In some examples, the control information is configured to be decodable by at least a second network entity that is of a different generation than the network entity. In some examples, the network entity and the second network entity are capable of decoding the control information. In some examples, the network entity is capable of communicating time interleaved respective instances of respective TBs that are for the multicast service or the broadcast service, or both.

In some examples, the TB monitoring component 955 is capable of, configured to, or operable to support a means for monitoring for the first set of instances of the first TB and the second set of instances of the second TB via a bandwidth that satisfies a threshold bandwidth for multicast or broadcast via at least one PDSCH.

In some examples, the registration component 965 is capable of, configured to, or operable to support a means for transmitting registration information that indicates a capability of the network entity to receive the one or more respective instances of the set of multiple respective TBs via the threshold bandwidth, where, to monitor for the first set of instances of the first TB, the processing system is configured to monitor for the first set of instances of the first TB based on transmission of the registration information. In some examples, the TB monitoring component 955 is capable of, configured to, or operable to support a means for monitoring for the first set of instances of the first TB based on transmission of the registration information.

In some examples, the threshold bandwidth is a reduced bandwidth. In some examples, the reduced bandwidth includes less frequency resources than a second bandwidth for receiving a fourth set of instances of a fourth TB. In some examples, the fourth set of instances is a single instance, is not time-interleaved with instances of a fifth TB, or is associated with a single PDSCH, or any combination thereof.

In some examples, the threshold bandwidth is a 5 megahertz bandwidth.

In some examples, the control information includes one or more downlink control information messages that schedule the first set of instances of the first TB, the one or more downlink control information messages including an identifier that is indicative that the first set of instances correspond to the first TB. In some examples, reception of the first set of instances of the first TB of the set of multiple respective TBs for the multicast service or the broadcast service in accordance with the timing gap is based on the identifier that is indicative that the first set of instances correspond to the first TB.

In some examples, to support decoding the first TB, the TB decoding component 935 is capable of, configured to, or operable to support a means for performing a soft combination on one or more instances of the first set of instances of the first TB based on the control information including an indication that each instance of the one or more instances of the first set of instances is of the first TB.

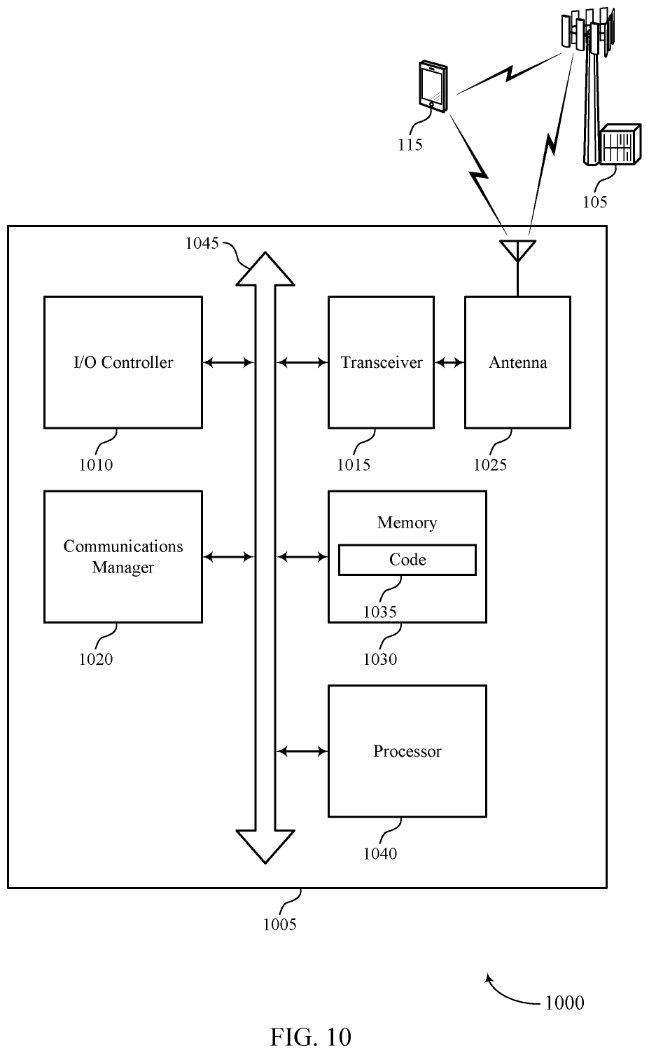

FIG. 10 shows a diagram of a system 1000 including a device 1005 that supports inter-TB time interleaving in accordance with one or more aspects of the present disclosure. The device 1005 may be an example of or include the components of a device 705, a device 805, or a UE 115 as described herein, which may also be referred to as a network entity. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable code 1035 including instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may contain, among other things, a basic I/O system (BIOS) which may control basic hardware or software operation such as the interaction with peripheral components or devices.

The at least one processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting inter-TB time interleaving). For example, the device 1005 or a component of the device 1005 may include at least one processor 1040 and at least one memory 1030 coupled with or to the at least one processor 1040, the at least one processor 1040 and at least one memory 1030 configured to perform various functions described herein. In some examples, the at least one processor 1040 may include multiple processors and the at least one memory 1030 may include multiple memories. One or more of the multiple processors may be coupled with one or more of the multiple memories, which may, individually or collectively, be configured to perform various functions herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. As such, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code stored in the at least one memory 1030 or otherwise, to perform one or more of the functions described herein.

The communications manager 1020 may support wireless communication in accordance with examples as disclosed herein. For example, the communications manager 1020 is capable of, configured to, or operable to support a means for receiving a first set of one or more downlink control information messages that collectively schedule a first set of instances of a first TB. The communications manager 1020 is capable of, configured to, or operable to support a means for receiving a second set of one or more downlink control information messages that collectively schedule a second set of instances of a second TB. The communications manager 1020 is capable of, configured to, or operable to support a means for receiving, via a set of one or more physical downlink shared channels (PDSCHs) in accordance with the first set of one or more downlink control information messages and the second set of one or more downlink control information messages, the first set of instances of the first TB and the second set of instances of the second TB for a multicast service or for a broadcast service, where at least one instance of the first set of instances of the first TB is time-interleaved with the second set of instances of the second TB. The communications manager 1020 is capable of, configured to, or operable to support a means for decoding the first TB based on reception of the first set of instances of the first TB.

Additionally, or alternatively, the communications manager 1020 may support wireless communication in accordance with examples as disclosed herein. For example, the communications manager 1020 is capable of, configured to, or operable to support a means for receiving control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof. The communications manager 1020 is capable of, configured to, or operable to support a means for receiving, via a set of one or more physical downlink shared channels (PDSCHs) according to the one or more parameters, a first set of instances of a first TB of the set of multiple TBs and a second set of instances of a second TB of the set of multiple TBs for a multicast service or for a broadcast service, where the first set of instances of the first TB and the second set of instances of the second TB are time-interleaved. The communications manager 1020 is capable of, configured to, or operable to support a means for decoding the first TB based on reception of the first set of instances of the first TB.

Additionally, or alternatively, the communications manager 1020 may support wireless communication in accordance with examples as disclosed herein. For example, the communications manager 1020 is capable of, configured to, or operable to support a means for receiving control information that schedules one or more respective instances of a set of multiple respective TBs, where the one or more respective instances of the set of multiple respective TBs are time-interleaved according to a time interleaving pattern, a timing gap being between each of the one or more respective instances of the set of multiple respective TBs. The communications manager 1020 is capable of, configured to, or operable to support a means for receiving, via a first set of one or more physical downlink shared channels (PDSCHs) and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process. The communications manager 1020 is capable of, configured to, or operable to support a means for decode at least the first TB basing on reception of the first set of instances of the first TB.

Additionally, or alternatively, the communications manager 1020 may support wireless communication in accordance with examples as disclosed herein. For example, the communications manager 1020 is capable of, configured to, or operable to support a means for receiving a first set of one or more downlink control information messages that collectively schedule a first set of instances of a first TB. The communications manager 1020 is capable of, configured to, or operable to support a means for receiving a second set of one or more downlink control information messages that collectively schedule a second set of instances of a second TB. The communications manager 1020 is capable of, configured to, or operable to support a means for receiving, via a set of one or more physical downlink shared channels (PDSCHs) in accordance with the first set of one or more downlink control information messages and the second set of one or more downlink control information messages, the first set of instances of the first TB and the second set of instances of the second TB for a multicast service or for a broadcast service, where at least one instance of the first set of instances of the first TB is time-interleaved with the second set of instances of the second TB. The communications manager 1020 is capable of, configured to, or operable to support a means for decoding the first TB based on reception of the first set of instances of the first TB.

Additionally, or alternatively, the communications manager 1020 may support wireless communication in accordance with examples as disclosed herein. For example, the communications manager 1020 is capable of, configured to, or operable to support a means for receiving control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof. The communications manager 1020 is capable of, configured to, or operable to support a means for receiving, via a set of one or more physical downlink shared channels (PDSCHs) according to the one or more parameters, a first set of instances of a first TB of the set of multiple TBs and a second set of instances of a second TB of the set of multiple TBs for a multicast service or for a broadcast service, where the first set of instances of the first TB and the second set of instances of the second TB are time-interleaved. The communications manager 1020 is capable of, configured to, or operable to support a means for decoding the first TB based on reception of the first set of instances of the first TB.

Additionally, or alternatively, the communications manager 1020 may support wireless communication in accordance with examples as disclosed herein. For example, the communications manager 1020 is capable of, configured to, or operable to support a means for receiving control information that schedules one or more respective instances of a set of multiple respective TBs, where the one or more respective instances of the set of multiple respective TBs are time-interleaved according to a time interleaving pattern, a timing gap being between each of the one or more respective instances of the set of multiple respective TBs. The communications manager 1020 is capable of, configured to, or operable to support a means for receiving, via a first set of one or more physical downlink shared channels (PDSCHs) and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process. The communications manager 1020 is capable of, configured to, or operable to support a means for decode at least the first TB basing on reception of the first set of instances of the first TB.

By including or configuring the communications manager 1020 in accordance with examples as described herein, the device 1005 may support techniques for improved communication reliability. For example, network entities (e.g., including UEs) implementing the techniques described herein may be capable of soft combining multiple instances of a TB for MBS communications, which may allow for increased decoding reliability in the MBS communications.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of inter-TB time interleaving as described herein, or the at least one processor 1040 and the at least one memory 1030 may be otherwise configured to, individually or collectively, perform or support such operations.

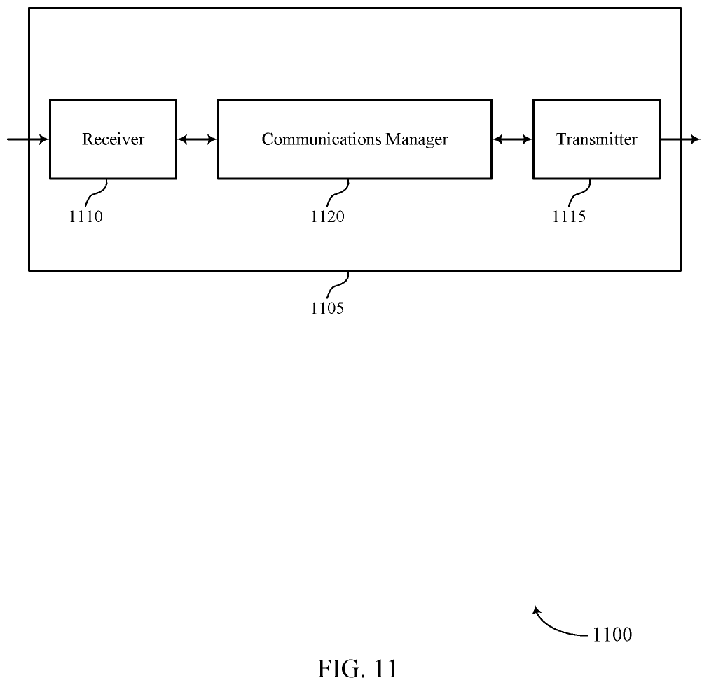

FIG. 11 shows a block diagram 1100 of a device 1105 that supports inter-TB time interleaving in accordance with one or more aspects of the present disclosure. The device 1105 may be an example of aspects of a network entity 105 as described herein, wherein a network entity 105 may include a UE 115 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of inter-TB time interleaving as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor. If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication in accordance with examples as disclosed herein. For example, the communications manager 1120 is capable of, configured to, or operable to support a means for transmitting a first set of one or more downlink control information messages that collectively schedule a first set of instances of a first TB. The communications manager 1120 is capable of, configured to, or operable to support a means for transmitting a second set of one or more downlink control information messages that collectively schedule a second set of instances of a second TB. The communications manager 1120 is capable of, configured to, or operable to support a means for transmitting, via a set of one or more physical downlink shared channels (PDSCHs) in accordance with the first set of one or more downlink control information messages and the second set of one or more downlink control information messages, the first set of instances of the first TB and the second set of instances of the second TB for a multicast service or a broadcast service, where at least one instance of the first set of instances of the first TB is interleaved with the second set of instances of the second TB.

Additionally, or alternatively, the communications manager 1120 may support wireless communication in accordance with examples as disclosed herein. For example, the communications manager 1120 is capable of, configured to, or operable to support a means for transmitting control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof. The communications manager 1120 is capable of, configured to, or operable to support a means for transmitting, via a set of one or more physical downlink shared channels (PDSCHs) according to the one or more parameters, a first set of instances of a first TB and a second set of instances of a second TB for a multicast service or a broadcast service, where the first set of instances of the first TB and the second set of instances of the second TB are time-interleaved.

Additionally, or alternatively, the communications manager 1120 may support wireless communication in accordance with examples as disclosed herein. For example, the communications manager 1120 is capable of, configured to, or operable to support a means for transmitting control information that schedules one or more respective instances of a set of multiple respective TBs, where the one or more respective instances of the set of multiple respective TBs are time-interleaved according to a time interleaving pattern, a timing gap being between each of the one or more respective instances of the set of multiple respective TBs. The communications manager 1120 is capable of, configured to, or operable to support a means for transmitting, via a first set of one or more physical downlink shared channels (PDSCHs) and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process.

Additionally, or alternatively, the communications manager 1120 may support wireless communication in accordance with examples as disclosed herein. For example, the communications manager 1120 is capable of, configured to, or operable to support a means for transmitting a first set of one or more downlink control information messages that collectively schedule a first set of instances of a first TB. The communications manager 1120 is capable of, configured to, or operable to support a means for transmitting a second set of one or more downlink control information messages that collectively schedule a second set of instances of a second TB. The communications manager 1120 is capable of, configured to, or operable to support a means for transmitting, via a set of one or more physical downlink shared channels (PDSCHs) in accordance with the first set of one or more downlink control information messages and the second set of one or more downlink control information messages, the first set of instances of the first TB and the second set of instances of the second TB for a multicast service or a broadcast service, where at least one instance of the first set of instances of the first TB is interleaved with the second set of instances of the second TB.

Additionally, or alternatively, the communications manager 1120 may support wireless communication in accordance with examples as disclosed herein. For example, the communications manager 1120 is capable of, configured to, or operable to support a means for transmitting control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof. The communications manager 1120 is capable of, configured to, or operable to support a means for transmitting, via a set of one or more physical downlink shared channels (PDSCHs) according to the one or more parameters, a first set of instances of a first TB and a second set of instances of a second TB for a multicast service or a broadcast service, where the first set of instances of the first TB and the second set of instances of the second TB are time-interleaved.

Additionally, or alternatively, the communications manager 1120 may support wireless communication in accordance with examples as disclosed herein. For example, the communications manager 1120 is capable of, configured to, or operable to support a means for transmitting control information that schedules one or more respective instances of a set of multiple respective TBs, where the one or more respective instances of the set of multiple respective TBs are time-interleaved according to a time interleaving pattern, a timing gap being between each of the one or more respective instances of the set of multiple respective TBs. The communications manager 1120 is capable of, configured to, or operable to support a means for transmitting, via a first set of one or more physical downlink shared channels (PDSCHs) and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for more efficient utilization of communication resources. For example, a network entity (e.g., including a UE) implementing the techniques described herein may experience a higher reliability of wireless communications, which may cause fewer retransmissions of data, making for more efficient utilization of communication resources.

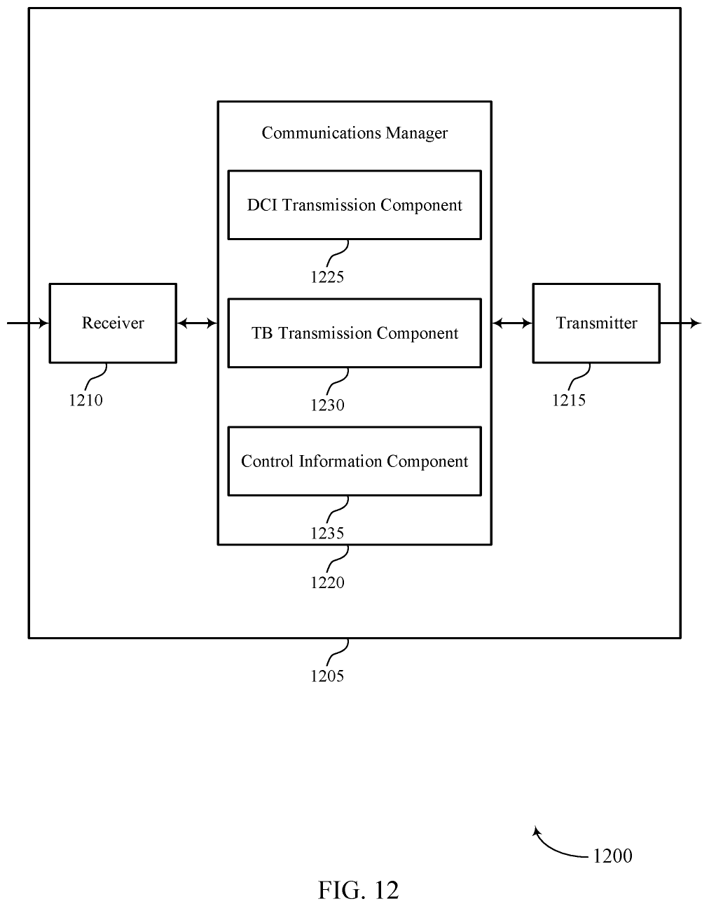

FIG. 12 shows a block diagram 1200 of a device 1205 that supports inter-TB time interleaving in accordance with one or more aspects of the present disclosure. The device 1205 may be an example of aspects of a device 1105 or a network entity 105 as described herein, wherein a network entity 105 may include a UE 115 as described herein. The device 1205 may include a receiver 1210, a transmitter 1215, and a communications manager 1220. The device 1205, or one or more components of the device 1205 (e.g., the receiver 1210, the transmitter 1215, and the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of inter-TB time interleaving as described herein. For example, the communications manager 1220 may include a DCI transmission component 1225, a TB transmission component 1230, a control information component 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication in accordance with examples as disclosed herein. The DCI transmission component 1225 is capable of, configured to, or operable to support a means for transmitting a first set of one or more downlink control information messages that collectively schedule a first set of instances of a first TB. The DCI transmission component 1225 is capable of, configured to, or operable to support a means for transmitting a second set of one or more downlink control information messages that collectively schedule a second set of instances of a second TB. The TB transmission component 1230 is capable of, configured to, or operable to support a means for transmitting, via a set of one or more physical downlink shared channels (PDSCHs) in accordance with the first set of one or more downlink control information messages and the second set of one or more downlink control information messages, the first set of instances of the first TB and the second set of instances of the second TB for a multicast service or a broadcast service, where at least one instance of the first set of instances of the first TB is interleaved with the second set of instances of the second TB.

Additionally, or alternatively, the communications manager 1220 may support wireless communication in accordance with examples as disclosed herein. The control information component 1235 is capable of, configured to, or operable to support a means for transmitting control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof. The TB transmission component 1230 is capable of, configured to, or operable to support a means for transmitting, via a set of one or more physical downlink shared channels (PDSCHs) according to the one or more parameters, a first set of instances of a first TB and a second set of instances of a second TB for a multicast service or a broadcast service, where the first set of instances of the first TB and the second set of instances of the second TB are time-interleaved.

Additionally, or alternatively, the communications manager 1220 may support wireless communication in accordance with examples as disclosed herein. The control information component 1235 is capable of, configured to, or operable to support a means for transmitting control information that schedules one or more respective instances of a set of multiple respective TBs, where the one or more respective instances of the set of multiple respective TBs are time-interleaved according to a time interleaving pattern, a timing gap being between each of the one or more respective instances of the set of multiple respective TBs. The TB transmission component 1230 is capable of, configured to, or operable to support a means for transmitting, via a first set of one or more physical downlink shared channels (PDSCHs) and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process.

Additionally, or alternatively, the communications manager 1220 may support wireless communication in accordance with examples as disclosed herein. The DCI transmission component 1225 is capable of, configured to, or operable to support a means for transmitting a first set of one or more downlink control information messages that collectively schedule a first set of instances of a first TB. The DCI transmission component 1225 is capable of, configured to, or operable to support a means for transmitting a second set of one or more downlink control information messages that collectively schedule a second set of instances of a second TB. The TB transmission component 1230 is capable of, configured to, or operable to support a means for transmitting, via a set of one or more physical downlink shared channels (PDSCHs) in accordance with the first set of one or more downlink control information messages and the second set of one or more downlink control information messages, the first set of instances of the first TB and the second set of instances of the second TB for a multicast service or a broadcast service, where at least one instance of the first set of instances of the first TB is interleaved with the second set of instances of the second TB.

Additionally, or alternatively, the communications manager 1220 may support wireless communication in accordance with examples as disclosed herein. The control information component 1235 is capable of, configured to, or operable to support a means for transmitting control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof. The TB transmission component 1230 is capable of, configured to, or operable to support a means for transmitting, via a set of one or more physical downlink shared channels (PDSCHs) according to the one or more parameters, a first set of instances of a first TB and a second set of instances of a second TB for a multicast service or a broadcast service, where the first set of instances of the first TB and the second set of instances of the second TB are time-interleaved.

Additionally, or alternatively, the communications manager 1220 may support wireless communication in accordance with examples as disclosed herein. The control information component 1235 is capable of, configured to, or operable to support a means for transmitting control information that schedules one or more respective instances of a set of multiple respective TBs, where the one or more respective instances of the set of multiple respective TBs are time-interleaved according to a time interleaving pattern, a timing gap being between each of the one or more respective instances of the set of multiple respective TBs. The TB transmission component 1230 is capable of, configured to, or operable to support a means for transmitting, via a first set of one or more physical downlink shared channels (PDSCHs) and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process.

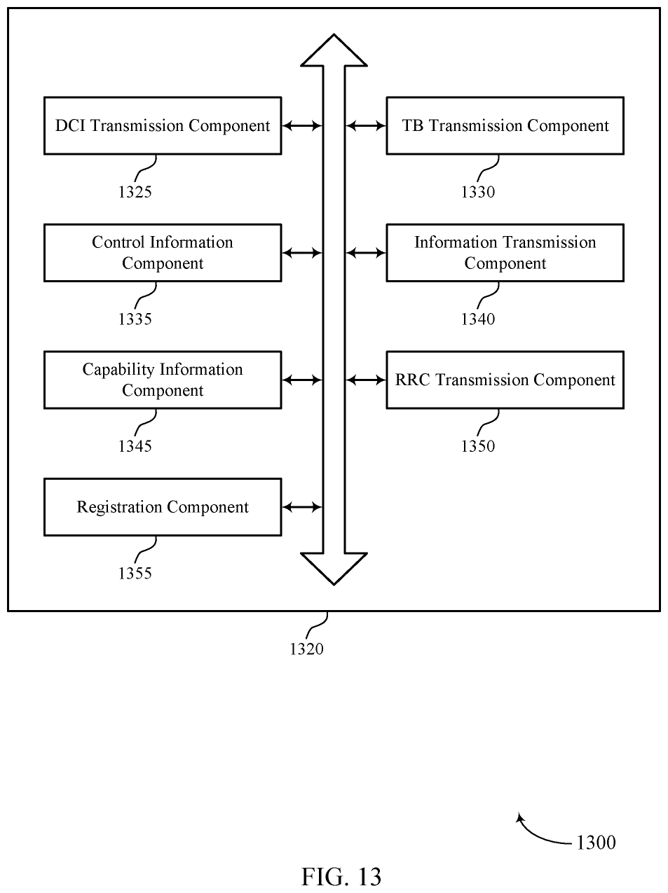

FIG. 13 shows a block diagram 1300 of a communications manager 1320 that supports inter-TB time interleaving in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of inter-TB time interleaving as described herein. For example, the communications manager 1320 may include a DCI transmission component 1325, a TB transmission component 1330, a control information component 1335, an information transmission component 1340, a capability information component 1345, an RRC transmission component 1350, a registration component 1355, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication in accordance with examples as disclosed herein. The DCI transmission component 1325 is capable of, configured to, or operable to support a means for transmitting a first set of one or more downlink control information messages that collectively schedule a first set of instances of a first TB. In some examples, the DCI transmission component 1325 is capable of, configured to, or operable to support a means for transmitting a second set of one or more downlink control information messages that collectively schedule a second set of instances of a second TB. The TB transmission component 1330 is capable of, configured to, or operable to support a means for transmitting, via a set of one or more physical downlink shared channels (PDSCHs) in accordance with the first set of one or more downlink control information messages and the second set of one or more downlink control information messages, the first set of instances of the first TB and the second set of instances of the second TB for a multicast service or a broadcast service, where at least one instance of the first set of instances of the first TB is interleaved with the second set of instances of the second TB.

In some examples, each downlink control information message of the first set of one or more downlink control information messages schedules a respective instance of the first set of instances of the first TB. In some examples, each downlink control information message of the second set of one or more downlink control information messages schedules a respective instance of the second set of instances of the second TB.

In some examples, each downlink control information message of the first set of one or more downlink control information messages includes a respective field indicating that the scheduled respective instance of the first set of instances corresponds to the first TB.

In some examples, the respective field of each downlink control information message of the first set of one or more downlink control information messages indicates a respective HARQ process identifier (ID) associate with the scheduled respective instance of the first set of instances, a new data indicator (NDI) associated with the HARQ process ID, or both.

In some examples, the NDI associated with the respective HARQ process ID indicates whether the scheduled respective instance is a first temporal transmission corresponding to the first transport block.

In some examples, the HARQ process ID indicates whether the scheduled respective instance is a retransmission corresponding to the first TB.

In some examples, at least one downlink control information message of the first set of one or more downlink control information messages has downlink control information format 4_.

In some examples, at least one downlink control information message of the first set of one or more downlink control information messages is for the broadcast service and has downlink control information format 4_1. In some examples, at least one downlink control information message of the first set of one or more downlink control information messages is for the broadcast service and has downlink control information format 4_2.

In some examples, transmit information that indicates a time window associated the first set of instances and decoding the first TB.

In some examples, the first set of one or more downlink control information messages and the second set of one or more downlink control information messages are configured to be decodable by at least a second network entity that is of a different generation than at least a third network entity. In some examples, the second network entity and the third network entity are capable of decoding the first set of one or more downlink control information messages and the second set of one or more downlink control information messages. In some examples, the third network entity is capable of communicating time interleaved respective instances of respective TBs that are for the multicast service or the broadcast service, or both.

In some examples, transmit first information that indicates a quantity of the first set of instances of the first TB and second information that indicates a time delay between individual instances of the first set of instances of the first TB, and where the first set of one or more downlink control information messages is a single downlink control information message that schedules the first set of instances of the first TB.

In some examples, transmit radio resource control information that corresponds to a group radio network temporary identifier associated with a second network entity, where the radio resource control information includes the first information and the second information.

In some examples, the single downlink control information message includes a time domain resource allocation index that is indicative of the first information and the second information.

In some examples, transmit radio resource control information that includes the first information, where the single downlink control information message includes a time domain resources allocation index that is indicative of the second information.

In some examples, transmit radio resource control information that includes the second information, where the single downlink control information message includes a time domain resource allocation index that is indicative of the first information.

In some examples, the single downlink control information message includes a field with more than 2 bits that indicates a redundancy version index associated with one instance of the first set of instances of the first TB.

In some examples, each downlink control information message of the first set of one or more downlink control information messages includes a respective field with more than 2 bits that indicates a respective redundancy version index associated with a respective instance of the first set of instances of the first TB.

In some examples, transmit information that indicates a redundancy version index pattern for the first set of instances of the first TB, where the redundancy version index pattern is associated with decoding the first TB.

In some examples, the redundancy version index pattern indicates that a respective redundancy version index associated with a first temporal instance of the first set of instances of the first TB is zero.

In some examples, at least one downlink control information message of the first set of one or more downlink control information messages includes a redundancy version field that indicates a redundancy version index associated with a first temporal instance of the first set of instances of the first TB. In some examples, the indicated redundancy version index corresponds to a redundancy version index pattern of a set of multiple redundancy version index patterns. In some examples, the redundancy version index pattern begins with the indicated redundancy version index.

In some examples, receive information that indicate a capability of a second network entity to communicate time interleaved respective instances of respective TBs that are for the multicast service or the broadcast service, where transmitting the first set of one or more downlink control information messages, transmitting the second set of one or more downlink control information messages, transmitting the first set of instances of the first TB, or transmitting the second set of instances of the second TB, or any combination thereof, is based on receiving the information.

Additionally, or alternatively, the communications manager 1320 may support wireless communication in accordance with examples as disclosed herein. The control information component 1335 is capable of, configured to, or operable to support a means for transmitting control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof. In some examples, the TB transmission component 1330 is capable of, configured to, or operable to support a means for transmitting, via a set of one or more physical downlink shared channels (PDSCHs) according to the one or more parameters, a first set of instances of a first TB and a second set of instances of a second TB for a multicast service or a broadcast service, where the first set of instances of the first TB and the second set of instances of the second TB are time-interleaved.

In some examples, transmit one or more radio resource control messages.

In some examples, the one or more radio resource control messages semi-statically configure the one or more parameters.

In some examples, transmit one or more downlink control information messages.

In some examples, at least one downlink control information message of the one or more downlink control information messages schedules resources for receiving one or more of the set of multiple TBs and activates the one or more parameters.

In some examples, the control information includes one or more downlink control information messages that are in a format supported by a second network entity for scheduling time-interleaved TBs for the multicast service or the broadcast service.

In some examples, the one or more downlink control information messages are associated with one or more of a group radio network temporary identifier, a control resource set, a SS set, or any combination thereof. In some examples, the association is indicative that the one or more downlink control information messages include the one or more parameters and pertain to communications of the multicast service or the broadcast service.

In some examples, the one or more downlink control information messages include dedicated fields for the one or more parameters.

In some examples, the one or more downlink control information messages include a time domain resource allocation index corresponding to a time domain resource allocation table including entries for the one or more parameters.

In some examples, transmit second control information that indicates a pattern of HARQ process identifiers (IDs) corresponding to instances of the set of multiple TBs, where each respective instance of the first set of instances of the first TB corresponds to a respective HARQ process ID of the pattern of HARQ process IDs and each respective instance of the second set of instances of the second TB corresponds to a respective HARQ process ID of the pattern of HARQ process IDs, and where the first set of instances of the first TB and the second set of instances of the second TB are time-interleaved based on the pattern of HARQ process IDs.

In some examples, a size of the first TB is based on the TB scaling factor and the respective quantity of instances of the first set of instances of the first TB.

In some examples, a threshold data rate per time duration of a set of multiple time durations that corresponds to the first set of instances of the first TB is based on the TB scaling factor.

In some examples, transmit second control information that indicates one or more redundancy version index patterns, where a redundancy version index of a first redundancy version index pattern corresponds to each respective instance of the first set of instances, and where an order of the first set of instances of the first TB is based on the first redundancy version index pattern.

Additionally, or alternatively, the communications manager 1320 may support wireless communication in accordance with examples as disclosed herein. In some examples, the control information component 1335 is capable of, configured to, or operable to support a means for transmitting control information that schedules one or more respective instances of a set of multiple respective TBs, where the one or more respective instances of the set of multiple respective TBs are time-interleaved according to a time interleaving pattern, a timing gap being between each of the one or more respective instances of the set of multiple respective TBs. In some examples, the TB transmission component 1330 is capable of, configured to, or operable to support a means for transmitting, via a first set of one or more physical downlink shared channels (PDSCHs) and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process.

In some examples, the control information is configured to be decodable by at least a second network entity that is of a different generation than a third network entity. In some examples, the second network entity and the third network entity are capable of decoding the control information. In some examples, the third network entity is capable of communicating time interleaved respective instances of respective TBs that are for the multicast service or the broadcast service, or both.

In some examples, the first set of instances of the first TB and the second set of instances of the second TB are transmitted via a bandwidth that satisfies a threshold bandwidth for the multicast service or the broadcast service via at least one PDSCH.

In some examples, receive registration information that indicates a capability of a second network entity to receive the one or more respective instances of the set of multiple respective TBs via the threshold bandwidth, where the first set of instances of the first TB are transmitted based on the registration information.

In some examples, the threshold bandwidth is a reduced bandwidth. In some examples, the reduced bandwidth includes less frequency resources than a second bandwidth for receiving a fourth set of instances of a fourth TB. In some examples, the fourth set of instances is a single instance, is not time-interleaved with instances of a fifth TB, or is associated with a single PDSCH, or any combination thereof.

In some examples, the threshold bandwidth is a 5 megahertz bandwidth.

In some examples, the control information includes one or more downlink control information messages that schedule the first set of instances of the first TB, the one or more downlink control information messages including an identifier that is indicative that the first set of instances correspond to the first TB. In some examples, transmission of the first set of instances of the first TB of the set of multiple respective TBs for the multicast service or the broadcast service in accordance with the timing gap is based on the identifier.

Additionally, or alternatively, the communications manager 1320 may support wireless communication in accordance with examples as disclosed herein. In some examples, the DCI transmission component 1325 is capable of, configured to, or operable to support a means for transmitting a first set of one or more downlink control information messages that collectively schedule a first set of instances of a first TB. In some examples, the DCI transmission component 1325 is capable of, configured to, or operable to support a means for transmitting a second set of one or more downlink control information messages that collectively schedule a second set of instances of a second TB. In some examples, the TB transmission component 1330 is capable of, configured to, or operable to support a means for transmitting, via a set of one or more physical downlink shared channels (PDSCHs) in accordance with the first set of one or more downlink control information messages and the second set of one or more downlink control information messages, the first set of instances of the first TB and the second set of instances of the second TB for a multicast service or a broadcast service, where at least one instance of the first set of instances of the first TB is interleaved with the second set of instances of the second TB.

In some examples, each downlink control information message of the first set of one or more downlink control information messages schedules a respective instance of the first set of instances of the first TB. In some examples, each downlink control information message of the second set of one or more downlink control information messages schedules a respective instance of the second set of instances of the second TB.

In some examples, each downlink control information message of the first set of one or more downlink control information messages includes a respective field indicating that the scheduled respective instance of the first set of instances corresponds to the first TB.

In some examples, the respective field of each downlink control information message of the first set of one or more downlink control information messages indicates a respective HARQ process identifier (ID) associate with the scheduled respective instance of the first set of instances, a new data indicator (NDI) associated with the HARQ process ID, or both.

In some examples, the NDI associated with the respective HARQ process ID indicates whether the scheduled respective instance is a first temporal transmission corresponding to the first transport block.

In some examples, the HARQ process ID indicates whether the scheduled respective instance is a retransmission corresponding to the first TB.

In some examples, at least one downlink control information message of the first set of one or more downlink control information messages has downlink control information format 4_.

In some examples, at least one downlink control information message of the first set of one or more downlink control information messages is for the broadcast service and has downlink control information format 4_1. In some examples, at least one downlink control information message of the first set of one or more downlink control information messages is for the broadcast service and has downlink control information format 4_2.

In some examples, the information transmission component 1340 is capable of, configured to, or operable to support a means for transmit information that indicates a time window associated the first set of instances and decoding the first TB.

In some examples, the first set of one or more downlink control information messages and the second set of one or more downlink control information messages are configured to be decodable by at least a second network entity that is of a different generation than at least a third network entity. In some examples, the second network entity and the third network entity are capable of decoding the first set of one or more downlink control information messages and the second set of one or more downlink control information messages. In some examples, the third network entity is capable of communicating time interleaved respective instances of respective TBs that are for the multicast service or the broadcast service, or both.

In some examples, the information transmission component 1340 is capable of, configured to, or operable to support a means for transmitting first information that indicates a quantity of the first set of instances of the first TB and second information that indicates a time delay between individual instances of the first set of instances of the first TB, and where the first set of one or more downlink control information messages is a single downlink control information message that schedules the first set of instances of the first TB.

In some examples, the RRC transmission component 1350 is capable of, configured to, or operable to support a means for transmitting radio resource control information that corresponds to a group radio network temporary identifier associated with a second network entity, where the radio resource control information includes the first information and the second information.

In some examples, the single downlink control information message includes a time domain resource allocation index that is indicative of the first information and the second information.

In some examples, the RRC transmission component 1350 is capable of, configured to, or operable to support a means for transmitting radio resource control information that includes the first information, where the single downlink control information message includes a time domain resources allocation index that is indicative of the second information.

In some examples, the RRC transmission component 1350 is capable of, configured to, or operable to support a means for transmitting radio resource control information that includes the second information, where the single downlink control information message includes a time domain resource allocation index that is indicative of the first information.

In some examples, the single downlink control information message includes a field with more than 2 bits that indicates a redundancy version index associated with one instance of the first set of instances of the first TB.

In some examples, each downlink control information message of the first set of one or more downlink control information messages includes a respective field with more than 2 bits that indicates a respective redundancy version index associated with a respective instance of the first set of instances of the first TB.

In some examples, the information transmission component 1340 is capable of, configured to, or operable to support a means for transmitting information that indicates a redundancy version index pattern for the first set of instances of the first TB, where the redundancy version index pattern is associated with decoding the first TB.

In some examples, the redundancy version index pattern indicates that a respective redundancy version index associated with a first temporal instance of the first set of instances of the first TB is zero.

In some examples, at least one downlink control information message of the first set of one or more downlink control information messages includes a redundancy version field that indicates a redundancy version index associated with a first temporal instance of the first set of instances of the first TB. In some examples, the indicated redundancy version index corresponds to a redundancy version index pattern of a set of multiple redundancy version index patterns. In some examples, the redundancy version index pattern begins with the indicated redundancy version index.

In some examples, the capability information component 1345 is capable of, configured to, or operable to support a means for receiving information that indicate a capability of a second network entity to communicate time interleaved respective instances of respective TBs that are for the multicast service or the broadcast service, where transmitting the first set of one or more downlink control information messages, transmitting the second set of one or more downlink control information messages, transmitting the first set of instances of the first TB, or transmitting the second set of instances of the second TB, or any combination thereof, is based on receiving the information.

Additionally, or alternatively, the communications manager 1320 may support wireless communication in accordance with examples as disclosed herein. In some examples, the control information component 1335 is capable of, configured to, or operable to support a means for transmitting control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof. In some examples, the TB transmission component 1330 is capable of, configured to, or operable to support a means for transmitting, via a set of one or more physical downlink shared channels (PDSCHs) according to the one or more parameters, a first set of instances of a first TB and a second set of instances of a second TB for a multicast service or a broadcast service, where the first set of instances of the first TB and the second set of instances of the second TB are time-interleaved.

In some examples, to support transmitting the control information, the control information component 1335 is capable of, configured to, or operable to support a means for transmitting one or more radio resource control messages.

In some examples, the one or more radio resource control messages semi-statically configure the one or more parameters.

In some examples, to support transmitting the control information, the control information component 1335 is capable of, configured to, or operable to support a means for transmitting one or more downlink control information messages.

In some examples, at least one downlink control information message of the one or more downlink control information messages schedules resources for receiving one or more of the set of multiple TBs and activates the one or more parameters.

In some examples, the control information includes one or more downlink control information messages that are in a format supported by a second network entity for scheduling time-interleaved TBs for the multicast service or the broadcast service.

In some examples, the one or more downlink control information messages are associated with one or more of a group radio network temporary identifier, a control resource set, a SS set, or any combination thereof. In some examples, the association is indicative that the one or more downlink control information messages include the one or more parameters and pertain to communications of the multicast service or the broadcast service.

In some examples, the one or more downlink control information messages include dedicated fields for the one or more parameters.

In some examples, the one or more downlink control information messages include a time domain resource allocation index corresponding to a time domain resource allocation table including entries for the one or more parameters.

In some examples, the control information component 1335 is capable of, configured to, or operable to support a means for transmitting second control information that indicates a pattern of HARQ process identifiers (IDs) corresponding to instances of the set of multiple TBs, where each respective instance of the first set of instances of the first TB corresponds to a respective HARQ process ID of the pattern of HARQ process IDs and each respective instance of the second set of instances of the second TB corresponds to a respective HARQ process ID of the pattern of HARQ process IDs, and where the first set of instances of the first TB and the second set of instances of the second TB are time-interleaved based on the pattern of HARQ process IDs.

In some examples, a size of the first TB is based on the TB scaling factor and the respective quantity of instances of the first set of instances of the first TB.

In some examples, a threshold data rate per time duration of a set of multiple time durations that corresponds to the first set of instances of the first TB is based on the TB scaling factor.

In some examples, the control information component 1335 is capable of, configured to, or operable to support a means for transmitting second control information that indicates one or more redundancy version index patterns, where a redundancy version index of a first redundancy version index pattern corresponds to each respective instance of the first set of instances, and where an order of the first set of instances of the first TB is based on the first redundancy version index pattern.

Additionally, or alternatively, the communications manager 1320 may support wireless communication in accordance with examples as disclosed herein. In some examples, the control information component 1335 is capable of, configured to, or operable to support a means for transmitting control information that schedules one or more respective instances of a set of multiple respective TBs, where the one or more respective instances of the set of multiple respective TBs are time-interleaved according to a time interleaving pattern, a timing gap being between each of the one or more respective instances of the set of multiple respective TBs. In some examples, the TB transmission component 1330 is capable of, configured to, or operable to support a means for transmitting, via a first set of one or more physical downlink shared channels (PDSCHs) and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process.

In some examples, the control information is configured to be decodable by at least a second network entity that is of a different generation than a third network entity. In some examples, the second network entity and the third network entity are capable of decoding the control information. In some examples, the third network entity is capable of communicating time interleaved respective instances of respective TBs that are for the multicast service or the broadcast service, or both.

In some examples, the first set of instances of the first TB and the second set of instances of the second TB are transmitted via a bandwidth that satisfies a threshold bandwidth for the multicast service or the broadcast service via at least one PDSCH.

In some examples, the registration component 1355 is capable of, configured to, or operable to support a means for receiving registration information that indicates a capability of a second network entity to receive the one or more respective instances of the set of multiple respective TBs via the threshold bandwidth, where the first set of instances of the first TB are transmitted based on the registration information.

In some examples, the threshold bandwidth is a reduced bandwidth. In some examples, the reduced bandwidth includes less frequency resources than a second bandwidth for receiving a fourth set of instances of a fourth TB. In some examples, the fourth set of instances is a single instance, is not time-interleaved with instances of a fifth TB, or is associated with a single PDSCH, or any combination thereof.

In some examples, the threshold bandwidth is a 5 megahertz bandwidth.

In some examples, the control information includes one or more downlink control information messages that schedule the first set of instances of the first TB, the one or more downlink control information messages including an identifier that is indicative that the first set of instances correspond to the first TB. In some examples, transmission of the first set of instances of the first TB of the set of multiple respective TBs for the multicast service or the broadcast service in accordance with the timing gap is based on the identifier.

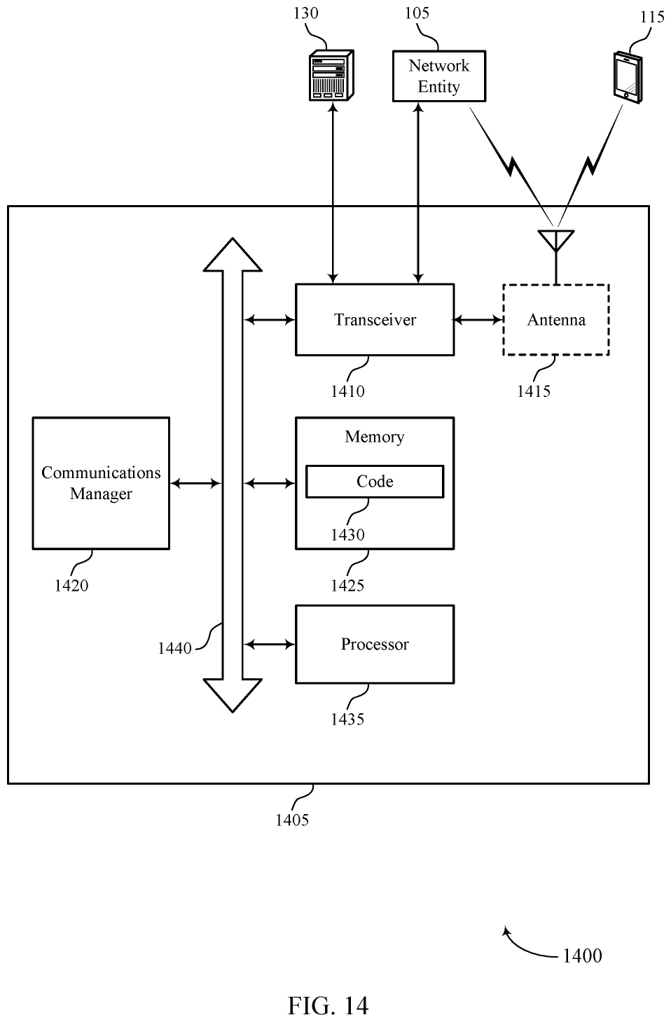

FIG. 14 shows a diagram of a system 1400 including a device 1405 that supports inter-TB time interleaving in accordance with one or more aspects of the present disclosure. The device 1405 may be an example of or include the components of a device 1105, a device 1205, or a network entity 105 as described herein, wherein a network entity 105 may include or may be a UE 115 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., a communication link 125, a backhaul communication link 120, a midhaul communication link 162, a fronthaul communication link 168).

The at least one memory 1425 may include RAM, ROM, or any combination thereof. The at least one memory 1425 may store computer-readable, computer-executable code 1430 including instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may contain, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting inter-TB time interleaving). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425). In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. As such, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication in accordance with examples as disclosed herein. For example, the communications manager 1420 is capable of, configured to, or operable to support a means for transmitting a first set of one or more downlink control information messages that collectively schedule a first set of instances of a first TB. The communications manager 1420 is capable of, configured to, or operable to support a means for transmitting a second set of one or more downlink control information messages that collectively schedule a second set of instances of a second TB. The communications manager 1420 is capable of, configured to, or operable to support a means for transmitting, via a set of one or more physical downlink shared channels (PDSCHs) in accordance with the first set of one or more downlink control information messages and the second set of one or more downlink control information messages, the first set of instances of the first TB and the second set of instances of the second TB for a multicast service or a broadcast service, where at least one instance of the first set of instances of the first TB is interleaved with the second set of instances of the second TB.

Additionally, or alternatively, the communications manager 1420 may support wireless communication in accordance with examples as disclosed herein. For example, the communications manager 1420 is capable of, configured to, or operable to support a means for transmitting control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof. The communications manager 1420 is capable of, configured to, or operable to support a means for transmitting, via a set of one or more physical downlink shared channels (PDSCHs) according to the one or more parameters, a first set of instances of a first TB and a second set of instances of a second TB for a multicast service or a broadcast service, where the first set of instances of the first TB and the second set of instances of the second TB are time-interleaved.

Additionally, or alternatively, the communications manager 1420 may support wireless communication in accordance with examples as disclosed herein. For example, the communications manager 1420 is capable of, configured to, or operable to support a means for transmitting control information that schedules one or more respective instances of a set of multiple respective TBs, where the one or more respective instances of the set of multiple respective TBs are time-interleaved according to a time interleaving pattern, a timing gap being between each of the one or more respective instances of the set of multiple respective TBs. The communications manager 1420 is capable of, configured to, or operable to support a means for transmitting, via a first set of one or more physical downlink shared channels (PDSCHs) and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process.

Additionally, or alternatively, the communications manager 1420 may support wireless communication in accordance with examples as disclosed herein. For example, the communications manager 1420 is capable of, configured to, or operable to support a means for transmitting a first set of one or more downlink control information messages that collectively schedule a first set of instances of a first TB. The communications manager 1420 is capable of, configured to, or operable to support a means for transmitting a second set of one or more downlink control information messages that collectively schedule a second set of instances of a second TB. The communications manager 1420 is capable of, configured to, or operable to support a means for transmitting, via a set of one or more physical downlink shared channels (PDSCHs) in accordance with the first set of one or more downlink control information messages and the second set of one or more downlink control information messages, the first set of instances of the first TB and the second set of instances of the second TB for a multicast service or a broadcast service, where at least one instance of the first set of instances of the first TB is interleaved with the second set of instances of the second TB.

Additionally, or alternatively, the communications manager 1420 may support wireless communication in accordance with examples as disclosed herein. For example, the communications manager 1420 is capable of, configured to, or operable to support a means for transmitting control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof. The communications manager 1420 is capable of, configured to, or operable to support a means for transmitting, via a set of one or more physical downlink shared channels (PDSCHs) according to the one or more parameters, a first set of instances of a first TB and a second set of instances of a second TB for a multicast service or a broadcast service, where the first set of instances of the first TB and the second set of instances of the second TB are time-interleaved.

Additionally, or alternatively, the communications manager 1420 may support wireless communication in accordance with examples as disclosed herein. For example, the communications manager 1420 is capable of, configured to, or operable to support a means for transmitting control information that schedules one or more respective instances of a set of multiple respective TBs, where the one or more respective instances of the set of multiple respective TBs are time-interleaved according to a time interleaving pattern, a timing gap being between each of the one or more respective instances of the set of multiple respective TBs. The communications manager 1420 is capable of, configured to, or operable to support a means for transmitting, via a first set of one or more physical downlink shared channels (PDSCHs) and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process.

By including or configuring the communications manager 1420 in accordance with examples as described herein, the device 1405 may support techniques for improved communication reliability. For example, network entities (e.g., including UEs) implementing the techniques described herein may be capable of soft combining multiple instances of a TB for MBS communications, which may allow for increased decoding reliability in the MBS communications.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of inter-TB time interleaving as described herein, or the at least one processor 1435 and the at least one memory 1425 may be otherwise configured to, individually or collectively, perform or support such operations.

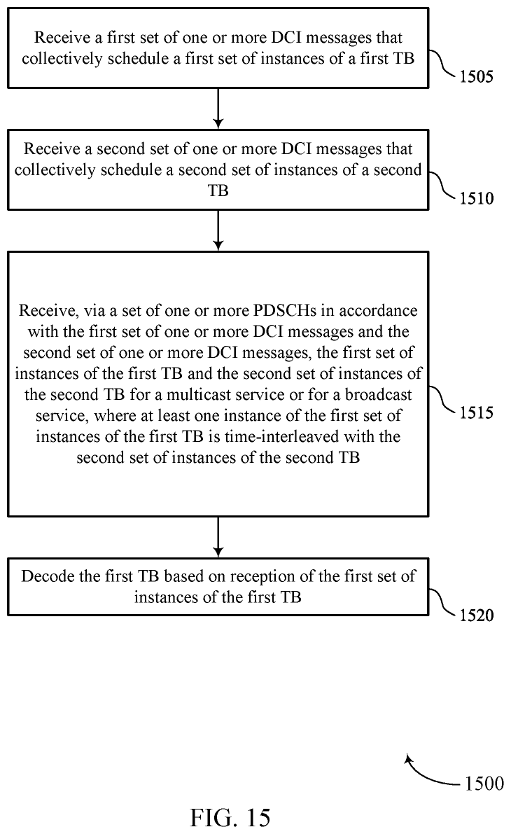

FIG. 15 shows a flowchart illustrating a method 1500 that supports inter-TB time interleaving in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving a first set of one or more DCI messages that collectively schedule a first set of instances of a first TB. The operations of block 1505 may be performed in accordance with examples as disclosed herein. In some examples, aspects of the operations of 1505 may be performed by a DCI reception component 925 as described with reference to FIG. 9.

At 1510, the method may include receiving a second set of one or more DCI messages that collectively schedule a second set of instances of a second TB. The operations of block 1510 may be performed in accordance with examples as disclosed herein. In some examples, aspects of the operations of 1510 may be performed by a DCI reception component 925 as described with reference to FIG. 9.

At 1515, the method may include receiving, via a set of one or more PDSCHs in accordance with the first set of one or more DCI messages and the second set of one or more DCI messages, the first set of instances of the first TB and the second set of instances of the second TB for a multicast service or for a broadcast service, where at least one instance of the first set of instances of the first TB is time-interleaved with the second set of instances of the second TB. The operations of block 1515 may be performed in accordance with examples as disclosed herein. In some examples, aspects of the operations of 1515 may be performed by a TB reception component 930 as described with reference to FIG. 9.

At 1520, the method may include decoding the first TB based on reception of the first set of instances of the first TB. The operations of block 1520 may be performed in accordance with examples as disclosed herein. In some examples, aspects of the operations of 1520 may be performed by a TB decoding component 935 as described with reference to FIG. 9.

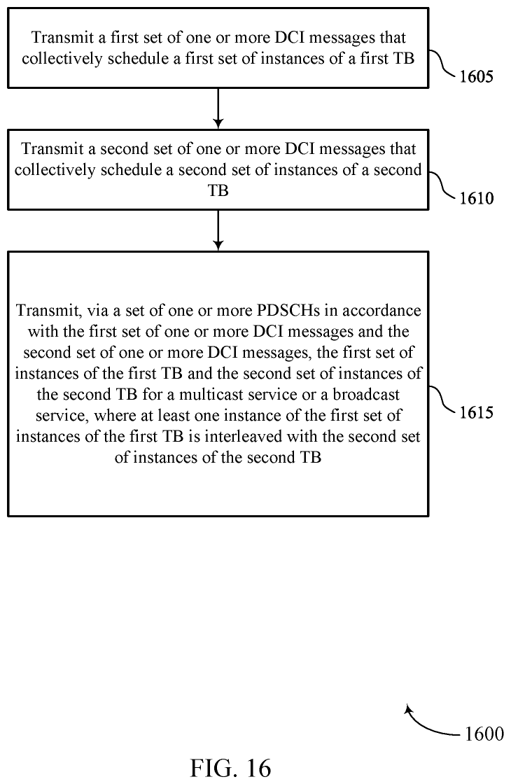

FIG. 16 shows a flowchart illustrating a method 1600 that supports inter-TB time interleaving in accordance with aspects of the present disclosure. The operations of the method 1600 may be implemented by a network entity or its components as described herein. For example, the operations of the method 1600 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1605, the method may include transmitting a first set of one or more DCI messages that collectively schedule a first set of instances of a first TB. The operations of block 1605 may be performed in accordance with examples as disclosed herein. In some examples, aspects of the operations of 1605 may be performed by a DCI transmission component 1325 as described with reference to FIG. 13.

At 1610, the method may include transmitting a second set of one or more DCI messages that collectively schedule a second set of instances of a second TB. The operations of block 1610 may be performed in accordance with examples as disclosed herein. In some examples, aspects of the operations of 1610 may be performed by a DCI transmission component 1325 as described with reference to FIG. 13.

At 1615, the method may include transmitting, via a set of one or more PDSCHs in accordance with the first set of one or more DCI messages and the second set of one or more DCI messages, the first set of instances of the first TB and the second set of instances of the second TB for a multicast service or a broadcast service, where at least one instance of the first set of instances of the first TB is interleaved with the second set of instances of the second TB. The operations of block 1615 may be performed in accordance with examples as disclosed herein. In some examples, aspects of the operations of 1615 may be performed by a TB transmission component 1330 as described with reference to FIG. 13.

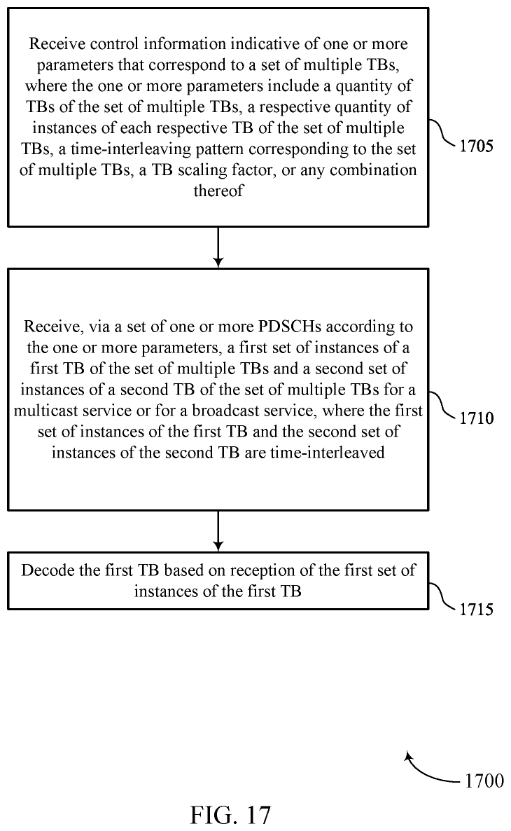

FIG. 17 shows a flowchart illustrating a method 1700 that supports inter-TB time interleaving in accordance with aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include receiving control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof. The operations of block 1705 may be performed in accordance with examples as disclosed herein. In some examples, aspects of the operations of 1705 may be performed by a control information component 940 as described with reference to FIG. 9.

At 1710, the method may include receiving, via a set of one or more PDSCHs according to the one or more parameters, a first set of instances of a first TB of the set of multiple TBs and a second set of instances of a second TB of the set of multiple TBs for a multicast service or for a broadcast service, where the first set of instances of the first TB and the second set of instances of the second TB are time-interleaved. The operations of block 1710 may be performed in accordance with examples as disclosed herein. In some examples, aspects of the operations of 1710 may be performed by a TB reception component 930 as described with reference to FIG. 9.

At 1715, the method may include decoding the first TB based on reception of the first set of instances of the first TB. The operations of block 1715 may be performed in accordance with examples as disclosed herein. In some examples, aspects of the operations of 1715 may be performed by a TB decoding component 935 as described with reference to FIG. 9.

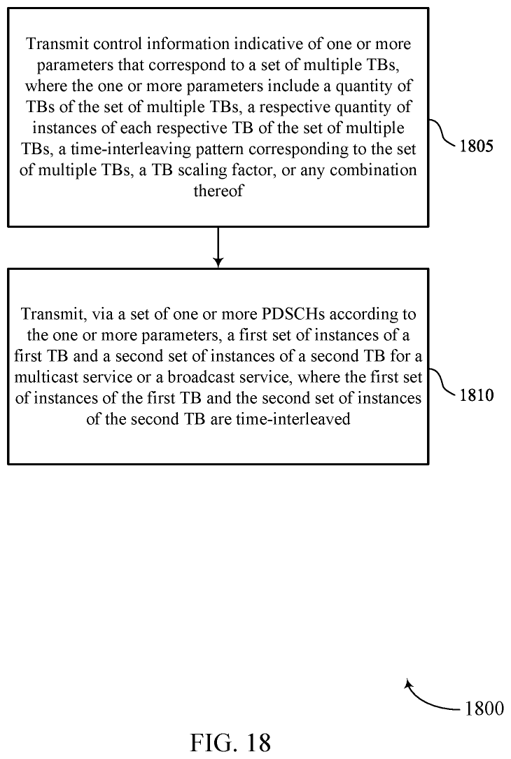

FIG. 18 shows a flowchart illustrating a method 1800 that supports inter-TB time interleaving in accordance with aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include transmitting control information indicative of one or more parameters that correspond to a set of multiple TBs, where the one or more parameters include a quantity of TBs of the set of multiple TBs, a respective quantity of instances of each respective TB of the set of multiple TBs, a time interleaving pattern corresponding to the set of multiple TBs, a TB scaling factor, or any combination thereof. The operations of block 1805 may be performed in accordance with examples as disclosed herein. In some examples, aspects of the operations of 1805 may be performed by a control information component 1335 as described with reference to FIG. 13.

At 1810, the method may include transmitting, via a set of one or more PDSCHs according to the one or more parameters, a first set of instances of a first TB and a second set of instances of a second TB for a multicast service or a broadcast service, where the first set of instances of the first TB and the second set of instances of the second TB are time-interleaved. The operations of block 1810 may be performed in accordance with examples as disclosed herein. In some examples, aspects of the operations of 1810 may be performed by a TB transmission component 1330 as described with reference to FIG. 13.

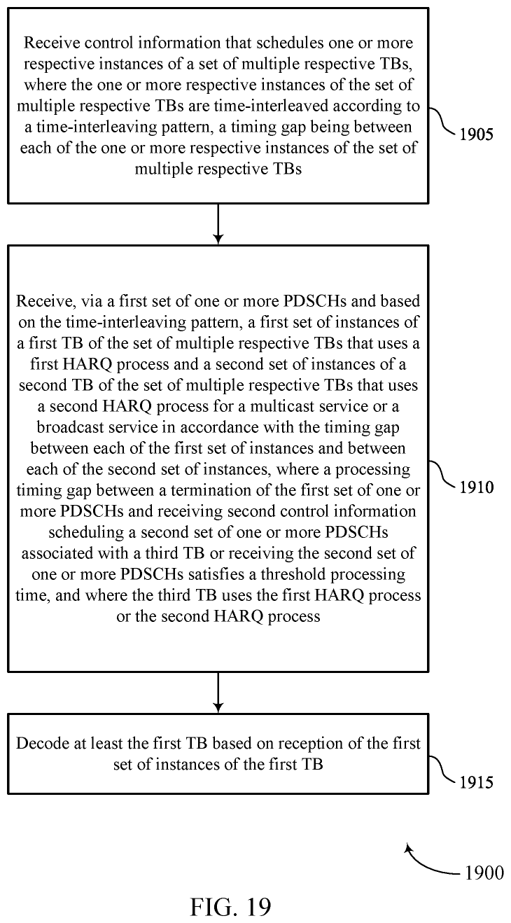

FIG. 19 shows a flowchart illustrating a method 1900 that supports inter-TB time interleaving in accordance with aspects of the present disclosure. The operations of the method 1900 may be implemented by a UE or its components as described herein. For example, the operations of the method 1900 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1905, the method may include receiving control information that schedules one or more respective instances of a set of multiple respective TBs, where the one or more respective instances of the set of multiple respective TBs are time-interleaved according to a time interleaving pattern, a timing gap being between each of the one or more respective instances of the set of multiple respective TBs. The operations of block 1905 may be performed in accordance with examples as disclosed herein. In some examples, aspects of the operations of 1905 may be performed by a control information component 940 as described with reference to FIG. 9.

At 1910, the method may include receiving, via a first set of one or more PDSCHs and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process. The operations of block 1910 may be performed in accordance with examples as disclosed herein. In some examples, aspects of the operations of 1910 may be performed by a TB reception component 930 as described with reference to FIG. 9.

At 1915, the method may include decode at least the first TB basing on reception of the first set of instances of the first TB. The operations of block 1915 may be performed in accordance with examples as disclosed herein. In some examples, aspects of the operations of 1915 may be performed by a TB decoding component 935 as described with reference to FIG. 9.

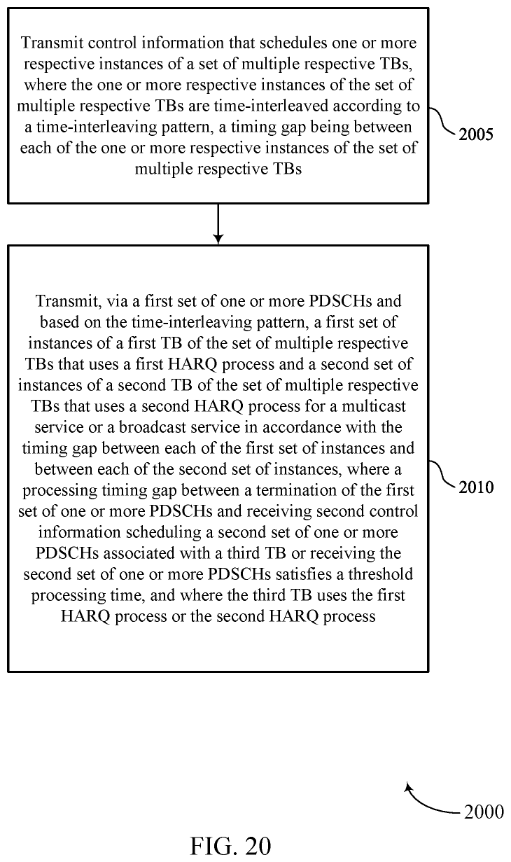

FIG. 20 shows a flowchart illustrating a method 2000 that supports inter-TB time interleaving in accordance with aspects of the present disclosure. The operations of the method 2000 may be implemented by a network entity or its components as described herein. For example, the operations of the method 2000 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2005, the method may include transmitting control information that schedules one or more respective instances of a set of multiple respective TBs, where the one or more respective instances of the set of multiple respective TBs are time-interleaved according to a time interleaving pattern, a timing gap being between each of the one or more respective instances of the set of multiple respective TBs. The operations of block 2005 may be performed in accordance with examples as disclosed herein. In some examples, aspects of the operations of 2005 may be performed by a control information component 1335 as described with reference to FIG. 13.

At 2010, the method may include transmitting, via a first set of one or more PDSCHs and based on the time interleaving pattern, a first set of instances of a first TB of the set of multiple respective TBs that uses a first HARQ process and a second set of instances of a second TB of the set of multiple respective TBs that uses a second HARQ process for a multicast service or a broadcast service in accordance with the timing gap between each of the first set of instances and between each of the second set of instances, where a processing timing gap between a termination of the first set of one or more PDSCHs and receiving second control information scheduling a second set of one or more PDSCHs associated with a third TB or receiving the second set of one or more PDSCHs satisfies a threshold processing time, and where the third TB uses the first HARQ process or the second HARQ process. The operations of block 2010 may be performed in accordance with examples as disclosed herein. In some examples, aspects of the operations of 2010 may be performed by a TB transmission component 1330 as described with reference to FIG. 13.

The following provides an overview of aspects of the present disclosure:

Aspect 1: A method for wireless communication by a network entity, comprising: receiving a first set of one or more DCI messages that collectively schedule a first set of instances of a first TB; receiving a second set of one or more DCI messages that collectively schedule a second set of instances of a second TB; receiving, via a set of one or more PDSCHs in accordance with the first set of one or more DCI messages and the second set of one or more DCI messages, the first set of instances of the first TB and the second set of instances of the second TB for a multicast service or for a broadcast service, wherein at least one instance of the first set of instances of the first TB is time-interleaved with the second set of instances of the second TB; and decoding the first TB based on reception of the first set of instances of the first TB.

Aspect 2: The method of aspect 1, wherein decoding the first TB comprises: performing a soft combination of one or more instances of the first set of instances of the first TB based on the first set of one or more DCI messages comprising an indication that each instance of the one or more instances of the first set of instances is of the first TB.

Aspect 3: The method of any of aspects 1 through 2, wherein decoding the first TB comprises: decoding the first TB based on the network entity being of a first generation of network entity that is different from a second generation of network entity, or the network entity being capable of communicating time interleaved respective instances of respective TBs that are for the multicast service or the broadcast service, or both.

Aspect 4: The method of any of aspects 1 through 3, wherein the first set of one or more DCI messages and the second set of one or more DCI messages are configured to be decodable by at least a second network entity that is of a different generation than the network entity, the network entity and the second network entity are capable of decoding the first set of one or more DCI messages and the second set of one or more DCI messages, and the network entity is capable of communicating time interleaved respective instances of respective TBs that are for the multicast service or the broadcast service, or both

Aspect 5: The method of any of aspects 1 through 4, wherein each DCI message of the first set of one or more DCI messages schedules a respective instance of the first set of instances of the first TB, and each DCI message of the second set of one or more DCI messages schedules a respective instance of the second set of instances of the second TB

Aspect 6: The method of aspect 5, wherein each DCI message of the first set of one or more DCI messages comprises a respective field indicating that the scheduled respective instance of the first set of instances corresponds to the first TB, decoding the first TB is based on the respective field of each DCI message of the first set of one or more DCI messages

Aspect 7: The method of aspect 6, wherein the respective field of each DCI message of the first set of one or more DCI messages indicates a respective HPID associated with the scheduled respective instance of the first set of instances, a NDI associated with the HPID, or both.

Aspect 8: The method of aspect 7, wherein the NDI associated with the respective HPID indicates whether the scheduled respective instance is a first temporal transmission corresponding to the first TB.

Aspect 9: The method of any of aspects 7 through 8, wherein the HPID indicates whether the scheduled respective instance is a retransmission corresponding to the first TB.

Aspect 10: The method of any of aspects 7 through 9, wherein at least one DCI message of the first set of one or more DCI messages has DCI format 4_0.

Aspect 11: The method of any of aspects 7 through 10, wherein at least one of at least one DCI message of the first set of one or more DCI messages is for the broadcast service and has DCI format 4_1; or at least one DCI message of the first set of one or more DCI messages is for the broadcast service and has DCI format 4_2.

Aspect 12: The method of any of aspects 5 through 11, further comprising: receiving information that indicates a time window, wherein decoding the first TB is based on the first set of instances being within the time window.

Aspect 13: The method of any of aspects 1 through 4, further comprising: receiving first information that indicates a quantity of the first set of instances of the first TB and second information that indicates a time delay between individual instances of the first set of instances of the first TB, wherein decoding the first TB is based on the quantity and the time delay, and wherein the first set of one or more DCI messages is a single DCI message that schedules the first set of instances of the first TB.

Aspect 14: The method of aspect 13, further comprising: receiving RRC information that corresponds to a group radio network temporary identifier associated with the network entity, wherein the RRC information includes the first information and the second information.

Aspect 15: The method of aspect 13, wherein the single DCI message comprises a TDRA index that is indicative of the first information and the second information.

Aspect 16: The method of aspect 13, further comprising: receiving RRC information that includes the first information, wherein the single DCI message includes a TDRA index that is indicative of the second information.

Aspect 17: The method of aspect 13, further comprising: receiving RRC information that includes the second information, wherein the single DCI message includes a TDRA index that is indicative of the first information.

Aspect 18: The method of any of aspects 13 through 17, wherein the single DCI message includes a field with more than 2 bits that indicates a RV index associated with one instance of the first set of instances of the first TB.

Aspect 19: The method of any of aspects 1 through 18, further comprising: receiving information that indicates a RV index pattern for the first set of instances of the first TB; and decoding only a portion of each DCI message of the first set of one or more DCI messages, wherein the portion excludes a respective RV field of each respective DCI message based on receipt of the information, and wherein decoding the first TB is based on the RV index pattern.

Aspect 20: The method of aspect 19, wherein the RV index pattern indicates that a respective RV index associated with a first temporal instance of the first set of instances of the first TB is zero.

Aspect 21: The method of any of aspects 1 through 20, wherein at least one DCI message of the first set of one or more DCI messages includes a RV field that indicates a RV index associated with a first temporal instance of the first set of instances of the first TB, the indicated RV index corresponds to a RV index pattern of a plurality of RV index patterns, and the RV index pattern begins with the indicated RV index

Aspect 22: A method for wireless communication by a network entity, comprising: transmitting a first set of one or more DCI messages that collectively schedule a first set of instances of a first TB; transmitting a second set of one or more DCI messages that collectively schedule a second set of instances of a second TB; and transmitting, via a set of one or more PDSCHs in accordance with the first set of one or more DCI messages and the second set of one or more DCI messages, the first set of instances of the first TB and the second set of instances of the second TB for a multicast service or a broadcast service, wherein at least one instance of the first set of instances of the first TB is interleaved with the second set of instances of the second TB.

Aspect 23: The method of aspect 22, wherein each DCI message of the first set of one or more DCI messages schedules a respective instance of the first set of instances of the first TB, and each DCI message of the second set of one or more DCI messages schedules a respective instance of the second set of instances of the second TB

Aspect 24: The method of aspect 23, wherein each DCI message of the first set of one or more DCI messages comprises a respective field indicating that the scheduled respective instance of the first set of instances corresponds to the first TB.

Aspect 25: The method of aspect 24, wherein the respective field of each DCI message of the first set of one or more DCI messages indicates a respective HPID associate with the scheduled respective instance of the first set of instances, a NDI associated with the HPID, or both.

Aspect 26: The method of aspect 25, wherein the NDI associated with the respective HPID indicates whether the scheduled respective instance is a first temporal transmission corresponding to the first TB.

Aspect 27: The method of any of aspects 25 through 26, wherein the HPID indicates whether the scheduled respective instance is a retransmission corresponding to the first TB.

Aspect 28: The method of any of aspects 24 through 27, wherein at least one DCI message of the first set of one or more DCI messages has DCI format 4_0.

Aspect 29: The method of any of aspects 24 through 28, wherein at least one of at least one DCI message of the first set of one or more DCI messages is for the broadcast service and has DCI format 4_1; or at least one DCI message of the first set of one or more DCI messages is for the broadcast service and has DCI format 4_2.

Aspect 30: The method of any of aspects 23 through 29, further comprising: transmit information that indicates a time window associated the first set of instances and decoding the first TB.

Aspect 31: The method of any of aspects 22 through 30, wherein the first set of one or more DCI messages and the second set of one or more DCI messages are configured to be decodable by at least a second network entity that is of a different generation than at least a third network entity, the second network entity and the third network entity are capable of decoding the first set of one or more DCI messages and the second set of one or more DCI messages, and the third network entity is capable of communicating time interleaved respective instances of respective TBs that are for the multicast service or the broadcast service, or both

Aspect 32: The method of any of aspects 22 and 31, further comprising: transmitting first information that indicates a quantity of the first set of instances of the first TB and second information that indicates a time delay between individual instances of the first set of instances of the first TB, and wherein the first set of one or more DCI messages is a single DCI message that schedules the first set of instances of the first TB.

Aspect 33: The method of aspect 32, further comprising: transmitting RRC information that corresponds to a group radio network temporary identifier associated with a second network entity, wherein the RRC information includes the first information and the second information.

Aspect 34: The method of aspect 32, wherein the single DCI message comprises a TDRA index that is indicative of the first information and the second information.

Aspect 35: The method of aspect 32, further comprising: transmitting RRC information that includes the first information, wherein the single DCI message includes a TDRA index that is indicative of the second information.

Aspect 36: The method of aspect 32, further comprising: transmitting RRC information that includes the second information, wherein the single DCI message includes a TDRA index that is indicative of the first information.

Aspect 37: The method of any of aspects 32 through 36, wherein the single DCI message includes a field with more than 2 bits that indicates a RV index associated with one instance of the first set of instances of the first TB.

Aspect 38: The method of any of aspects 22 through 37, wherein each DCI message of the first set of one or more DCI messages includes a respective field with more than 2 bits that indicates a respective RV index associated with a respective instance of the first set of instances of the first TB.

Aspect 39: The method of any of aspects 22 through 38, further comprising: transmitting information that indicates a RV index pattern for the first set of instances of the first TB, wherein the RV index pattern is associated with decoding the first TB.

Aspect 40: The method of aspect 39, wherein the RV index pattern indicates that a respective RV index associated with a first temporal instance of the first set of instances of the first TB is zero.

Aspect 41: The method of any of aspects 22 through 40, wherein at least one DCI message of the first set of one or more DCI messages includes a RV field that indicates a RV index associated with a first temporal instance of the first set of instances of the first TB, the indicated RV index corresponds to a RV index pattern of a plurality of RV index patterns, and the RV index pattern begins with the indicated RV index

Aspect 42: The method of any of aspects 22 through 41, further comprising: receiving information that indicate a capability of a second network entity to communicate time interleaved respective instances of respective TBs that are for the multicast service or the broadcast service, wherein transmitting the first set of one or more DCI messages, transmitting the second set of one or more DCI messages, transmitting the first set of instances of the first TB, or transmitting the second set of instances of the second TB, or any combination thereof, is based on receiving the information.

Aspect 43: A method for wireless communication by a network entity, comprising: receiving control information indicative of one or more parameters that correspond to a plurality of TBs, wherein the one or more parameters include a quantity of TBs of the plurality of TBs, a respective quantity of instances of each respective TB of the plurality of TBs, a time-interleaving pattern corresponding to the plurality of TBs, a TB scaling factor, or any combination thereof; receiving, via a set of one or more PDSCHs according to the one or more parameters, a first set of instances of a first TB of the plurality of TBs and a second set of instances of a second TB of the plurality of TBs for a multicast service or for a broadcast service, wherein the first set of instances of the first TB and the second set of instances of the second TB are time-interleaved; and decoding the first TB based on reception of the first set of instances of the first TB.

Aspect 44: The method of aspect 43, wherein receiving the control information and decoding the first TB are based on the network entity being of a first generation of network entity that is different from a second generation of network entity, or the network entity being capable of communicating time interleaved respective instances of respective TBs that are for the multicast service or the broadcast service, or both.

Aspect 45: The method of any of aspects 43 through 44, wherein receiving the control information comprises: receiving one or more RRC messages.

Aspect 46: The method of aspect 45, wherein the one or more RRC messages semi-statically configure the one or more parameters.

Aspect 47: The method of any of aspects 43 through 46, wherein receiving the control information comprises: receiving one or more DCI messages.

Aspect 48: The method of aspect 47, wherein at least one DCI message of the one or more DCI messages schedules resources for receiving one or more of the plurality of TBs and activates the one or more parameters.

Aspect 49: The method of any of aspects 47 through 48, wherein the one or more DCI messages are in a format supported by the network entity for scheduling time-interleaved TBs for the multicast service or the broadcast service.

Aspect 50: The method of any of aspects 47 through 49, wherein the one or more DCI messages are associated with one or more of a group radio network temporary identifier, a control resource set, a search space set, or any combination thereof, the association is indicative that the one or more DCI messages pertain to communications of the multicast service or the broadcast service

Aspect 51: The method of any of aspects 47 through 50, wherein the one or more DCI messages include a TDRA index corresponding to a TDRA table that includes entries for the one or more parameters.

Aspect 52: The method of any of aspects 47 through 51, wherein the one or more DCI messages include dedicated fields for the one or more parameters.

Aspect 53: The method of any of aspects 43 through 52, further comprising: receiving second control information that indicates a pattern of HPIDentifiers (IDs) corresponding to instances of the plurality of TBs, wherein each respective instance of the first set of instances of the first TB corresponds to a respective HPID of the pattern of HPIDs and each respective instance of the second set of instances of the second TB corresponds to a respective HPID of the pattern of HPIDs, and wherein the first set of instances of the first TB and the second set of instances of the second TB are time-interleaved based on the pattern of HPIDs.

Aspect 54: The method of any of aspects 43 through 53, wherein decoding the first TB comprises: decoding the first TB based on the TB scaling factor, wherein a size of the first TB is based on the TB scaling factor and the respective quantity of instances of the first set of instances of the first TB.

Aspect 55: The method of aspect 54, wherein decoding the first TB comprises: decode the first TB based on a low-density parity-check (LDPC) base graph defined by a coding rate and a payload size of the first TB, and wherein the payload size of the first TB is based on the TB scaling factor applied to an unscaled TB size.

Aspect 56: The method of any of aspects 54 through 55, wherein decoding the first TB comprises: decode the first TB based on a limited buffer rate matching (LBRM) size that is defined by the TB scaling factor.

Aspect 57: The method of any of aspects 54 through 56, wherein a threshold data rate per time duration of a plurality of time durations that correspond to the first set of instances of the first TB is based on the TB scaling factor.

Aspect 58: The method of aspect 57, wherein the threshold data rate per time duration for a component carrier for the multicast service or the broadcast service is less than or equal to a second threshold data rate for unicast signaling.

Aspect 59: The method of any of aspects 54 through 58, further comprising: receiving second control information that indicates one or more RV index patterns, wherein a RV index of a first RV index pattern corresponds to each respective instance of the first set of instances, and wherein an order of the first set of instances of the first TB is based on the first RV index pattern.

Aspect 60: The method of aspect 59, further comprising: selecting the first RV index pattern from the one or more RV index patterns based on the quantity of the first set of instances of the first TB satisfying a threshold quantity, wherein the first set of instances of the first TB and the second set of instances of the second TB are time-interleaved based on the first RV index pattern.

Aspect 61: A method for wireless communication by a network entity, comprising: transmitting control information indicative of one or more parameters that correspond to a plurality of TBs, wherein the one or more parameters include a quantity of TBs of the plurality of TBs, a respective quantity of instances of each respective TB of the plurality of TBs, a time-interleaving pattern corresponding to the plurality of TBs, a TB scaling factor, or any combination thereof; and transmitting, via a set of one or more PDSCHs according to the one or more parameters, a first set of instances of a first TB and a second set of instances of a second TB for a multicast service or a broadcast service, wherein the first set of instances of the first TB and the second set of instances of the second TB are time-interleaved.

Aspect 62: The method of aspect 61, wherein transmitting the control information comprises: transmitting one or more RRC messages.

Aspect 63: The method of aspect 62, wherein the one or more RRC messages semi-statically configure the one or more parameters.

Aspect 64: The method of any of aspects 61 through 63, wherein transmitting the control information comprises: transmitting one or more DCI messages.

Aspect 65: The method of aspect 64, wherein at least one DCI message of the one or more DCI messages schedules resources for receiving one or more of the plurality of TBs and activates the one or more parameters.

Aspect 66: The method of any of aspects 64 through 65, wherein the control information includes one or more DCI messages that are in a format supported by a second network entity for scheduling time-interleaved TBs for the multicast service or the broadcast service.

Aspect 67: The method of any of aspects 64 through 66, wherein the one or more DCI messages are associated with one or more of a group radio network temporary identifier, a control resource set, a search space set, or any combination thereof, the association is indicative that the one or more DCI messages include the one or more parameters and pertain to communications of the multicast service or the broadcast service.

Aspect 68: The method of any of aspects 64 through 67, wherein the one or more DCI messages include dedicated fields for the one or more parameters.

Aspect 69: The method of any of aspects 64 through 68, wherein the one or more DCI messages include a TDRA index corresponding to a TDRA table comprising entries for the one or more parameters.

Aspect 70: The method of any of aspects 61 through 69, further comprising: transmitting second control information that indicates a pattern of HPIDentifiers (IDs) corresponding to instances of the plurality of TBs, wherein each respective instance of the first set of instances of the first TB corresponds to a respective HPID of the pattern of HPIDs and each respective instance of the second set of instances of the second TB corresponds to a respective HPID of the pattern of HPIDs, and wherein the first set of instances of the first TB and the second set of instances of the second TB are time-interleaved based on the pattern of HPIDs.

Aspect 71: The method of any of aspects 61 through 70, wherein a size of the first TB is based on the TB scaling factor and the respective quantity of instances of the first set of instances of the first TB.

Aspect 72: The method of any of aspects 61 through 71, wherein a threshold data rate per time duration of a plurality of time durations that corresponds to the first set of instances of the first TB is based on the TB scaling factor.

Aspect 73: The method of any of aspects 61 through 72, further comprising: transmitting second control information that indicates one or more RV index patterns, wherein a RV index of a first RV index pattern corresponds to each respective instance of the first set of instances, and wherein an order of the first set of instances of the first TB is based on the first RV index pattern.

Aspect 74: A method for wireless communication by a network entity, comprising: receiving control information that schedules one or more respective instances of a plurality of respective TBs, wherein the one or more respective instances of the plurality of respective TBs are time-interleaved according to a time-interleaving pattern, a timing gap being between each of the one or more respective instances of the plurality of respective TBs; receiving, via a first set of one or more PDSCHs and based on the time-interleaving pattern, a first set of instances of a first TB of the plurality of respective TBs that uses a first HARQ process and a second set of instances of a second TB of the plurality of respective TBs that uses a second HARQ process for a multicast service or a broadcast service in accordance with the timing gap between each of the first set of instances and between each of the second set of instances, wherein a processing timing gap between a termination of the first set of one or more PDSCHs and receiving second control information scheduling a second set of one or more PDSCHs associated with a third TB or receiving the second set of one or more PDSCHs satisfies a threshold processing time, and wherein the third TB uses the first HARQ process or the second HARQ process; and decode at least the first TB basing on reception of the first set of instances of the first TB.

Aspect 75: The method of aspect 74, wherein the control information is configured to be decodable by at least a second network entity that is of a different generation than the network entity, the network entity and the second network entity are capable of decoding the control information, and the network entity is capable of communicating time interleaved respective instances of respective TBs that are for the multicast service or the broadcast service, or both

Aspect 76: The method of any of aspects 74 through 75, further comprising: monitoring for the first set of instances of the first TB and the second set of instances of the second TB via a bandwidth that satisfies a threshold bandwidth for multicast or broadcast via at least one PDSCH.

Aspect 77: The method of aspect 76, further comprising: transmitting registration information that indicates a capability of the network entity to receive the one or more respective instances of the plurality of respective TBs via the threshold bandwidth, wherein, to monitor for the first set of instances of the first TB, the processing system is configured to: monitoring for the first set of instances of the first TB based on transmission of the registration information.

Aspect 78: The method of any of aspects 76 through 77, wherein the threshold bandwidth is a reduced bandwidth, the reduced bandwidth comprises less frequency resources than a second bandwidth for receiving a fourth set of instances of a fourth TB, and the fourth set of instances is a single instance, is not time-interleaved with instances of a fifth TB, or is associated with a single PDSCH, or any combination thereof

Aspect 79: The method of any of aspects 76 through 78, wherein the threshold bandwidth is a 5 megahertz bandwidth.

Aspect 80: The method of any of aspects 74 through 79, wherein the control information includes one or more DCI messages that schedule the first set of instances of the first TB, the one or more DCI messages including an identifier that is indicative that the first set of instances correspond to the first TB, and reception of the first set of instances of the first TB of the plurality of respective TBs for the multicast service or the broadcast service in accordance with the timing gap is based on the identifier that is indicative that the first set of instances correspond to the first TB.

Aspect 81: The method of any of aspects 74 through 80, wherein decoding the first TB comprises: performing a soft combination on one or more instances of the first set of instances of the first TB based on the control information comprising an indication that each instance of the one or more instances of the first set of instances is of the first TB.

Aspect 82: A method for wireless communication by a network entity, comprising: transmitting control information that schedules one or more respective instances of a plurality of respective TBs, wherein the one or more respective instances of the plurality of respective TBs are time-interleaved according to a time-interleaving pattern, a timing gap being between each of the one or more respective instances of the plurality of respective TBs; and transmitting, via a first set of one or more PDSCHs and based on the time-interleaving pattern, a first set of instances of a first TB of the plurality of respective TBs that uses a first HARQ process and a second set of instances of a second TB of the plurality of respective TBs that uses a second HARQ process for a multicast service or a broadcast service in accordance with the timing gap between each of the first set of instances and between each of the second set of instances, wherein a processing timing gap between a termination of the first set of one or more PDSCHs and receiving second control information scheduling a second set of one or more PDSCHs associated with a third TB or receiving the second set of one or more PDSCHs satisfies a threshold processing time, and wherein the third TB uses the first HARQ process or the second HARQ process.

Aspect 83: The method of aspect 82, wherein the control information is configured to be decodable by at least a second network entity that is of a different generation than a third network entity, the second network entity and the third network entity are capable of decoding the control information, and the third network entity is capable of communicating time interleaved respective instances of respective TBs that are for the multicast service or the broadcast service, or both

Aspect 84: The method of any of aspects 82 through 83, wherein the first set of instances of the first TB and the second set of instances of the second TB are transmitted via a bandwidth that satisfies a threshold bandwidth for the multicast service or the broadcast service via at least one PDSCH.

Aspect 85: The method of aspect 84, further comprising: receiving registration information that indicates a capability of a second network entity to receive the one or more respective instances of the plurality of respective TBs via the threshold bandwidth, wherein the first set of instances of the first TB are transmitted based on the registration information.

Aspect 86: The method of any of aspects 84 through 85, wherein the threshold bandwidth is a reduced bandwidth, the reduced bandwidth comprises less frequency resources than a second bandwidth for receiving a fourth set of instances of a fourth TB, and the fourth set of instances is a single instance, is not time-interleaved with instances of a fifth TB, or is associated with a single PDSCH, or any combination thereof

Aspect 87: The method of any of aspects 84 through 86, wherein the threshold bandwidth is a 5 megahertz bandwidth.

Aspect 88: The method of any of aspects 82 through 87, wherein the control information includes one or more DCI messages that schedule the first set of instances of the first TB, the one or more DCI messages including an identifier that is indicative that the first set of instances correspond to the first TB, and transmission of the first set of instances of the first TB of the plurality of respective TBs for the multicast service or the broadcast service in accordance with the timing gap is based on the identifier

Aspect 89: A network entity for wireless communication, comprising one or more memories storing processor-executable code, and one or more processors coupled with the one or more memories and individually or collectively operable to execute the code to cause the network entity to perform a method of any of aspects 1 through 21.

Aspect 90: A network entity for wireless communication, comprising at least one means for performing a method of any of aspects 1 through 21.

Aspect 91: A non-transitory computer-readable medium storing code for wireless communication, the code comprising instructions executable by one or more processors to perform a method of any of aspects 1 through 21.

Aspect 92: A network entity for wireless communication, comprising one or more memories storing processor-executable code, and one or more processors coupled with the one or more memories and individually or collectively operable to execute the code to cause the network entity to perform a method of any of aspects 22 through 42.

Aspect 93: A network entity for wireless communication, comprising at least one means for performing a method of any of aspects 22 through 42.

Aspect 94: A non-transitory computer-readable medium storing code for wireless communication, the code comprising instructions executable by one or more processors to perform a method of any of aspects 22 through 42.

Aspect 95: A network entity for wireless communication, comprising one or more memories storing processor-executable code, and one or more processors coupled with the one or more memories and individually or collectively operable to execute the code to cause the network entity to perform a method of any of aspects 43 through 60.

Aspect 96: A network entity for wireless communication, comprising at least one means for performing a method of any of aspects 43 through 60.

Aspect 97: A non-transitory computer-readable medium storing code for wireless communication, the code comprising instructions executable by one or more processors to perform a method of any of aspects 43 through 60.

Aspect 98: A network entity for wireless communication, comprising one or more memories storing processor-executable code, and one or more processors coupled with the one or more memories and individually or collectively operable to execute the code to cause the network entity to perform a method of any of aspects 61 through 73.

Aspect 99: A network entity for wireless communication, comprising at least one means for performing a method of any of aspects 61 through 73.

Aspect 100: A non-transitory computer-readable medium storing code for wireless communication, the code comprising instructions executable by one or more processors to perform a method of any of aspects 61 through 73.

Aspect 101: A network entity for wireless communication, comprising one or more memories storing processor-executable code, and one or more processors coupled with the one or more memories and individually or collectively operable to execute the code to cause the network entity to perform a method of any of aspects 74 through 81.

Aspect 102: A network entity for wireless communication, comprising at least one means for performing a method of any of aspects 74 through 81.

Aspect 103: A non-transitory computer-readable medium storing code for wireless communication, the code comprising instructions executable by one or more processors to perform a method of any of aspects 74 through 81.

Aspect 104: A network entity for wireless communication, comprising one or more memories storing processor-executable code, and one or more processors coupled with the one or more memories and individually or collectively operable to execute the code to cause the network entity to perform a method of any of aspects 82 through 88.

Aspect 105: A network entity for wireless communication, comprising at least one means for performing a method of any of aspects 82 through 88.

Aspect 106: A non-transitory computer-readable medium storing code for wireless communication, the code comprising instructions executable by one or more processors to perform a method of any of aspects 82 through 88.

The methods described herein describe possible implementations, and the operations and the steps may be rearranged or otherwise modified and that other implementations are possible. Further, aspects from 2 or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity for wireless communication, comprising:
a processing system configured to:
receive a first set of one or more downlink control information messages that collectively schedule a first set of instances of a first transport block;
receive a second set of one or more downlink control information messages that collectively schedule a second set of instances of a second transport block;
receive, via a set of one or more physical downlink shared channels (PDSCHs) in accordance with the first set of one or more downlink control information messages and the second set of one or more downlink control information messages, the first set of instances of the first transport block and the second set of instances of the second transport block for a multicast service or for a broadcast service, wherein at least one instance of the first set of instances of the first transport block is time-interleaved with the second set of instances of the second transport block; and
decode the first transport block based on reception of the first set of instances of the first transport block.

2. The network entity of claim 1, wherein, to decode the first transport block, the processing system is configured to:
perform a soft combination of one or more instances of the first set of instances of the first transport block based on the first set of one or more downlink control information messages comprising an indication that each instance of the one or more instances of the first set of instances is of the first transport block.

3. The network entity of claim 1, wherein, to decode the first transport block, the processing system is configured to:
decode the first transport block based on the network entity being of a first generation of network entity that is different from a second generation of network entity, or the network entity being capable of communicating time interleaved respective instances of respective transport blocks that are for the multicast service or the broadcast service, or both.

4. The network entity of claim 1, wherein the first set of one or more downlink control information messages and the second set of one or more downlink control information messages are configured to be decodable by at least a second network entity that is of a different generation than the network entity, wherein the network entity and the second network entity are capable of decoding the first set of one or more downlink control information messages and the second set of one or more downlink control information messages, and wherein the network entity is capable of communicating time interleaved respective instances of respective transport blocks that are for the multicast service or the broadcast service, or both.

5. The network entity of claim 1, wherein each downlink control information message of the first set of one or more downlink control information messages schedules a respective instance of the first set of instances of the first transport block, and wherein each downlink control information message of the second set of one or more downlink control information messages schedules a respective instance of the second set of instances of the second transport block.

6. The network entity of claim 5, wherein each downlink control information message of the first set of one or more downlink control information messages comprises a respective field indicating that the scheduled respective instance of the first set of instances corresponds to the first transport block, wherein the processing system is configured to:
decode the first transport block based on the respective field of each downlink control information message of the first set of one or more downlink control information messages.

7. The network entity of claim 6, wherein the respective field of each downlink control information message of the first set of one or more downlink control information messages indicates a respective hybrid automatic repeat request (HARQ) process identifier (ID) associated with the scheduled respective instance of the first set of instances, a new data indicator (NDI) associated with the HARQ process ID, or both.

8. The network entity of claim 7, wherein the NDI associated with the respective HARQ process ID indicates whether the scheduled respective instance is a first temporal transmission corresponding to the first transport block.

9. The network entity of claim 7, wherein the HARQ process ID indicates whether the scheduled respective instance is a retransmission corresponding to the first transport block.

10. The network entity of claim 7, wherein at least one downlink control information message of the first set of one or more downlink control information messages has downlink control information format 4_0.

11. The network entity of claim 7, wherein at least one of:
at least one downlink control information message of the first set of one or more downlink control information messages is for the broadcast service and has downlink control information format 4_1; or
at least one downlink control information message of the first set of one or more downlink control information messages is for the broadcast service and has downlink control information format 4_2.

12. The network entity of claim 5, wherein the processing system is configured to:
receive information that indicates a time window, wherein decoding the first transport block is based on the first set of instances being within the time window.

13. The network entity of claim 1, wherein the processing system is configured to:
receive first information that indicates a quantity of the first set of instances of the first transport block and second information that indicates a time delay between individual instances of the first set of instances of the first transport block, wherein decoding the first transport block is based on the quantity and the time delay, and wherein the first set of one or more downlink control information messages is a single downlink control information message that schedules the first set of instances of the first transport block.

14. The network entity of claim 13, wherein the processing system is configured to:
receive radio resource control information that corresponds to a group radio network temporary identifier associated with the network entity, wherein the radio resource control information includes the first information and the second information.

15. The network entity of claim 13, wherein the single downlink control information message comprises a time domain resource allocation index that is indicative of the first information and the second information.

16. The network entity of claim 13, wherein the processing system is configured to:
receive radio resource control information that includes the first information, wherein the single downlink control information message includes a time domain resource allocation index that is indicative of the second information.

17. The network entity of claim 13, wherein the processing system is configured to:
receive radio resource control information that includes the second information, wherein the single downlink control information message includes a time domain resource allocation index that is indicative of the first information.

18. The network entity of claim 13, wherein the single downlink control information message includes a field with more than 2 bits that indicates a redundancy version index associated with one instance of the first set of instances of the first transport block.

19. The network entity of claim 1, wherein the processing system is configured to:
receive information that indicates a redundancy version index pattern for the first set of instances of the first transport block; and
decode only a portion of each downlink control information message of the first set of one or more downlink control information messages, wherein the portion excludes a respective redundancy version field of each respective downlink control information message based on receipt of the information, and wherein decoding the first transport block is based on the redundancy version index pattern.

20. The network entity of claim 19, wherein the redundancy version index pattern indicates that a respective redundancy version index associated with a first temporal instance of the first set of instances of the first transport block is zero.

21. The network entity of claim 1, wherein at least one downlink control information message of the first set of one or more downlink control information messages includes a redundancy version field that indicates a redundancy version index associated with a first temporal instance of the first set of instances of the first transport block, wherein the indicated redundancy version index corresponds to a redundancy version index pattern of a plurality of redundancy version index patterns, and wherein the redundancy version index pattern begins with the indicated redundancy version index.

22. A network entity for wireless communication, comprising:
a processing system configured to:
transmit a first set of one or more downlink control information messages that collectively schedule a first set of instances of a first transport block;
transmit a second set of one or more downlink control information messages that collectively schedule a second set of instances of a second transport block; and
transmit, via a set of one or more physical downlink shared channels (PDSCHs) in accordance with the first set of one or more downlink control information messages and the second set of one or more downlink control information messages, the first set of instances of the first transport block and the second set of instances of the second transport block for a multicast service or a broadcast service, wherein at least one instance of the first set of instances of the first transport block is interleaved with the second set of instances of the second transport block.

23. The network entity of claim 22, wherein each downlink control information message of the first set of one or more downlink control information messages schedules a respective instance of the first set of instances of the first transport block, and wherein each downlink control information message of the second set of one or more downlink control information messages schedules a respective instance of the second set of instances of the second transport block.

24. The network entity of claim 23, wherein each downlink control information message of the first set of one or more downlink control information messages comprises a respective field indicating that the scheduled respective instance of the first set of instances corresponds to the first transport block.

25. The network entity of claim 24, wherein the respective field of each downlink control information message of the first set of one or more downlink control information messages indicates a respective hybrid automatic repeat request (HARQ) process identifier (ID) associate with the scheduled respective instance of the first set of instances, a new data indicator (NDI) associated with the HARQ process ID, or both.

26. The network entity of claim 25, wherein the NDI associated with the respective HARQ process ID indicates whether the scheduled respective instance is a first temporal transmission corresponding to the first transport block.

27. The network entity of claim 25, wherein the HARQ process ID indicates whether the scheduled respective instance is a retransmission corresponding to the first transport block.

28. The network entity of claim 24, wherein at least one downlink control information message of the first set of one or more downlink control information messages has downlink control information format 4_0.

29. The network entity of claim 24, wherein at least one of:
at least one downlink control information message of the first set of one or more downlink control information messages is for the broadcast service and has downlink control information format 4_1; or
at least one downlink control information message of the first set of one or more downlink control information messages is for the broadcast service and has downlink control information format 4_2.

30. The network entity of claim 23, wherein the processing system is configured to:
transmit information that indicates a time window associated the first set of instances and decoding the first transport block.

31. The network entity of claim 22, wherein the first set of one or more downlink control information messages and the second set of one or more downlink control information messages are configured to be decodable by at least a second network entity that is of a different generation than at least a third network entity, wherein the second network entity and the third network entity are capable of decoding the first set of one or more downlink control information messages and the second set of one or more downlink control information messages, and wherein the third network entity is capable of communicating time interleaved respective instances of respective transport blocks that are for the multicast service or the broadcast service, or both.

32. The network entity of claim 22, wherein the processing system is configured to:
transmit first information that indicates a quantity of the first set of instances of the first transport block and second information that indicates a time delay between individual instances of the first set of instances of the first transport block, and wherein the first set of one or more downlink control information messages is a single downlink control information message that schedules the first set of instances of the first transport block.

33. The network entity of claim 32, wherein the processing system is configured to:
transmit radio resource control information that corresponds to a group radio network temporary identifier associated with a second network entity, wherein the radio resource control information includes the first information and the second information.

34. The network entity of claim 32, wherein the single downlink control information message comprises a time domain resource allocation index that is indicative of the first information and the second information.

35. The network entity of claim 32, wherein the processing system is configured to:
transmit radio resource control information that includes the first information, wherein the single downlink control information message includes a time domain resources allocation index that is indicative of the second information.

36. The network entity of claim 32, wherein the processing system is configured to:
transmit radio resource control information that includes the second information, wherein the single downlink control information message includes a time domain resource allocation index that is indicative of the first information.

37. The network entity of claim 32, wherein the single downlink control information message includes a field with more than 2 bits that indicates a redundancy version index associated with one instance of the first set of instances of the first transport block.

38. The network entity of claim 22, wherein each downlink control information message of the first set of one or more downlink control information messages includes a respective field with more than 2 bits that indicates a respective redundancy version index associated with a respective instance of the first set of instances of the first transport block.

39. The network entity of claim 22, wherein the processing system is configured to:
transmit information that indicates a redundancy version index pattern for the first set of instances of the first transport block, wherein the redundancy version index pattern is associated with decoding the first transport block.

40. The network entity of claim 39, wherein the redundancy version index pattern indicates that a respective redundancy version index associated with a first temporal instance of the first set of instances of the first transport block is zero.

41. The network entity of claim 22, wherein at least one downlink control information message of the first set of one or more downlink control information messages includes a redundancy version field that indicates a redundancy version index associated with a first temporal instance of the first set of instances of the first transport block, wherein the indicated redundancy version index corresponds to a redundancy version index pattern of a plurality of redundancy version index patterns, and wherein the redundancy version index pattern begins with the indicated redundancy version index.

42. The network entity of claim 22, wherein the processing system is configured to:
receive information that indicate a capability of a second network entity to communicate time interleaved respective instances of respective transport blocks that are for the multicast service or the broadcast service, wherein transmitting the first set of one or more downlink control information messages, transmitting the second set of one or more downlink control information messages, transmitting the first set of instances of the first transport block, or transmitting the second set of instances of the second transport block, or any combination thereof, is based on receiving the information.
